(19) United States
(12) Patent Application Publication
(10) Pub. No.: US 2025/0307427 A1
(43) Pub. Date: Oct. 2, 2025

(54) SYSTEMS AND METHODS FOR SYNTHETIC SIDE-CHANNEL ANALYSIS

(71) Applicant: Battelle Energy Alliance, LLC, Idaho Falls, ID (US)

(72) Inventors: Robert Ivans, Idaho Falls, ID (US); Kurt Vedros, Moscow, ID (US); Craig Rieger, Pocatello, ID (US); Konstantinos Kolias, Moscow, ID (US)

(73) Assignee: Battelle Energy Alliance, LLC, Idaho Falls, ID (US)

(21) Appl. No.: 19/092,483

(22) Filed: Mar. 27, 2025

Related U.S. Application Data
(60) Provisional application No. 63/570,790, filed on Mar. 27, 2024.

(51) Int. Cl. G06F 21/57; G06F 21/55

(52) U.S. Cl. CPC G06F 21/577; G06F 21/556

(57) ABSTRACT

Side-channel analysis systems and related methods are disclosed. A side-channel analysis system is configured to generate a synthetic side-channel signal for a code for a software program using a side-channel model. The code includes human-readable instructions of a human-readable computing language. The synthetic side-channel signal includes an estimate of an actual side-channel signal that would be generated by a computer executing the code for the software program. The synthetic side-channel signal is generated based, at least in part, on token values for the human-readable instructions of the code and the training data. The side-channel analysis system is also configured to analyze the synthetic side-channel signal to detect one or more of anomalies or vulnerabilities of the software program. A method includes training the side-channel model.

### CROSS-REFERENCE TO RELATED APPLICATIONS

This application claims the benefit of U.S. Provisional Application No. 63/570,790, filed Mar. 27, 2024, the entire disclosure of which is hereby incorporated herein by this reference.

### FEDERALLY SPONSORED RESEARCH AND DEVELOPMENT

This invention was made with government support under Contract Number DE-AC07-05-ID 14517 awarded by the United States Department of Energy. The government has certain rights in the invention.

### TECHNICAL FIELD

This disclosure relates to systems and methods for anomaly detection and, more specifically, to systems and methods for anomaly detection based, at least in part, on electromagnetic radiation signals.

### BACKGROUND

Unless explicitly indicated otherwise, the approaches described in the technical field and background sections of this disclosure are not prior art to the claims in this disclosure nor admitted prior art.

Anomalies (e.g., injected malicious code) and vulnerabilities (e.g., side-channel attacks) may interfere with functioning of software. For example, an attacker may discover a vulnerability in the software that allows them to perform code injection. Code injection may, in many instances, exploit buffer overflow vulnerabilities. As another example, side-channel vulnerabilities may exploit information related to the fundamental way software is implemented as opposed to flaws in the protocols or algorithms of the software itself. For example, the execution of instructions by a computing device may result in current flow, which, in turn, may produce corresponding electromagnetic radiation signals that can be detected by an attacker. Side-channel attacks have been used to compromise systems, extract cryptographic information, such as private keys, and so on. To mitigate these and other risks, side-channel analysis can be performed before software is deployed; side-channel data acquired during nominal operation of the software may be analyzed to identify anomalies, potential leaks, or other vulnerabilities. Side-channel analysis, however, can pose significant challenges. The acquisition of analog side-channel signals can be time-consuming, error-prone, and require the manual operation of human experts. Therefore, while side-channel analysis can mitigate potential threats, it is generally considered to be impractical for widespread use.

### BRIEF DESCRIPTION OF DRAWINGS

Examples of systems, methods, devices, and computer-readable storage media including instructions configured to implement operations for EM-based anomaly detection are set forth in the accompanying figures and detailed description.

FIG. 1 is a schematic block diagram illustrating an example of an operating environment in which systems and methods for synthetic side-channel analysis may be practiced.

FIG. 2 is a schematic block diagram illustrating an example of system configured to capture side-channel data.

FIG. 3 is a schematic block diagram illustrating an example of a side-channel analysis module configured to, inter alia, generate synthetic side-channel data.

FIG. 4A is a schematic block diagram illustrating an example of a side-channel analysis module configured to learn to a side-channel response of a computing device.

FIG. 4B is a plot illustrating examples of side-channel measurement data.

FIG. 4C is a schematic block diagram illustrating an example of a machine-learning framework for side-channel analysis.

FIG. 4D is a schematic block diagram illustrating another example of a machine-learning framework for side-channel analysis.

FIG. 4E is a schematic block diagram illustrating a further example of a machine-learning framework for side-channel analysis.

FIG. 5A is a flow diagram illustrating an example of a method for learning EM signals for a specified instruction.

FIG. 5B is a flow diagram illustrating another example of a method for learning EM signals for a specified instruction.

FIG. 5C is a flow diagram illustrating an example of a method for learning EM signals for a specified instruction over a plurality of iterations.

FIG. 6A is a flow diagram illustrating an example of a method for learning EM signals for a specified instruction sequence.

FIG. 6B is a flow diagram illustrating another example of a method for learning EM signals for a specified instruction sequence.

FIG. 6C is a flow diagram illustrating an example of a method for learning EM signals for a specified instruction sequence over a plurality of iterations.

FIG. 7A is a schematic block diagram illustrating another example of a side-channel analysis module configured to learn to a side-channel response of a computing device.

FIG. 7B is a schematic block diagram illustrating another example of a side-channel analysis module configured to, inter alia, generate synthetic side-channel data.

FIGS. 7C-7G include plots depicting examples of synthetic side-channel data generated by a machine-learned side-channel synthesis module, as disclosed herein.

FIG. 7H includes a plot depicting distance metrics determined for synthetic side-channel data.

FIG. 8A illustrates an example of a side-channel analysis module configured to implement operations of a side-channel analysis function.

FIG. 8B illustrates another example of a side-channel analysis module configured to implement operations of a side-channel analysis function.

FIG. 9A is a schematic block diagram illustrating an example of a side-channel analysis module configured to learn to emulate a plurality of side channels.

FIG. 9B is a schematic block diagram illustrating an example of a side-channel analysis module configured to analyze a plurality of side channels.

FIG. 10A is a flow diagram illustrating an example of a method for synthetic side-channel signal analysis.

FIG. 10B is a flow diagram illustrating another example of a method for synthetic side-channel signal analysis.

FIG. 11 is a schematic block diagram illustrating an example of a system configured to implement operations of synthetic side-channel anomaly detection, as disclosed herein.

FIG. 12A is a schematic block diagram illustrating an example of a side-channel anomaly detection module.

FIG. 12B is a schematic block diagram illustrating another example of a side-channel anomaly detection module.

FIG. 13 is a flow diagram illustrating an example of a method for synthetic side-channel anomaly detection.

### DETAILED DESCRIPTION OF THE INVENTION

As used herein, a side-channel (SC) attack refers to an attack that exploits information that can be acquired due to the way a software protocol or algorithm is implemented by a computing device. Prior to deployment, SC analysis can be used to identify and mitigate SC vulnerabilities in software. SC analysis may also be used to identify and mitigate anomalies (e.g., injected code anomalies) in software. A SC verification process may include a) capturing SC data from a computing device during execution of the software, and b) analyzing the captured SC data to identify anomalies and/or potential SC vulnerabilities, such as SC data that could be exploited to extract sensitive information, such as private cryptographic data or the like. The SC verification process may further include modifying the software to mitigate the identified anomalies or SC vulnerabilities, e.g., modify executable code, functions, libraries, and/or the like.

Some types of SC data acquired from a computing device may be unique to the software code being executed thereby. For example, the execution of machine-executable code by a computing device may result in current flow, which, in turn, may produce detectable electromagnetic radiation (EM) signals. As used herein, machine-executable code (MEC) may include and/or refer to any suitable information configured to cause a computing device to implement a task. MEC may include and/or be embodied by machine-executable instructions. As used herein, a machine-executable instruction (MEI) may include and/or refer to any suitable information configured to cause a computing device to implement one or more computing tasks or operations; MEI may include, but are not limited to: executable instructions, machine-code instructions, binary instructions, interpretable instructions (e.g., scripts or the like), firmware, configuration data, settings data, and/or the like. The EM signals generated by the computing device in response to the execution of certain MEI may be distinguishable from the EM signals produced in response to the execution of other MEI. Accordingly, the EM signals observed during execution of certain MEI may be distinguishable from the EM signals produced in response to execution of other MEI. As disclosed in further detail herein, modifications at the firmware and/or software level may be detected by, inter alia, comparing EM signals acquired from the computing device during operation to known EM signatures.

SC analysis (e.g., SC-based vulnerability detection and SC-based anomaly detection), however, can suffer from significant drawbacks. It can be difficult and time-consuming to capture EM signals that accurately characterize nominal operation of the computing device and/or characterize nominal behavior of SC of the computing device during execution of respective software modules. The disclosed systems and methods for synthetically generating SC data address these and other issues. The disclosed systems and methods may be configured to generate SC data directly from software, obviating the need for expensive, error-prone manual data gathering. The disclosed systems and methods may, therefore, improve the speed, efficiency, and reliability of SC analysis, while reducing cost.

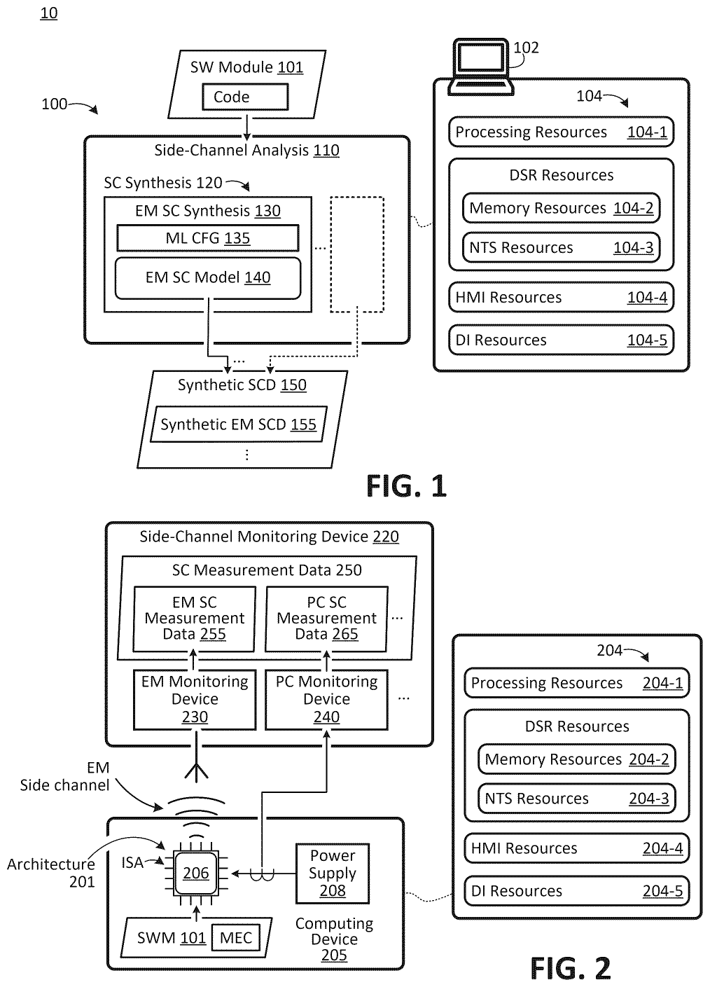

FIG. 1 illustrates an example of an operating environment 10 in the systems and methods for synthetic SC analysis disclosed herein may be practiced. The operating environment 10 may include an SC analysis system 100. The system 100 may include and/or be coupled to an apparatus 102, which may be configured to implement operations of synthetic SC generation, as disclosed herein. The apparatus 102 may include and/or be embodied by one or more physical components, which may include, but are not limited to: an electronic device, a computing device, a general-purpose computing device, an application-specific computing device, a mobile computing device, a smart phone, a tablet, a laptop, a server device, a distributed computing system, a cloud-based computing system, an embedded computing system, and/or the like.

The apparatus 102 may include and/or be coupled to computing resources 104. The computing resources 104 may include any suitable computing means including, but not limited to processing resources 104-1, data storage and/or retrieval (DSR) resources (e.g., memory resources 104-2, non-transitory storage (NTS) resources 104-3, and/or the like), human-machine interface (HMI) resources 104-4, data interface (DI) resources 104-5, and/or the like.

The processing resources 104-1 may include any suitable processing means including, but not limited to: processing circuitry, logic circuitry, an integrated circuit (IC), a processor, a physical processor, a virtual processor (e.g., a virtual machine), an arithmetic-logic unit (ALU), a central processing unit (CPU), a general-purpose processor, a programmable logic device (PLD), a field programmable gate array (FPGA), an application-specific integrated circuit (ASIC), a System on Chip (SoC), virtual processing resources, and/or the like.

The DSR resources may include any suitable means for storing, retrieving, maintaining, and/or otherwise managing data which may include, but are not limited to memory resources 104-2, NTS resources 104-3, and/or the like. The memory resources 104-2 may include any suitable memory means including, but not limited to: volatile memory, non-volatile memory, random access memory (RAM), dynamic RAM (DRAM), synchronous DRAM (SDRAM), cache memory, or the like. The NTS resources 104-3 may include any suitable non-transitory, persistent, and/or non-volatile storage means including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like.

The HMI resources 104-4 may include any suitable means for human-machine interaction including, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like.

The DI resources 104-5 may include any suitable data communication and/or interface means including, but not limited to: a communication interface, a I/O interface, a device interface, a network interface, an interconnect, and/or the like. In some implementations, the data interface 104-5 may be configured to communicatively couple the apparatus 102 to a network, which may include, but is not limited to: an electronic communication network, a computer network, a wired network, a wireless network, a local area network (LAN), a wide area network (WAN), a virtual private network (VPN), Internet Protocol (IP) networks, Transmission Control Protocol/Internet Protocol (TCP/IP) networks, the Internet, or the like.

The apparatus 102 may include a side-channel analysis (SCA) module 110. The SCA module 110 may be configured to implement operations of synthetic SC analysis, as disclosed herein. Operations of the SCA module 110 may be implemented and/or embodied by computing resources 104 of the apparatus 102. For example, the SCA module 110 may be configured for operation on processing resources 104-1 of the apparatus 102, utilize data storage and/or retrieval resources of the apparatus 102 (e.g., memory resources 104-2, NTS resources 104-3, and/or the like), may be implemented and/or embodied by MEI stored within NTS resources 104-3 of the apparatus 102, and so on.

In the FIG. 1 example, the SCA module 110 may further include one or more SC synthesis modules 120. As used herein, an SC synthesis module 120 may include and/or refer to means for generating synthetic SC data 150 pertaining to a specified SC. In other words, an SC synthesis module 120 may include and/or refer to means for emulating a specified SC of a computing device (and/or a computing architecture). In some implementations, the SCA module 110 may include and/or be coupled to a plurality of SC synthesis modules 120, each configured to emulate a respective SC, e.g., may include and/or be coupled to SC synthesis modules 120 configured to emulate SC pertaining to one or more of EM emission, electro-optical radiation emission, power consumption, temperature, acoustics, vibration, and/or the like. In the FIG. 1 example, SCA modules 120 may include an EM SC synthesis module 130 configured to, inter alia, emulate the response of an EM SC.

The SC synthesis module(s) 120 may be configured to generate synthetic SC data 150 for respective software modules 101. As used herein, a software module (SWM) 101 may include and/or refer to any suitable means for configuring a device to implement a task. A SWM 101 may include, but is not limited to a binary, an executable, firmware, an operating system, an application, a program, a library, a package, and/or the like. As a specific, non-limiting example, the SWM 101 includes human-readable code (e.g., assembly code). A SWM 101 may include MEC. The MEC of a SWM 101 may include and/or be embodied by MEI. For example, the MEC of a SWM 101 may include MEI logically organized into one or more sequences, segments, functions, libraries, and/or the like. The SWM 101 illustrated in the FIG. 1 example may be received by any suitable means; the SCA module 110 may receive the SWM 101 from DI resources 104-5, receive the SWM 101 through an electronic communication network, retrieve the SWM 101 from DSR resources, and/or the like.

As disclosed herein, an SC synthesis module 120 may be configured to generate synthetic SC data 150 for respective SWM 101. The synthetic SC data 150 may be configured to emulate the response of an SC of a computing device to execution of the SWM 101. As used herein, the SC response of a SWM 101 may include and/or refer to SC data observed during execution of the SWM 101. The SC response of an SWM 101 may be characteristic of and/or unique to the SWM 101 (and/or MEC thereof). Accordingly, the synthetic SC data 150 (or synthetic SC response) determined for respective SWM 101 may be characteristic of and/or unique to the respective SWM 101 (and/or MEC thereof). The synthetic SC data 150 determined for an SWM 101 may, therefore, include and/or be referred to as an SC signature or SC fingerprint of the SWM 101.

The SC synthesis module(s) 120 may be configured to generate synthetic SC data 150 configured to emulate any suitable SC and/or any suitable type of SC data, e.g., power consumption, EM emission, sound, mechanical vibration, or the like. In the FIG. 1 example, the SCA module 110 may include an SC synthesis module 120 configured to emulate an EM SC of a computing architecture, e.g., an EM SC synthesis module 130. The EM SC synthesis module 130 may be configured to generate synthetic EM SC data 155 for respective SWM 101. The synthetic EM SC data 155 generated for an SWM 101 may be configured to emulate EM signals emitted during execution of the SWM 101, e.g., may be configured to emulate the EM SC response of the SWM 101. The EM SC response of an SWM 101 may be characteristic of and/or unique to the SWM 101 (and/or MEC thereof). The synthetic EM SC data 155 generated for an SMW 101 may, therefore, include and/or be referred to as an EM SC signature or EM SC fingerprint of the SWM 101.

By way of further clarification, FIG. 2 is a schematic block diagram illustrating an example of a computing device 205 including one or more SC, including an EM SC. The computing device 205 may include any suitable computing means, as disclosed herein. In the FIG. 2 example, the computing device 205 may include an embedded device, an SoC, or the like. The computing device 205 may include and/or be coupled to computing resources 204, which may include, but are not limited to processing resources 204-1, DSR resources (e.g., memory resources 204-2, NTS resources 204-3, and so on), HMI resources 204-4, DI resources 204-5, and/or the like. The processing resources 204-1 of the computing device 205 may include a processing unit 206. The processing unit 206 may include any suitable processing means, as disclosed herein, e.g., may include, but is not limited to: processing circuitry, processing logic, an IC, a processor, a CPU, an ALU, a PLD, an FPGA, an ASIC, a SoC, and/or the like.

As illustrated in FIG. 2, the computing device 205 may include and/or be implemented in accordance with an architecture 201. As used herein, an architecture 201 may include and/or refer to a specification that defines the logical and/or physical functionality, structure, and/or implementation of a computing system. The architecture 201 of a computing system may include and/or define, inter alia, an instruction set architecture (ISA). The ISA may include and/or define the set of MEI the architecture 201 and/or corresponding computing systems are configured to implement. The computing device 205 of the FIG. 2 example may include and/or implement any suitable architecture 201 including, but not limited to: a Complex Instruction Set Computer (CISC) architecture, a Reduced Instruction Set Computer (RISC) architecture, an Advanced RISC Machine (ARM) architecture, an SoC architecture, an embedded device architecture, and/or the like.

The SC monitoring device 201 may be configured to monitor one or more SC of the computing device 205. The monitoring may include capturing, recording, measuring, and/or otherwise acquiring SC measurement (SCM) data 250. The SCM data 250 may include information pertaining to the behavior of respective SC of the computing device 205 during operation, e.g., during execution of MEC code of the SWM 101. The SC monitoring device 201 may be configured to monitor and/or acquire SCM data 250 pertaining to any suitable SC and/or SC type, e.g., power consumption, EM radiation, sound, vibration, and/or the like. In FIG. 2 example, the SC monitoring device 201 may be configured to monitor an EM SC of the computing device 205. The EM SC may include and/or correspond to EM radiation generated by a processor of the computing device 205, such as a CPU, SoC, cryptographic processor, and/or the like. The SC monitoring device 201 may include and/or be coupled to an EM monitoring device 230. The EM monitoring device 230 may include any suitable means for sensing, detecting, measuring, observing and/or otherwise monitoring EM radiation emanating from the computing device 205 including, but not limited to: an EM sensor, a magnetic sensor, a magnetic field sensor, an electromagnetic field (EMF) sensor, an inductive sensor, an induction coil, an antenna, and/or the like.

As illustrated in the FIG. 2 example, the SCM data 250 acquired by the SC monitoring device 201 may include EM SC measurement (EM SCM) data 255. The EM SCM data 255 may be expressed in any suitable terms. For example, the EM SCM data 255 may be expressed in terms of energy, wavelength, frequency, and/or the like. The EM SCM data 255 may include EM spectra, e.g., may quantify EM radiation energy across a range of wavelengths or frequencies. Alternatively, or in addition, the EM SCM data 255 may be configured to quantify EM radiation energy detected at specified wavelengths or frequencies, e.g., at frequencies corresponding to operating frequencies of the computing device 205, such as a clock frequency, CPU clock frequency, bus frequency, and/or the like. The EM SCM data 255 may include any suitable representation of the EM SC response and/or EM SC signature of the SWM 101. The EM SCM data 255 may include one or more of a time domain representation (e.g., EM amplitude over time), frequency domain representation (e.g., EM amplitude over frequency), a spectrogram (e.g., frequency over time), and/or the like.

Although particular examples of SCM data 250 are described herein, the disclosure is not limited in this regard. The SC monitoring device 220 may be configured to capture any data pertaining to the response of any suitable SC of the computing device 205 (and/or architecture 201), e.g., SC pertaining to temperature, vibration, acoustics, power consumption, and/or the like. In some implementations, the SC monitoring device 220 may be configured to monitor a plurality of different types of Sc. For example, the SC monitoring device 220 may be configured to monitor the EM SC and one or more other SC.

In some implementations, the SC monitoring device 220 may be configured to acquire SCM data 250 pertaining to a power consumption SC of the computing device 205. As used herein, a power consumption (PC) SC may include and/or refer to an SC pertaining to power consumption during execution of respective MEI and/or MEI sequences. PC of a computing device 205 may be characterized by one or more factors including, but not limited to: current draw, current draw of the computing device 205, current draw of the processing unit 206 of the computing device 205, voltage potentials associated with such current draw, load on a power supply 208 of the computing device 205, power flow to the processing unit 206 of the computing device 205, and/or the like.

In the FIG. 2 example, the SC monitoring device 220 may include and/or be coupled to a PC monitoring device 240. The PC monitoring device 240 may be configured to acquire PC SCM data 265 pertaining to a PC SC of the architecture 201, the PC SC corresponding to PC by the processing unit 206 of the computing device 205. The PC monitoring device 240 may, therefore, be configured to monitor power flow to the processing unit 206, e.g., monitor power flow from the power supply 208 to the processing unit 206. The PC monitoring device 240 may include any suitable means for monitoring PC including, but not limited to one or more current sensors, current transformers, voltage sensors, potentiometers, power meters, and/or the like. The SC monitoring device 240 may be configured to record PC SCM data 265 configured to characterize the response of the PC SC of the computing device 205 during execution of respective SMW 101 (and/or MEC or MEI). The SCA module 110 may utilize the PC SCM data 255-1 to, inter alia, learn to emulate PC SC of the architecture 201, as disclosed herein.

Referring back to FIG. 1, the SCA module 110 may be configured to generate synthetic SC data 150. The SCA module 110 may include and/or be coupled to one or more SC synthesis module(s) 120, each configured to estimate, predict, and/or otherwise emulate the behavior of a respective SC of the computing device 205, e.g., emulate the SC response of respective SWM 101. In other words, the synthetic SC data 150 generated for the SWM 101 by the SC synthesis module(s) 120 may be configured to predict the real-world behavior of respective SC of the computing device 205, e.g., emulate and/or predict SCM data 250 observed during execution of the SWM 101, as illustrated in FIG. 2. As disclosed herein, an SC synthesis module 120 may be configured to generate synthetic SC data 150 corresponding to any suitable SC and/or SC type. In the FIG. 1 example, the one or more SC synthesis module(s) 120 may include EM SC synthesis module 130, which may be configured to, inter alia, emulate the behavior of an EM SC of the computing device 205. In other words, the EM SC synthesis module 130 may be configured to generate synthetic EM SC data 155 for the SWM 101, the EM SC data 155 configured to match the EM SCM data 255 acquired from the EM SC of the computing device 205 in response to execution of the SWM 101.

In some implementations, the EM SC synthesis module 130 may include and/or be coupled to an EM SC model 140. The EM SC model 140 may include and/or implement one or more artificial intelligence, machine-learning, and/or machine-learned (AI/ML) components. The EM SC model 140 may include and/or implement any suitable AI/ML platform, architecture and/or component, including, but not limited to: a supervised learning AI/ML architecture, an unsupervised AI/ML architecture, a reinforcement AI/ML architecture, a deep learning AI/ML architecture, an artificial neural network (ANN), a convolutional neural network (CNN), a recurrent or recursive neural network (RNN), a generative model, and/or the like.

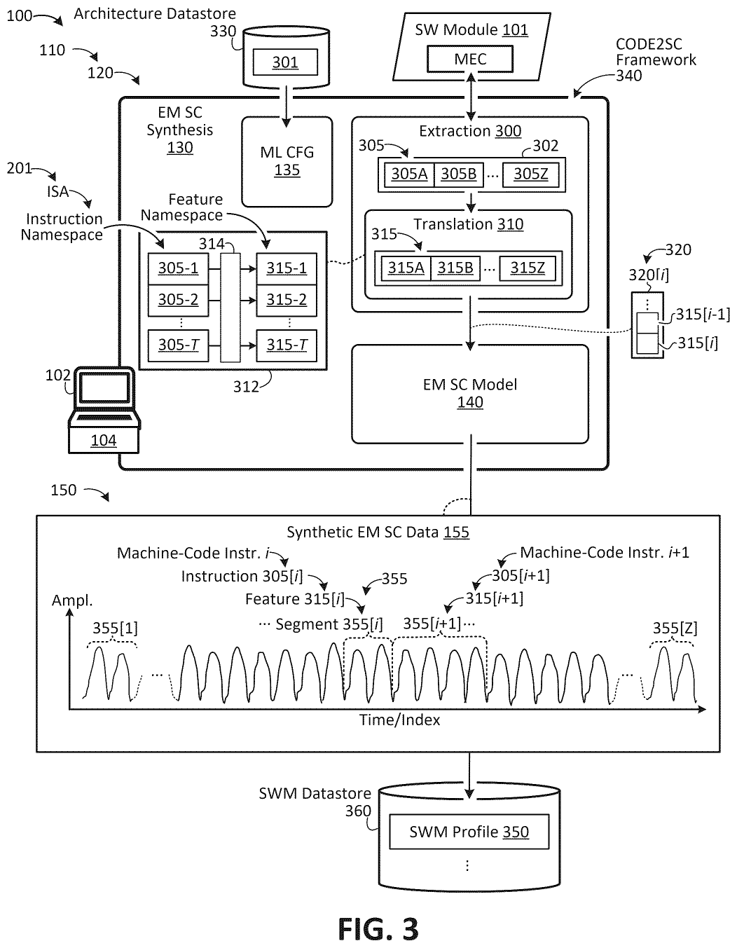

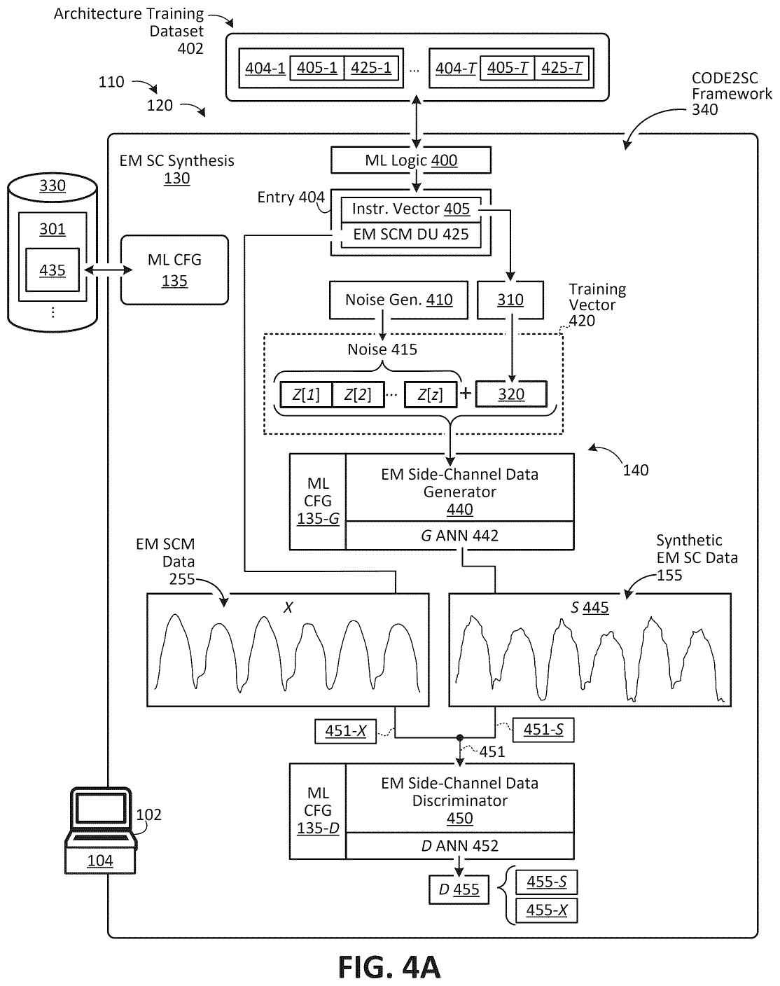

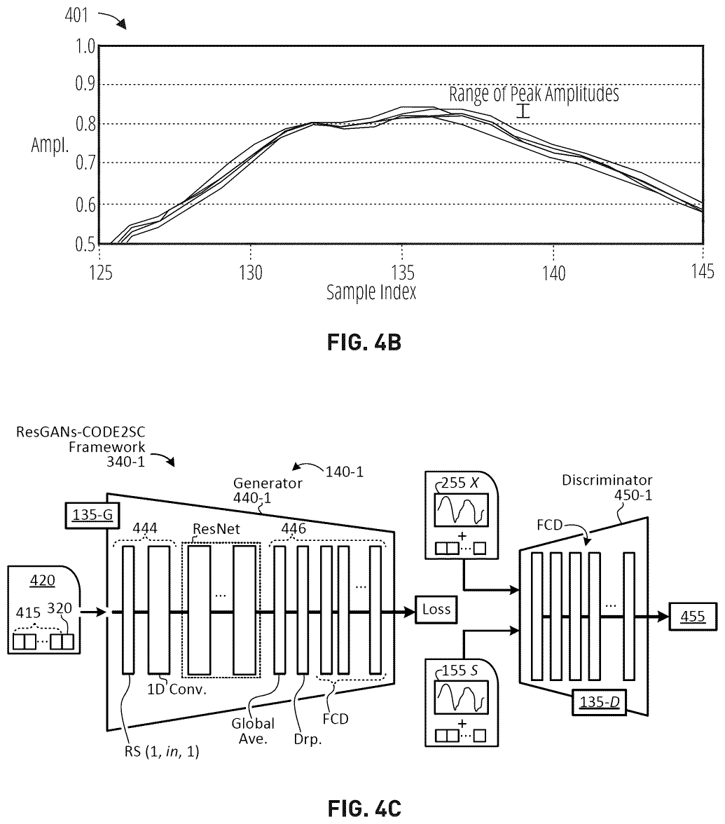

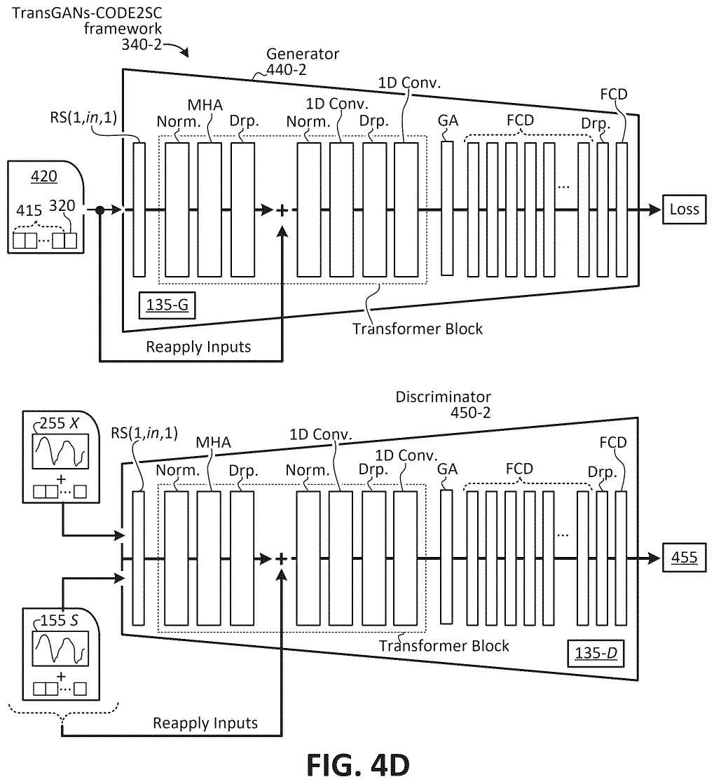

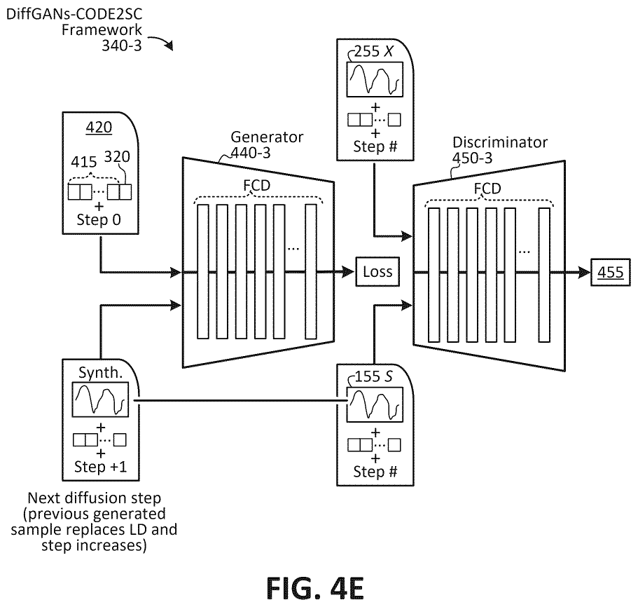

In some implementations, the EM SC model 140 may include and/or implement one or more generative AI/ML architecture(s), which may include, but is not limited to: a generative adversarial networks (GANs) framework, a variational autoencoder (VAE), an autoregressive model, an RNN, a transformer-based model, reinforcement learning architecture (e.g., reinforcement learning for generative tasks), and/or the like. The EM SC synthesis module 130 (and/or EM SC model 140 thereof) may include, embody, and/or implement a machine-learned configuration (ML CFG) 135. Operations of the ML CFG 135 may be learned through an AI/ML training and/or learning procedure, as disclosed in further detail herein. In the FIG. 1 example, the EM SC model 140 may include and/or implement a Code to SC (CODE2SC) framework 340. The example illustrated in FIG. 3 may be configured to translate SWM 101 to EM signals and, as such, may include and/or be referred to as a Code to EM (CODE2EM) framework. Operations of the ML CFG 135 may be learned, refined, and/or otherwise developed in accordance with the CODE2SC framework 340, as illustrated in FIG. 4A.

FIG. 3 is a schematic block diagram illustrating an example of an EM SC synthesis module 130. The EM SC synthesis module 130 may include an EM SC model 140 trained to emulate the EM SC of a specified architecture 201. In other words, the EM SC synthesis module 130 may be configured to convert or translate SWM 101 into synthetic EM SC data 155. More specifically, the EM SC synthesis module 130 may be configured to convert or translate MEC of respective SWM 101 (e.g., individual MEI and/or MEI sequences) into synthetic EM SC data 155. The synthetic EM SC data 155 may include a realistic representation of the EM signals produced during execution of the SWM 101 by the computing device 205. The EM SC synthesis module 130 may include and/or implement the CODE2SC framework 340 disclosed herein. Operations of the CODE2SC framework 340 may be learned through GANs architectures and, as such, may include and/or be referred to as a GANs-CODE2SC framework 340.

In some implementations, the EM SC synthesis module 130 of the CODE2SC framework 340 may be targeted and/or configured to specified architecture(s) 201. The CODE2SC framework 340 illustrated in the FIG. 3 example may be configured to emulate the EM SC of the computing device 205 illustrated in FIG. 3. In other words, the CODE2SC framework 340 of FIG. 3 may be configured to emulate the EM SC of the architecture 201 implemented by the computing device 205, e.g., emulate the EM SC of the architecture 201. The SCA module 110 may be configured to record, store, retrieve, and/or maintain information pertaining to respective architectures 201 within non-transitory storage, such as an architecture datastore 330. Information pertaining to an architecture 201 may be stored according to any suitable scheme and/or in any suitable format. In the FIG. 3 example, information pertaining to the architecture 201 may be maintained and/or retrieved from an architecture profile 301. An architecture profile 301 may include and/or reference any suitable information pertaining to an architecture 201, such AI/ML data learned for the architecture 201 (e.g., an ML CFG 135), architecture metadata, such as an identifier of the architecture 201 (e.g., name, unique identifier, version number, revision number, and/or the like), information pertaining to the ISA of the architecture 201 (e.g., MEI vocabulary or namespace, MEI instruction types, or the like), identifiers of computing device(s) 205 associated with the architecture 201, and so on. An architecture profile 301 may further include information pertaining to the ISA and/or instruction namespace of the architecture 201, as disclosed in further detail herein.

The CODE2SC framework 340 may be trained to learn translations between MEI supported by the architecture 201 to EM signals (and vice versa). In other words, the CODE2SC framework 340 may be trained to translate an instruction vocabulary or namespace of the architecture 201 to an EM signal vocabulary. In the FIG. 3 example, the ISA of the architecture 201 may define T types of MEI and the CODE2SC framework 340 may be configured to emulate EM signals corresponding to each of the T instruction types. The CODE2SC framework 340 may be configured to emulate EM signals corresponding to any suitable architecture 201 having any suitable ISA, or instruction namespace including, but not limited to: a CISC ISA, RISC ISA, ARM ISA, and/or the like.

The EM SC synthesis module 130 of the CODE2SC framework 340 may include, embody, implement and/or be configured in accordance with ML CFG 135. The ML CFG 135 may be learned, refined, and/or otherwise developed through, inter alia, one or more AI/ML training procedures, as disclosed in further detail herein.

In some implementations, the EM SC synthesis module 130 may be configured to learn and/or refine characteristics of the ML CFG 135. Alternatively, or in addition, the EM SC synthesis module 130 (and/or EM SC model 140 thereof) may include, embody, and/or be configured in accordance with an ML CFG 135 learned in one or more previously implemented AI/ML training procedures and/or AI/ML training procedures implemented by another system or device. For example, the EM SC synthesis module 130 may be instantiated, configured, and/or implemented in accordance with an ML CFG 135 learned for the architecture 201 by the EM SC synthesis module 130 illustrated in FIG. 4A, as disclosed in further detail herein. The SCA module 110 may be configured to retrieve the ML CFG 135 for the architecture 201 from any suitable DSR resources, such as NTS resources 104-3, an architecture datastore 330 (e.g., may be retrieved from an architecture profile 301 associated with the architecture 201), and/or the like. In some implementations, operations of the EM SC synthesis module 130 may be programmable, e.g., may be implemented in software, programmable hardware, or the like. Programmable and/or software operations of the EM SC synthesis module 130 (and/or EM SC model 140) may be instantiated and/or configured in accordance with the ML CFG 135. Alternatively, or in addition, operations of the EM SC synthesis module 130 may be non-programmable, e.g., may be implemented in read only memory, hardware components (e.g., an IC, ASIC, or other hardware), or the like. Non-programmable operations and/or components of the EM SC model 140 may be implemented in accordance with the ML CFG 135 and/or embody the ML CFG 135, e.g., operations of the ML CFG 135 may be hardwired into the design and/or implementation of one or more hardware components of the EM SC synthesis module 130.

The ML CFG 135 may include any suitable information pertaining to the EM SC synthesis module 130 (and/or EM SC model 140 thereof). The ML CFG 135 may include information pertaining to features 315 utilized by the EM SC model 140, e.g., may include and/or define translations, mappings, embeddings, and/or other means for extracting and/or converting MEI configured for execution on the architecture 201 to features 315 suitable for processing by AI/ML components of the EM SC model 140. Alternatively, or in addition, the ML CFG 135 may include and/or define operations and/or components of the architecture, structure, implementation, and/or configuration of respective AI/ML components of the EM SC model 140. By way of non-limiting example, the EM SC model 140 may include an ANN and the ML CFG 135 may include hyperparameters configured to define one or more of: the architecture of the ANN, the structure of the ANN, the configuration of respective layers of the ANN (e.g., the configuration of an input layer, intermediate layer(s), output layer and so on), the types of layers included in the ANN (e.g., convolutional layers, linear layers, and/or the like), the quantity of nodes included in respective layers of the ANN, interconnections between nodes of respective layers of the ANN (e.g., fully connected, non-fully connected, sparsely connected, or the like), activation functions implemented by nodes of respective layers of the ANN, regularization strength, neuron dropout rate, weights learned for respective nodes, learned activation weights, and/or the like.

The ML CFG 135 may be configured to cause the EM SC synthesis module 130 to emulate the EM SC of computing device(s) 205 having a specified architecture 201. The EM SC synthesis module 130 may be trained to emulate the EM SC of a specified type of computing device 205, e.g., computing device(s) 205 having a specified architecture 201. Accordingly, in some implementations, the ML CFG 135 of the CODE2SC framework 340 may be architecture specific. The ML CFG 135 may include architecture-specific information (e.g., architecture metadata), which may include any suitable information pertaining to the architecture 201 including, but not limited to: an identifier of the architecture 201, information pertaining to the ISA of the architecture 201 (e.g., an instruction vocabulary or namespace, dictionary, and/or the like), identifiers of computing device(s) 205 that implement the architecture 201, and/or the like.

As illustrated in the FIG. 3 example, the EM SC synthesis module 130 of the CODE2SC framework 340 may be configured to generate synthetic EM SC data 155 for a SWM 101. The synthetic EM SC data 155 may be configured to emulate EM radiation emitted by computing device(s) 205 of architecture 201 in response to execution of the SWM 101. Generating the synthetic EM SC data 155 for the SWM 101 may include, inter alia, a) extracting features 315 from the SWM 101 according to the CODE2SC framework 340, and b) converting the features 315 into EM signals by use of an EM SC model 140 configured in accordance with the ML CFG 135.

The EM SC synthesis module 130 may be configured to extract features 315 from the SWM 101 according to the CODE2SC framework 340. The features 315 may represent respective MEI (and/or MEI sequences) of the SWM 101. The EM SC synthesis module 130 may be configured to derive features 315 from respective SWM 101 by use of an extraction module 300 and/or translation module 310. As disclosed in further detail herein, the extraction module 300 may be configured to extract information pertaining to MEC of the SWM 101 and the translation module 310 may be configured to convert such information into features 315 suitable for processing by AI/ML components of the CODE2SC framework 340, e.g., AI/ML components of the EM SC synthesis module 130.

As illustrated in FIG. 3, the EM SC synthesis module 130 may include and/or be coupled to an extraction module 300. The extraction module 300 may be configured to extract module code 302 from the SWM 101. The module code 302 may include and/or be derived from MEC of the SWM 101, e.g., may include and/or be derived from MEI, MEI sequences, functions, libraries, and/or the like. The module code 302 may include a plurality of instructions 305, which may include and/or correspond to the instruction namespace of the architecture 201. In the FIG. 3 example, the MEC of the SWM 101 may include and/or be represented by module code 302 including M instructions 305, e.g., instructions 305A through 305M. The module code 302 may be configured to model the logical organization of the MEI of the SWM 101, e.g., the module code 302 may include instructions 305 organized into instruction sequences, functions, libraries, and/or like, as disclosed herein.

In some implementations, the extraction module 300 may be configured to acquire module code 302 including any suitable representation of the MEC of the SWM 101. The module code 302 and/or instructions 305 may include but are not limited to: MEI of the architecture 201, semantic and/or textual representations of respective MEI of the architecture 201, intermediate language code (ILC), low-level programming language code (LLC), high-level programming language code (HLC), assembly language code (ASM), symbolic machine code, human-readable code, and/or the like. The extraction module 300 may be configured to obtain module code 302 any suitable means. In some non-limiting examples, the extraction module 300 may be configured to generate a semantic and/or textual representation of the MEC from, inter alia, build data pertaining to the SWM 101. The build data may include, but is not limited to source code, ILC, LLC, HLC, ASM, symbolic machine code, human-readable code, intermediate files, intermediate build data (e.g., ILC and/or other data generated during compilation and/or other build operations), and/or the like. Alternatively, or in addition, in other non-limiting examples, the extraction module 300 may be configured to derive module code 302 from the SWM 101 itself (and/or validate module code 302 retrieved from build data, as disclosed above). For example, build data pertaining to the SWM 101 may not be available to the EM SC synthesis module 130 (and/or may not be trusted). The extraction module 300 may be configured to a) identify MEC within the SWM 101 (e.g., identify MEI within code segments within the SWM 101 and/or distinguish code segments from segments of the SWM 101 including other, non-executable data), and b) generate module code 302 (e.g., instructions 305) corresponding to the identified MEC. The generating may include translating, decompiling, disassembling, and/or otherwise converting the MEC and/or MEI into corresponding semantic and/or textual representations, e.g., by use of a disassembler, decompiler, and/or the like.

Alternatively, in some implementations, the module code 302 may include and/or correspond to MEI of the architecture 201, e.g., may include MEI extracted from the MEC of the SWM 101, as disclosed herein. Information pertaining to the extraction of module code 302 from SWM 101 of respective architectures 201, such as the format of SWM 101 of the architecture 201, MEC of the architecture 201, the instruction namespace of the architecture 201, and so on, may be maintained within an architecture profile 301, as disclosed herein. The architecture profile 301 may include information pertaining to the format of MEC configured for execution on computing device(s) 205 of the architecture 201, the ISA of the architecture 201, the instruction namespace of the architecture 201, an instruction dictionary or namespace, and/or the like.

The EM SC synthesis module 130 may include and/or be coupled to a translation module 310. The translation module 310 may be configured to convert instructions 305 of the module code 302 extracted from the SWM 101 into features 315 suitable for processing by AI/ML components of the CODE2SC framework 340, e.g., the EM SC model 140. As used herein, a feature 315 may include and/or refer to any suitable representation of an instruction capable of being executed and/or otherwise implemented by a computing device 205 of the specified architecture 201, e.g., an MEI, instruction 305, and/or the like. The translation module 310 may be configured to generate features 315 of any suitable type and/or format including, but not limited to: symbols, numerical representations, vector representations, tokens, text embeddings, and/or the like.

In some implementations, the translation module 310 may be configured to convert instructions 305 into features 315 including numerical vectors that a) capture the semantic meaning and/or context of the instructions 305, and b) are suitable for processing by AI/ML components of the CODE2SC framework 340. In some non-limiting examples, the translation module 310 may be configured to implement a text embedding algorithm in which instructions 305 are projected or mapped into a high-dimensional latent space, wherein numerical vectors (e.g., features 315) of respective instructions 305 are determined by the position of the instructions 305 within the high-dimensional latent space.

In the FIG. 3 example, the translation module 310 may include and/or implement a tokenizer 312. The tokenizer 312 may be configured to map instructions 305 to features 315 including tokens, e.g., unique numerical representations of respective instructions 305. The tokenizer 312 may be configured to vectorize the instruction namespace of the architecture 201 by, inter alia, turning each entry of the namespace (e.g., each possible instruction type) into a sequence of integers, where each integer corresponds to an index of a token in a dictionary 314. In the FIG. 3 example, the architecture 201 implemented by the computing device 205 may include T unique instruction types, e.g., T different types of machine-code instructions corresponding to instructions 305-1 through 305-T. The tokenizer 312 may establish a dictionary 314 by which each type of instruction 305-1 through 305-T may be vectorized, e.g., maps each type of instruction 305 to a respective sequence of integers where each integer corresponds to an index of a token in the dictionary 314. Thereafter, the tokenizer 312 may utilize the dictionary 314 to produce a unique index (token or feature 315) for respective instructions 305. Operations of the translation module 310, such as the instruction namespace of the architecture 201, tokenizer 312, dictionary 314, and/or the like may be defined by and/or within the ML CFG 135 learned for the architecture 201 (and/or profile of the architecture 201), as disclosed herein.

Information pertaining to the extraction of features 315 from SWM 101 of respective architectures 201 may be maintained within corresponding architecture profiles 301 (and/or other DSR resources of the apparatus 102). In the FIG. 3 example, the architecture profile 301 (and/or ML CFG 135) may include extraction metadata pertaining to the architecture, such as identifier(s) and/or location(s) of MEC within the SWM 101, the format of respective MEI, logical relationships between MEI of the SWM 101 (e.g., MEI sequences, functions, libraries, and/or the like), and so on. The extraction module 300 may, utilize extraction metadata of the architecture profile 301 to, inter alia, extract executable code 302 from the SWM 101, as disclosed herein. The architecture profile 301 (and/or ML CFG 135) may further include information pertaining to translations between instructions 305 of the SWM 101 and respective features 315, e.g., translation metadata. The translation metadata may include but is not limited to: semantic and/or textual representations of respective MEI, mappings between instructions 305 and features 315 (e.g., mappings between each type of instruction 305-1 through 305-T and feature 315-1 through 315-T), text embeddings for respective instructions 305, tokens for respective instructions 305, a tokenizer 312, and dictionary 314, and/or the like.

As disclosed herein, the EM SC synthesis module 130 may be configured to generate synthetic EM SC data 155 for respective SWM 101. Generating synthetic EM SC data 155 for a SWM 101 may include a) extracting features 315 from the SWM 101 (e.g., tokenizing instructions 305 of executable code 302 extracted from MEC of the SWM 101), and b) configuring the EM SC model 140 to convert the features 315 into synthetic EM SC data 155. The synthetic EM SC data 155 may include any suitable representation of an EM signal. In some implementations, the synthetic EM SC data 155 may include a one-dimensional sequence of EM amplitude values; in the FIG. 3 example, the vertical, y axis represents amplitude and the horizontal, x axis represents time.

Generating the synthetic EM SC data 155 may include generating EM signals for features 315 corresponding to the MEC of the SWM 101, e.g., EM signals corresponding to execution a series of MEI by a computing device 205 of architecture 201. The synthetic EM SC data 155 may include a combination of a plurality of EM signals, each corresponding to execution of a respective MEI. By way of non-limiting example, the synthetic EM SC data 155 may include a plurality of segments 355, each segment 355 including an EM signal configured to emulate the response of the EM SC of the architecture 201 (and/or ISA) to execution of a respective MEI of the SWM 101.

In some implementations, the synthetic EM SC data 155 may include a series of substantially non-overlapping segments 355, each segment 355 corresponding a respective instruction, e.g., a series of substantially non-overlapping synthetic EM signals. Alternatively, the EM SC model 140 may be configured to generate synthetic EM SC data 155 including one or more overlapping segments 355. For example, the EM SC model 140 may be configured to emulate the EM SC of an architecture 201 capable of concurrent execution, e.g., an architecture 201 configured to implement instruction pipelining, a multi-core architecture 201, and/or the like. In these implementations, the EM SC model 140 may be configured to generate synthetic EM data 155 including segments 355 configured to emulate EM signals corresponding to concurrent and/or overlapping execution of two or more MEI.

As illustrated in the FIG. 3 example, the synthetic EM SC data 155 may include segments 355[1] through 355[Z] configured to emulate execution of instructions 305A through 305Z. As further illustrated, the synthetic EM SC data 155 may include, inter alia, a segment 355[i]. The segment 355[i] may include a synthetic EM signal configured to emulate EM emission of the computing device 205 during execution of MEI i of the SWM 101. The segment 355[i] may be generated by the EM SC model 140 in response to a feature 315[i] corresponding to MEI i extracted from the SWM 101 (e.g., instruction 305[i]), the segment 355[i+1] may be generated in response to feature 315[i+1] (e.g., instruction 305[i+1]), and so on.

From previous experiments, the inventors learned that the phenotype of the EM signals generated in response to execution of an instruction 305 can be influenced by previously executed instruction(s) 305. For example, the EM signals generated in response to execution of respective instructions 305 may be influenced by the instructions 305 executed directly prior thereto. By way of further example, the EM signals generated in response to execution of an XOR instruction 305 may vary based on preceding instructions; the EM signals generated when the XOR instruction 305 is executed within a first sequence (e.g., ADD, XOR, . . . ) may differ from the EM signals generated when the XOR instruction is executed within a second, different sequence (e.g., LDI, XOR, . . . ).

In some implementations, the EM SC model 140 of the CODE2SC framework 340 may be configured to account for the influence of prior instructions 305. For example, the extraction module EM SC model 140 may be configured to generate synthetic EM SC data 155 in response to feature vectors 320. The feature vector 320 created for an instruction 305 may include one or more features 315, including the feature 315 derived from the instruction 305. As illustrated in the FIG. 3 example, the feature vector 320 [i] created for instruction 305[i] may include feature 315[i] and a feature 315[i−1] corresponding to the instruction 305[i−1] directly preceding the instruction 305[i]. The EM SC model 140 may, therefore, adapt the synthetic EM signal data 155 generated for the instruction 305[1] (e.g., segment 355[i]) based on the instruction 305[i−1] that precedes the instruction 305[i] within the SWM 101. The EM SC model 140 may be configured to utilize feature vectors 320 of any suitable size. For example, the EM SC model 140 may be configured to generate synthetic EM SC data 155 in response to feature vectors 320 covering a specified instruction window w, where w≥1; such that window size of one corresponds to feature vectors 320 including a single instruction 305, a window size of two corresponds to feature vectors 320 including an instruction 305 and directly preceding instruction 305 (e.g., feature 315[i] and 315[i−1]), and so on.

As disclosed herein, the synthetic SC data 150 generated for respective SWM 101 may be unique to the SWM 101 (and/or the MEC thereof). Accordingly, the synthetic SC data 155 generated for a SWM 101 may include and/or be referred to as an SC signature or SC fingerprint of the SWM 101. The synthetic EM SC data 155 generated for the SWM 101 may include and/or be referred to as an EM SC signature or EM SC fingerprint.

The SCA module 110 may be further configured to record synthetic SC data 150 determined for respective SWM 101. The SCA module 110 may be configured to store, record, and/or maintain synthetic SC data 150 according to any suitable scheme and/or in any suitable format. The synthetic SC data 150 generated for a SWM 101 may be characteristic of and/or unique to the SWM 101 (and/or MEC thereof), e.g., may distinguish the SWM 101 from other SWM 101. The synthetic SC data 150 of a SWM 101 may, therefore, include an SC signature or SC fingerprint of the SWM 101. The synthetic EM SC data 155 generated for an SWM 101 may include and/or be referred to as an EM SC signature or EM SC fingerprint of the SWM 101.

In some implementations, the SCA module 110 may be configured to record synthetic SC data 150 determined for respective SWM 101 within a software module (SWM) datastore 360. The SWM datastore 360 include and/or be implemented by use of any suitable DSR resources, including, but not limited to, DSR resources of the apparatus 102 (e.g., memory resources 104-2, NTS resources 104-3, and/or the like), external DSR resources, remote DSR resources, network DSR resources, and/or the like. The SWM datastore 360 may include any suitable information pertaining to a SWM 101 according to any suitable scheme and/or format. As illustrated in the FIG. 3 example, the EM SC synthesis module 130 may be configured to record synthetic SC data 150 determined for respective SWM 101 within respective SWM profiles 350. As used herein, a SWM profile 350 may include any suitable information pertaining to a SWM 101 including, but not limited to: the target architecture 201 of the SWM 101, MEC of the SWM 101, executable code 302 extracted from the SWM 101, build information pertaining to the SWM 101 (e.g., intermediate language representations of the SWM 101), and/or the like. A SWM profile 350 may further include information pertaining to SC characteristics of the SWM 101. The SWM profiles 350 may include synthetic SC data 150 generated for respective SWM 101. In the FIG. 3 example, the SWM profile 350 may include synthetic EM SC data 155 generated for the SWM 101. As disclosed herein, the synthetic EM SC data 155 may include an EM SC signature or EM SC fingerprint of the SWM 101.

As disclosed herein, the SCA module 110 may be configured to generate synthetic SC data 150 configured to emulate any suitable feature(s) of the SC response of respective SWM 101. In some implementations, the SCA module 110 may be configured to generate synthetic EM SC data 155 including time domain representations of EM signals. As illustrated in the FIG. 3 example, the synthetic EM SC data 155 generated for a SWM 101 may be configured to represent a time domain EM signal, e.g., may include a series of EM amplitude values, each corresponding to a respective time index. The disclosure is not limited in this regard, however, and could be adapted to generate synthetic EM SC data 155 and/or EM SC signatures including any suitable representation of the EM SC response of a SWM 101, including, but not limited to: time domain representations (e.g., signal amplitude over time as illustrated in the FIG. 3 example), frequency domain representations (e.g., signal amplitude over frequency), spectrograms (e.g., frequency over time), and/or the like. In some implementations, the SCA module 110 may be configured to generate and/or maintain multiple representations of the EM SC response of respective SWM 101. For example, generating synthetic EM SC data 155 for a SWM 101 may include, inter alia: a) utilizing the EM SC synthesis module 130 to generate synthetic EM SC data 155 for the SWM 101, the synthetic EM SC data 155 including a time domain representation of the EM SC signature of the SWM 101 (e.g., as illustrated in FIG. 3), b) deriving one or more other representations of the EM SC signature from the synthetic EM SC data 155 (e.g., a frequency domain representation, spectrogram, and/or the like), and c) recording the time domain representation and the one or more other representations of the EM SC signature within an SWM profile 350 of the SWM 101.

As disclosed in further detail herein, the SCA module 110 may utilize the SC profile 350 of an SWM 101 to, inter alia, perform SC analysis pertaining to the SWM 101. The SC analysis may include a SC validation process. The SC validation process may include analyzing synthetic SC data 150 determined for the SWM 101, such as synthetic EM SC data 155 to, inter alia, identify anomalies and/or SC vulnerabilities of the SWM 101, such as injected code anomalies, the potential leakage of private information (e.g., cryptographic keys), or the like. The SC validation process may further include a) modifying the SWM 101 to mitigate the identified anomalies and/or SC vulnerabilities, b) determining updated synthetic SC data 150 for the modified SWM 101, and c) analyzing the updated synthetic SC data 150 to determine, inter alia, whether the identified anomalies and/or SC vulnerabilities were mitigated (and/or identify any new anomalies and/or SC vulnerabilities of the modified SWM 101). The synthetic SC data 150 determined for the SWM 101 may be used as a SC signature or baseline of the SWM 101. During operation, SCM data 250 acquired from the computing device 205 during execution of the SWM 101 may be compared to the SC signature of the SWM 101 and differences between the SC signature and acquired SCM data 250 may trigger detection of an anomaly, e.g., may be indicative of unauthorized modification of the SWM 101, compromise of the computing device 205, and/or the like.

As disclosed herein, the EM SC model 140 may be trained to emulate the EM SC of the computing device 205 (and/or architecture 201) through an AI/ML algorithm configured in accordance with the CODE2SC framework 340.

FIG. 4A is a schematic block diagram illustrating another example of a SCA module 110. The SCA module 110 may be configured for operation on an apparatus 102 including computing resources 104, as disclosed herein. The SCA module 110 may include and/or be coupled to an EM SC synthesis module 130. In the FIG. 4A example, the EM SC synthesis module 130 may be configured to learn, refine and/or otherwise develop an EM SC model 140 configured to emulate the EM SC of a specified architecture 201. The EM SC synthesis module 130 illustrated in the FIG. 4A example may be configured to learn an EM SC model 140 configured to emulate the EM SC of the architecture 201 of the computing device 205 illustrated in FIG. 2. In other words, the EM SC synthesis module 130 may be configured to learn an ML CFG 135, the ML CFG 135 configured to cause the EM SC model 140 to emulate the EM SC of the computing device 205 (and/or EM SC of architecture 201), as illustrated in the FIG. 3 example.

The EM SC synthesis module 130 may include and/or be coupled to machine-learning (ML) logic 400. The ML logic 400 may be configured to implement AI/ML training procedure(s) configured to learn an EM SC model 140 (and/or ML CFG 135) that accurately emulates the EM SC of architecture 201. The EM SC model 140 may be trained according to the CODE2SC framework 340 disclosed herein. The EM SC model 140 may be trained to generate EM signals for respective MEI of the architecture 201. The EM SC model 140 may be trained to convert individual MEI into realistic representations of the EM SC response of the architecture 201 to execution of the MEI. Alternatively, or in addition, the EM SC model 140 may be trained to convert MEI sequences into synthetic EM signals that emulate the EM SC response of the architecture 201 to execution of the MEI sequences (e.g., emulate the EM SC of an architecture 201 capable of concurrent execution).

The SCA module 110 (and/or ML logic 400) may be further configured to record features of the ML CFG 135 learned for respective architectures 210 within non-transitory storage. In some implementations, the SCA module 110 may be configured to retrieve, store, and/or otherwise maintain information pertaining to respective architectures 201 within non-transitory storage resources, such an architecture datastore 330, as disclosed herein.

ML logic 400 of the CODE2SC framework 340 may be configured to learn the EM SC model 140 through an adversarial approach. As illustrated in FIG. 4A, the EM SC synthesis module 130 may include a GAN-type architecture; the EM SC synthesis module 130 may include an EM SC data generator 440 (or generator 440) and an EM SC data discriminator 450 (or discriminator 450). The EM SC data generator 440 may include and/or correspond to an EM SC model 140, such as the trained EM SC model 140 illustrated in FIG. 3. The generator 440 and discriminator 450 may include and/or be implemented by use of any suitable AI/ML components. In the FIG. 4A example, the generator 440 and discriminator 450 may include respective ANN, the generator 440 may include a generator ANN 442 (or G ANN 442) and the discriminator 450 may include a discriminator ANN 452 (or D ANN 452).

According to the GANs-CTRM framework 340, the generator 440 and discriminator 450 may be configured with adversarial learning objectives, e.g., the generator 440 and discriminator 450 may be configured to complete with one another. As disclosed in further detail herein, the discriminator 450 be configured to learn to distinguish “real” SC data from “fake” SC data, whereas the generator 440 may be configured to learn to produce “fake” SC data that is identified as “real” by the discriminator 450. As used herein, “real” SC data may include and/or refer to data observed, measured and/or otherwise acquired from the computing device 205 (e.g., SCM data 250). In other words, “real” SC data may include and/or refer to authentic or valid EM SCM data 255. By contrast, as used herein, “fake” SC data may include and/or refer to synthetic or generative SC data (e.g., synthetic SC data 150).

The EM SC synthesis module 130 may be trained by use of training data, such as an architecture training dataset (ATD) 402. The ATD 402 may be stored, recorded, and/or otherwise maintained by use of DSR resources of the apparatus 102. In some implementations, the ATD 402 of the architecture 201 may be referenced by and/or maintained within the architecture datastore 33-0, e.g., portions of the ATD 402 of the architecture 201 may be maintained within a corresponding architecture profile 301.

An ATD 402 may include AI/ML training data configured in accordance with the GANs-CTRM framework 340. In the FIG. 4A example, the ATD 402 of architecture 201 may include entries 404 corresponding to respective MEI of the architecture 201. For example, the ATD 402 may include entries 404 corresponding to respective instructions 305, e.g., may include entries 404-1 through 404-T corresponding to the instruction namespace of the architecture 201. The entries 404 may include respective instruction vectors (IV) 405, each including one or more instructions 305. An IV 405 may be configured to represent execution of a specified instruction 305 (e.g., execution of a specified MEI). Alternatively, or in addition, an IV 405 may be configured to represent execution of a specified instruction 305 directly following another specified instruction 305 (e.g., execution of a specified instruction 305-n directly following another instruction 305-m). As disclosed herein, instructions 305 of the ATD 402 may include and/or correspond to MEI of the architecture 201, textual and/or semantic representations of respective MEI (e.g., ASM instructions,) and/or the like. The ATD 402 may be configured to span and/or cover the instruction namespace of the architecture 201. For example, the instruction namespace of the architecture 201 (and/or ISA thereof) may include T types of MEI (e.g., instructions 305-1 through 305-T) and the ATD 402 may include corresponding entries 404-1 through 404-T. Alternatively, or in addition, the ATD 402 may include multiple entries 404 for respective instructions 305. The ATD 402 may include entries 404 corresponding to respective instruction sequences, e.g., entries 404 configured to represent execution of instructions 305 directly after one or more other instructions 305. For example, ATD 402 may include a plurality of entries 404 for respective instructions 305 (e.g., instruction 305-n), each configured to characterize execution of the instruction 305-n directly following another instruction 305 (e.g., after one of instructions 305-1 through 305-T). For example, a first entry 404 for the instruction 305-n may be configured to characterize EM emitted in response to execution of the instruction 305-n following instruction 305-1, a second entry 404 for the instruction 305-n may be configured to characterize EM emitted in response to execution of the instruction 305-n following instruction 305-2, another entry 404 for the instruction 305-n may be configured to characterize EM emitted in response to execution of the instruction 305-n following instruction 305-T, and so on.

The ATD 402 may further include EM SCM data 155 characteristic of the execution of respective instructions 305 (and/or instruction sequences). Entries 404 of the ATD 402 may be configured to associate IV 405 with EM SCM data units 425, the EM SCM data units 425 including EM SCM data 255 acquired during execution of MEI corresponding to the IV 405. The EM SCM data units 425 may include EM data captured during execution of a specified instruction 305 and/or execution of the specified instruction 305 directly following execution of another instruction 305. The EM SCM data units 425 may include EM SCM data 255 acquired by any suitable means. The EM SCM data units 425 may, for example, include and/or be derived from EM SCM data 155 captured by an SC monitoring device 220 (and/or EM monitoring device 230), as illustrated in the FIG. 2 example. In other words, the ATD 402 may include authentic EM SCM data 255 for respective instructions 305, e.g., the ATD 402 may include entries 404-1 through 404-T including EM SCM data units 425-1 through 425-T including “real” EM SCM data 155 determined for instructions 305-1 through 305-T, respectively. The EM SCM DU 425 may include any suitable representation of an EM signal including, but not limited to: time domain representations (e.g., EM amplitude over time), frequency domain representations (e.g., EM amplitude over frequency), a spectrogram (e.g., frequency over time), and/or the like).

The ML logic 400 may be configured to train the EM SC synthesis module 130 according to the CODE2SC framework 340. As disclosed in further detail herein, training the EM SC synthesis module 130 may include processing training data associated with respective instructions 305 (e.g., entries 404 of the ATD 402) and updating the generator 440 and/or discriminator 450 based, at least in part, on the processing. Processing an entry 404 may include a) generating a training vector 420 corresponding to the instruction 305 of the entry 404, b) configuring the EM SC model 140 (e.g., generator 440) to produce an output S 445 including synthetic EM SC data 155 in response to the training vector 420, c) configuring the discriminator 450 to produce an output D 455, which may indicate, inter alia, a probability that output S 445 of the generator 440 represents authentic EM SCM data 255, and d) updating the generator 440 and/or discriminator 450 based, at least in part, on evaluation outputs S 445 and/or D 455.

As disclosed above, the generator 440 may be configured to generate synthetic EM SC data 155 in response to training vectors 420. The training vectors 420 may include respective noise signals Z (a noise vector 415). The ML logic 400 may be configured to generate a training vector 420 for a specified entry 404 by, inter alia, a) constructing a feature vector 320 for the entry 404, b) generating a noise vector 415, and c) appending the feature vector 320 to the noise vector 415. The feature vector 320 may include one or more features 315, including a feature 315 corresponding to the instruction 305 of the entry 404. The feature vector 320 may further include one or more preceding instructions 305, as disclosed herein (e.g., may include an instruction 305 executed directly before the instruction 305 characterized by the entry 404).

Instructions 305 may be translated to features 315 by a translation module 310, as disclosed herein. In some implementations, the translation module 310 may be configured to translate instructions 305 by use of a tokenizer 312 (and/or dictionary 314), as illustrated in the FIG. 3 example. Alternatively, the IV 405 of the ATD 402 may include features 315 rather than instruction 305, obviating the need for the translation module 310.

Noise vectors 415 may be generated by sampling noise produced by a noise generator 410. The noise generator 410 may be configured to generate noise vectors 415 of dimension Z as follows:

$$z ∈ {ℝ}^{Z} ∼ N ( 0 , 1 ) \qquad Eq . 1$$

The noise generator 410 may be configured to generate random noise adapted to cause the generator 440 to produce a wide variety of outputs that fall within a normal distribution, e.g., by sampling from different places within a target distribution. The noise vectors 415 may be configured to cause the generator 440 to produce as many plausible EM representations of respective instructions 305 as possible. In other words, the noise vectors 415 may be configured to cause the generator 440 to learn variations of the EM signals produced in response to execution of respective instructions 305 (and/or instruction sequences). FIG. 4B includes a plot 401 illustrating EM SCM data 255 corresponding to the same MEC (e.g., the same instruction 305 or instruction sequence). As illustrated in plot 401, the EM SCM data 255 captured during execution of the same MEC may exhibit slight variations, including variations in peak amplitude. The CODE2SC framework 340 may utilize the noise vectors 415 to learn a baseline or range of normalcy for the EM signals of respective MEI (and/or MEI sequences). By contrast, without the inclusion of random noise, the CODE2SC framework 340 may be limited to learning a single EM signal for each MEI.

In some implementations, the CODE2SC framework 340 may be configured to learn EM signals for respective instructions 305, e.g., learn EM signals for individual instructions 305 of the architecture 201. For example, the CODE2SC framework 340 may be trained by use training entries 404 including instruction vectors 405 including individual instructions 305.

Alternatively, or in addition, the CODE2SC framework 340 may be configured to learn EM signals for instruction sequences. In other words, the CODE2SC framework 340 may be configured to adapt EM signals learned for respective instructions 305 based, at least in part, on instructions 305 executed directly before the respective instructions 305. As disclosed herein, the inventors learned that the phenotype of the EM signals produced in response to execution of a given instruction 305 may be influenced by previously executed instruction(s) 305. For example, the EM signals emitted in response to execution of an instruction 305-i may be influenced by, inter alia, the instruction 305 that was executed directly before the instruction 305-i. The EM signals may differ when the instruction 305-i is executed following instruction 305-1, instruction 305-2, and so on (e.g., the EM signals produced in response to execution of an XOR may vary depending on whether the XOR is executed following an ADD, LDI, or other type of instruction 305).

In some implementations, the CODE2SC framework 340 may train the generator 440 to account for the influence of prior instructions 305. In the FIG. 4A example, the architecture 201 may include T instruction types (e.g., instructions 305-1 through 305-T), and the CODE2SC framework 340 may be configured to learn a set of T EM signals for each instruction 305, each corresponding to execution of the instruction 305 following a specified one of instructions 305-1 through 305-T. For example, the CODE2SC framework 340 may be configured to learn T sets of EM signals for an instruction 305-i, each corresponding to execution of the instruction 305-i directly following execution of one of instructions 305-1 through 305-T. The T sets of EM signals may be learned by use of training entries 404 configured to characterize the EM response of the architecture 201 to execution of the instruction 305-i following instructions 305-1 through 305-T, respectively. For example, the EM SC synthesis module 130 may learn EM signals for the instruction 305-i by use of training entries 404 configured as follows:

TABLE 1

| Entry 404 | IV 405 | EM SC Data Unit 425 |
|---|---|---|
| 404-i-1 | {305-1, 305-i} | EM SCM Data 255 characterizing EM SC |
| | | response of the architecture 201 to execution |
| | | of instruction 305-i directly following |
| | | execution of instruction 305-1. |
| 404-i-2 | {305-2, 305-i} | EM SCM Data 255 characterizing EM SC |
| | | response of the architecture 201 to execution |
| | | of instruction 305-i directly following |
| | | execution of instruction 305-2. |
| . . . | . . . | . . . |
| 404-i-T | {305-T, 305-i} | EM SCM Data 255 characterizing EM SC |
| | | response of the architecture 201 to execution |
| | | of instruction 305-i directly following |
| | | execution of instruction 305-T. |

According to the CODE2SC framework 340, the ML logic 400 may configure the generator 440 to learn to produce outputs S 445 including synthetic EM SC data 155 that emulates authentic EM SCM data 255. In other words, learning objectives of the generator 440 may be configured such that the generator 440 is incentivized to generate outputs S 445 that are identified as “real” or authentic by the discriminator 450. The learning objectives of the discriminator 450 may be adverse to the learning objectives of the generator 440. The learning objectives of the discriminator 450 may be configured such that the discriminator 450 is incentivized to accurately distinguish authentic EM SCM data 255 from synthetic EM SC data 155 produced by the generator 440. In other words, the discriminator 450 may be configured to learn to accurately classify EM SCM data units 425 as “real” or authentic and classify outputs S 445 of the generator 440 as “fake” or synthetic.

The architecture, structure, implementation, and/or configuration of the generator 440 and/or discriminator 450 may be defined in ML CFG 135, e.g., in the ML CFG 135 learned for architecture 201 in the FIG. 4A example. As illustrated in FIG. 4A, the ML CFG 135 may include ML configuration data pertaining to the generator 440 (ML CFG 135-G) and discriminator 450 (ML CFG 135-D). According to the CODE2SC framework 340, the ML logic 400 may configure the EM SC synthesis module 130 to learn and/or refine a) an ML CFG 135-G configured to cause the generator 440 to produce synthetic EM SC data 155 that accurately emulates the EM SC of the architecture 201 (e.g., generate outputs S 445 classified as “real” or authentic by the discriminator 450), and b) an ML CFG 135-D that accurately distinguishes authentic EM SCM data 255 from synthetic EM SC data 155 (e.g., generate outputs D 455 that identifies outputs S 445 generated for respective instructions 305 as synthetic or “fake” and identifies the corresponding EM SCM data units 425 as authentic or “real”).

Under the CODE2SC framework 340, the ML CFG 135-G may define the network architecture of the generator 440 (and/or generator ANN 442 thereof) as follows:

$$G : {ℝ}^{Z + T} \to {ℝ}^{S} \qquad Eq . 2$$

In Eq. 2, G represents the network architecture of the generator ANN 442, Z represents the dimension of the noise vectors 415 included in respective training vectors 420, T represents the dimension of respective features 315 (e.g., tokens) of the training vectors 420, and S represents the dimension of the outputs S 455 produced by the generator 440 in response to respective training vectors 420 (e.g., the dimension of the synthetic EM SC data 155 generated for respective instructions 305). According to Eq. 2, the generator ANN 442 may include, inter alia, an input layer configured to receive input vectors (e.g., training vectors 420) of dimension Z+T and an output layer configured to produce outputs S 445 including synthetic EM SC data 155. The network architecture of the generator ANN 442 may, for example, be configured to include an input layer including Z+T input nodes and an output layer including S output nodes. In some implementations, the generator ANN 442 may further include one or more intermediate layers logically disposed between the input layer and output layer (e.g., may include one or more hidden layers or the like).

Alternatively, or in addition, the EM SC model 140 may be configured to learn EM signals for respective instruction sequences (e.g., adapt the EM signals learned for respective instructions 305 based, at least in part, on one or more preceding instructions 305). For example, the ML CFG 135-G may define the network architecture of the generator 440 (and/or generator ANN 442 thereof) as follows G: [symbol] ^{Z+2T}→ [symbol] ^{S}, such that the generator 440 produces synthetic EM SC data 155 in response to feature vectors 320 including two tokens or features 315, e.g., a feature 315 representing the instruction 305 and a feature 305 representing an immediately preceding instruction 305.

Under the CODE2SC framework 340, the ML CFG 135-D may define the network architecture of the discriminator 450 (and/or discriminator ANN 452) as follows:

$$D : {ℝ}^{S + T} \to \{ 0 , 1 \} \qquad Eq . 3$$

In Eq. 3, D represents the network architecture of the discriminator ANN 452. According to Eq. 3, the discriminator ANN 452 may include, inter alia, an input layer configured to receive discriminator input vectors 451 of dimension S+T (e.g., an input layer including S+T input nodes) and an output layer configured to produce outputs D 455. The output layer of the discriminator ANN 452 may be configured to produce outputs D 455 that distinguish “fake” or synthetic EM SC data 155 produced by the generator from “real” or authentic EM SCM data 255, e.g., may include an output node configured to produce probability values between 0 and 1 in response to respective discriminator input vectors 451. The discriminator ANN 452 may be configured to a) generate an output D 455-S in response to a discriminator input vector 451-S including, inter alia, the output S 445 produced by the generator 440 for a specified instruction 305 (e.g., instruction 305-n), and/or b) generate an output 455-X in response to a discriminator input vector 451-X including, inter alia, the EM SCM data unit 425 associated with the specified instruction 305-n. The output D 455-S may indicate a probability that S 445 represents authentic EM SCM data 255 and the output D 455-X may indicate a probability that the corresponding EM SCM data unit 425 represents authentic EM SCM data 255.

Alternatively, or in addition, the discriminator 450 may be configured to evaluate synthetic EM SC data 155 generated based on instruction sequences. More specifically, the discriminator 450 may be configured to distinguish variations in the EM signals generated in response to execution of respective instructions 305 based, at least in part, on the instructions 305 executed directly before such instructions 305. In these implementations, the ML CFG 135-D may define the network architecture of the discriminator 450 (and/or discriminator ANN 452) as D: [symbol] ^{S+2T}→{0,1}. The discriminator ANN 452 may be configured to a) generate an output D 455-S in response to a discriminator input vector 451-S including, inter alia, the output S 445 produced by the generator 440 for a specified instruction 305 and preceding instruction 305 (e.g., instruction 305-n executed following instruction 305-m), and/or b) generate an output 455-X in response to a discriminator input vector 451-X including, inter alia, the EM SCM data unit 425 associated with the specified instruction sequence.

As disclosed herein, the ML logic 400 may configure the generator 440 and discriminator 450 with adverse learning objectives; the discriminator ANN 452 (and/or ML CFG 135-D) may learn to distinguish synthetic EM SC data 155 produced by the generator ANN 442 from authentic EM SCM data 255 and the generator ANN 442 may learn to produce synthetic EM SC data 155 that are classified as authentic or “real” by the discriminator 450. The ML logic 400 may configure the adverse learning objectives of the generator 440 and discriminator 450, as follows:

$${min}_{G} {max}_{D} \_Loss = {E}_{x} [ log D ( x ) ] + {E}_{z} [ log 1 - D ( G ( z ) ) ] \qquad Eq . 4$$

The generalized GAN model above, the ML logic 400 may configure learning objectives of the generator 440 to minimize the loss quantity of Eq. 4 and configure learning objectives of the discriminator 450 to maximize Eq. 4. In Eq. 4, D(x) represents output D 455-X of the discriminator 450, which may include an estimate of the probability that EM SCM data units 425 associated with respective instructions 305 represent authentic EM SCM data 255; G(z) represents outputs S 445 produced by the generator 440 given noise vectors (\hat{z}) 415 and/or corresponding training vectors 420; D(G(z)) represents output D 455-G of the discriminator 450, which may include an estimate of the probability that synthetic EM SC data 155 of the outputs S 445 represent authentic EM SCM data 255; and Eₓ and E_{z} are expected values over all instances of authentic EM SCM data units 425 and synthetic EM SC data 155 (e.g., outputs S 445), respectively.

The ML logic 400 may be configured to train the EM SC synthesis module 130 to emulate EM signals of respective instructions 305. According to the CODE2SC framework 340, adversarial learning objectives pertaining to a specified instruction 305 (e.g., instruction 305-n) may be expressed as follows:

$${min}_{G} {max}_{D} \_Loss = {E}_{x} [ log D ( x , {i}_{n} ) ] + {E}_{z} [ log 1 - D ( G ( z , {t}_{n} ) ) ] \qquad Eq . 5$$

In Eq. 5, D(x, iₙ) represents the output D 455-X of the discriminator ANN 452 in response to a discriminator input vector 451-X including, inter alia, authentic EM SCM data 255 (x) associated with instruction 305-n (e.g., EM SCM data unit 425-n), G(z, tₙ) represents an output S 445 produced by the generator ANN 442 in response to a training vector 420 including a combination of the feature 315-n associated with the instruction 305-i (e.g., token) and a noise vector \hat{z} 415, and D(G(\hat{z}′, tₙ)) may represent the output D 455-S produced by the discriminator ANN 452 in response to a discriminator input vector 451-S including, inter alia, G(z, tₙ), e.g., synthetic EM SC data 155 produced by the generator ANN 452 for the instruction 305-n.

In some implementations, the CODE2SC framework 340 may modify the generalized approach of Eq. 4 and/or 5 to incorporate a conditional GANs architecture, as follows:

$$Loss = {min}_{G} {max}_{D} {E}_{x} [ log D ( x ‖ y ) ] + {E}_{z} [ log 1 - D ( G ( z ‖ y ) ) ] \qquad Eq . 6$$

In Eq. 6, the generalized loss function of Eq. 4 and 5 is adapted to incorporate labels (y) representing respective instructions 305 (e.g., features 315); G(z∥y) represents synthetic EM SC data 155 produced by the generator 440 for instruction 305-y (e.g., output S 445 generated in response to a training vector 420 including noise vector 415 (z) and feature 315-y), D(G(z∥y)) represents the output D 455-S of the discriminator 450 in response to the synthetic EM SC data 155 of generator output S 445, and D(x∥y) represents the output D 455-X of the discriminator 450 in response to “real” EM SCM data 255 associated with instruction 305-y (e.g., EM SCM DU 425-y).

In some implementations, the CODE2SC framework 340 may be further configured to incorporate Wasserstein Distance and Gradient Penalty (WGAN-GP) learning, as follows:

$${min}_{G} {max}_{D} {𝔼}_{G ( z ) ∼ {ℙ}_{g}} [ D ( G ( z ) ) ] - {𝔼}_{x ∼ {ℙ}_{r}} [ D ( x ) ] + λ {𝔼}_{x ∼ {ℙ}_{r}} [ {( {‖ {∇}_{\hat{x}} D ( \hat{x} ) ‖}_{2} - 1 )}^{2} ] \qquad Eq . 7$$

In Eq. 7, the

$${𝔼}_{G ( z ) ∼ {ℙ}_{g}} [ D ( G ( z ) ) ] - {𝔼}_{x ∼ {ℙ}_{r}} [ D ( x ) ]$$

term represents the Wasserstein distance or loss (W_{Loss}) and the

$$λ {𝔼}_{x ∼ {ℙ}_{r}} [ {( {‖ {∇}_{\hat{x}} D ( \hat{x} ) ‖}_{2} - 1 )}^{2} ]$$

term presents the gradient penalty (gp). The WGAN-GP approach may be adapted to incorporate the labels of Eq. 6 as follows:

$${Min}_{G} {max}_{D} {𝔼}_{G ( z ‖ t ) ∼ {ℙ}_{g}} [ D ( G ( z ‖ t ) ) ] - {𝔼}_{x ∼ {ℙ}_{r}} [ D ( s ‖ t ) ] + λ {𝔼}_{\hat{s} ∼ {ℙ}_{r}} [ {( {‖ {∇}_{\hat{s}} D ( \hat{s} ‖ t ) ‖}_{2} - 1 )}^{2} ] \qquad Eq . 8$$

In Eq. 8, t represents the feature vector 320 associated with a specified instruction 305 and/or instruction sequence, ŝ represents synthetic EM SC data 155 produced by the generator 440 in response to a training vector 420 including a noise vector 415 (z) and feature vector 320 (t), e.g., G(z∥t), s represents “real” EM SC data 255 associated with the specified instruction 305 and/or instruction sequence (e.g., an EM SC data unit 425), D(s∥t) represents the output D 455-X produced by the discriminator 450 in response to the “real” EM SC data 255 associated with the instruction 305 (and/or instruction sequence), and D(ŝ∥t) represents the output D 455-S produced by the discriminator 450 in response to the synthetic EM SC data 155 (ŝ).

The ML logic 400 may be configured to train the EM SC synthesis module 130 in accordance with the CODE2SC framework 340, e.g., in accordance with an AI/ML algorithm or procedure. In some implementations, the ML logic 400 may be configured to implement one or more iterative AI/ML procedures, e.g., implement AI/ML procedures including a plurality of iterations. As used herein, an iteration (or training iteration) may include and/or refer to an AI/ML processes by which the CODE2SC framework 340 learns to emulate EM signal(s) associated with specified machine-code instructions of the architecture 201. By way of non-limiting example, an iteration may include a) generating a training vector 420 for a specified instruction 305, b) configuring the generator 440 to produce an output S 445 including synthetic EM SC data 155 configured to emulate a response of the EM SC of the architecture 201 to execution of the specified instruction 305 (e.g., execution of the corresponding machine-code instruction), c) configuring the discriminator 450 to produce one or more outputs D 455, such as an output D 455-G configured to indicate a probability that the output S 445 represents authentic EM SCM data 255 and/or an output D 455-X configured to indicate a probability that the EM SCM data unit 425 associated with the specified instruction 305 represents authentic EM SCM data 255, d) evaluating the outputs S 445 and D 455, and e) updating the ML CFG 135-G of the generator 440 and/or the ML CFG 135-D of the discriminator 450 based, at least in part, on the evaluating.

Portions of the ML CFG 135 learned for the architecture 201 may be recorded, stored, and/or otherwise maintained within a profile of the architecture 201, e.g., within an architecture profile 301, as disclosed herein. The EM SC synthesis module 130 may be configured to maintain portions of the ML CFG 135 learned for the architecture 201 within a non-transitory (NT) ML CFG 435. The NT ML CFG 435 may include information pertaining to implementation of the EM SC synthesis module 130 of the CODE2SC framework 340. The NL ML CFG 435 may capture a designated AI/ML state of the ML CFG 135, e.g., may capture the state of the ML CFG 135 after completion of one or more AI/ML training procedures, after learning EM signals for one or more instructions of the architecture 201, and/or the like. The NT ML CFG 435 may include features of the ML CFG-G learned for the generator 440 (e.g., may include, inter alia, hyperparameters learned for the generator ANN 442), may include features of the ML CFG-D learned for the discriminator 450 (e.g., may include, inter alia, hyperparameters learned for the discriminator ANN 452), and so on. The NT ML CFG 435 may be used to instantiate an EM SC synthesis module 130 in the designated AI/ML state. For example, the EM SC synthesis module 130 may be configured to record a first NT ML CFG 435 after completing a first set of AI/ML procedures to learn a first set of instructions of the architecture 201 (e.g., about 50% of the architecture namespace). The SCA module 110 may utilize the first NT ML CFG 435 to implement a second set of AI/ML procedures, which may include a) instantiating and/or configuring EM SC synthesis module 130 in accordance with the first NT ML CFG 435, b) performing the second set of AI/ML procedures to learn another, second set of instructions of the architecture 201 (e.g., the remaining 50% of the architecture namespace) such that the resulting EM SC synthesis module 130 can accurately emulate the EM response of the first and second set of instructions, and c) recording a second NT ML CFG 435 (and/or updating the first NT ML CFG 435). As disclosed in further detail herein, the NT ML CFG 435 may also be used to instantiate, configure, and/or implement an EM SC synthesis module 130, as illustrated in FIGS. 1 and/or 3, e.g., a “trained” EM SC synthesis module 130.

The CODE2SC framework 340 disclosed herein may include and/or implement any suitable AI/ML architecture. FIG. 4C illustrates an example of a CODE2SC framework 340-1 including a residual network (ResNet) architecture, e.g., a ResGANs-CODE2SC framework 340-1. ResNet architectures typically utilize higher-dimensional inputs (e.g., for image processing or the like). As such, in the FIG. 4C example, the generator 440-1 may include an input converter 444 configured to convert 1-dimensional (1D) input data into 3-dimensional (3D) data suitable by the ResNet. The input converter 444 may include a reshape layer and 1D convolution layer. The reshape layer may be configured to transform 1D input data into a (1, input, 1), which may be fed into the 1D convolution layer creating (1, input, 3) shaped input data, e.g., where input values are repeated across the third dimension. The generator 440-1 may further include an N-layer ResNet. In the FIG. 4C example, the generator 440-1 may include a ResNet that is about 50 layers deep, e.g., a ResNet-50.

The generator 440-1 may further include an output converter 448. The output converter 446 may be configured to convert 3D data utilized within the ResNet into 1D data using global average pooling (e.g., a global average layer). which may be configured to convert the 3D data utilized within the ResNet into 1D data. The output converter 446 may be configured to convert 3D data utilized within the ResNet into 1D by use of a global averaging layer. The output converter 446 may further include a dropout layer and one or more fully connected dense (FCD) layers (e.g., 6 FCD layers) to generate synthetic EM SC data 155 including a 1D array of EM values. The discriminator 450-1 may include a plurality of FCD layers, e.g., may include six or more FCD layers as opposed to convolutional layers as utilized within the generator 440-1.

FIG. 4D is a schematic block diagram illustrating an example of a CODE2SC framework 340-2 configured to implement a transformer architecture, e.g., the framework 340-2 may include a TransGANs-CODE2SC framework 340-2. In the FIG. 4D example, the generator 440-2 may include a transformer block followed by a set of FCD layers. The generator 440-2 may be configured to reshape input data into a 3D array, as disclosed herein. Within the transformer block, layer normalization and multi-headed attention may be applied followed by a first dropout layer. The input values may then be added followed by a second normalization layer, first 1D convolution layer, second dropout layer, and a second 1D convolution layer. Global average pooling may then be applied to convert the result to a 1D array and the synthetic EM data 155 may be formed by a series of FCD layers and a third dropout layer. In the FIG. 4D example, the discriminator 450-2 may have a similar structure as the generator 440-2.

FIG. 4E is a schematic block diagram illustrating an example of a CODE2SC framework 340-3 including a diffusion architecture, e.g., a DiffGANs-CODE2SC framework 340-3. As illustrated in FIG. 4E, the DiffGANs-CODE2SC framework 340-3 may be configured to implement a plurality of diffusion steps, each step including denoising respective segments. Due to the increased processing overhead involved in multi-step processing, the generator 440-3 and discriminator 450-3 may have a relatively simply architecture. As illustrated in the FIG. 4E example, the generator 440-3 and discriminator 450-3 may include respective sets of FCD layers, e.g., about 7 FCD layers, respectively.

Referring back to FIG. 3, in some implementations, the ML logic 400 may be configured to train the EM SC synthesis module 130 to generate EM signals for respective instructions 305. The EM signals for respective instructions 305 may be learned through iterative AI/ML procedures. Table 2 below includes pseudocode illustrating an example of an AI/ML procedure for learning EM signals associated with a specified instruction 305 (e.g., instruction 305-n) including Q iterations i:

TABLE 2

| 1: | function TRAIN:(instruction n, instruction | |
|---|---|---|
| | training signal sₙ, number of | |
| 2: | training batch steps Q, learning step size α): | |
| | for i = 1 to Q do | |
| 3: | tₙ ← φ(n) | Retrieve feature for instruction |
| 4: | z~N(0,1)^{z} | Draw sample of random noise |
| 5: | ŝ ← G(z, tₙ) | Forward through generator |
| 6: | dₓ ← D(sₙ, tₙ) | Discriminate real signal |
| 7: | dₛ ← D(ŝ, tₙ) | Discriminate synthetic signal |
| 8: | L_{D} ← log(dₓ) + (log(1 − dₛ)) | Discriminator loss |
| 9: | D ← D − α ∂L_{D}/∂D | Update discriminator |
| 10: | L_{G} ← log(dₛ) | Generator loss |
| 11: | G ← G − α ∂L_{G}/∂G | Update generator |

| | |
|---|---|
| 12: | end for |

In Table 2, sₙ may represent training data associated with instruction 305-n (e.g., an EM SCM data unit 425-n including EM SCM data 255 captured during execution of machine-code corresponding to the instruction 305-n), the symbol φ represents the translation module 310 (and/or tokenizer 312), the symbol t represents the feature 315 determined for instruction n (e.g., feature 315-n), § represents synthetic EM SC data 155 produced by the generator 440 (e.g., S 445), dx represents discriminator output D 455-X, and ds represents discriminator output D 455-S.

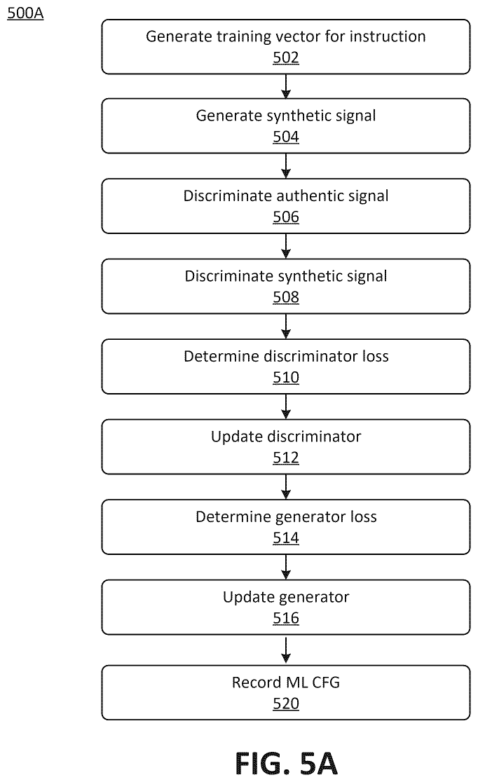

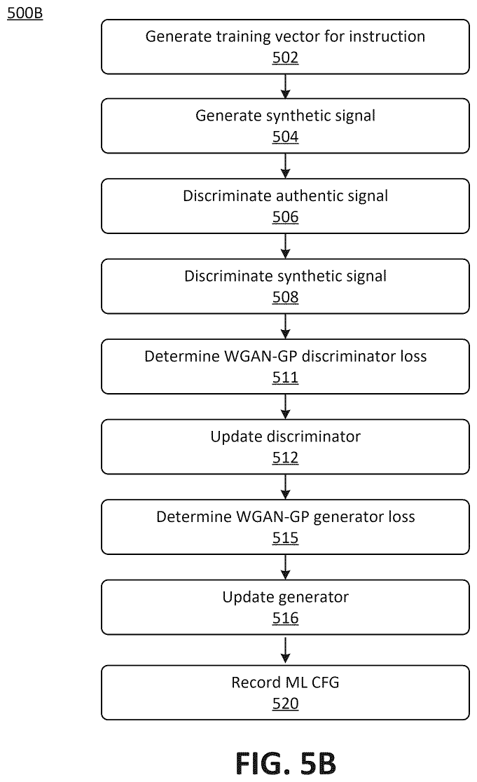

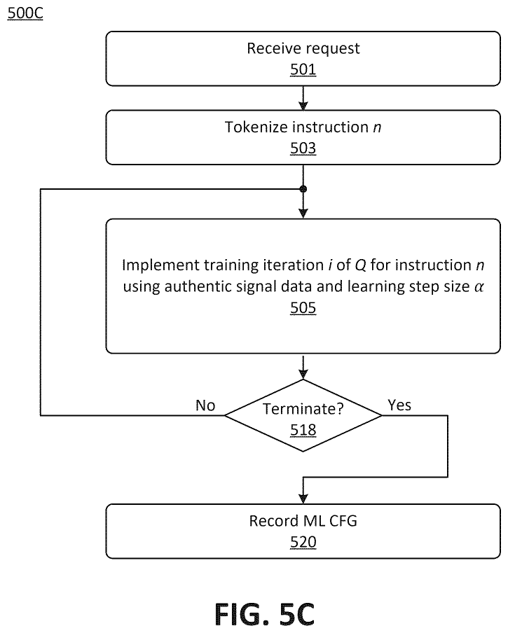

By way of further non-limiting example, FIG. 5A is a flow diagram illustrating an example of a method 500A for implementing a training iteration of an AI/ML procedure, as disclosed herein. The training iteration may include and/or correspond to an iteration i of the TRAIN function illustrated in Table 2. The training iteration may include processing a specified instruction 305-n and/or training vector 420 corresponding to the specified instruction 305-n, e.g., processing a training entry 404-n of the ATD 402. Operations of the training iteration of method 500A may be implemented by an SCA module 110 (e.g., EM SC synthesis module 130) in accordance with a CODE2SC framework 340, as disclosed herein. Although FIG. 5A describes a training procedure configured to learn EM signals for individual instructions 305, the disclosure is not limited in this regard and could be adapted to learn EM signals for instruction sequences, e.g., adapt EM signals learned for respective instructions 305 based, at least in part, on the instruction 305 executed immediately prior.

Step 502 may include generating a training input vector 420 for the instruction 305-n. Step 502 may include retrieving a training entry 404 configured to characterize EM emission associated with execution of the instruction 305-n on the architecture 201. In some implementations, step 502 may further include converting the instruction 305-n of the training entry 404 into a feature 315-n, e.g., by use of a translation module 310 or the like. The translation module 310 may be configured to tokenize the instruction 305-n, as disclosed herein, e.g., may include translating the instruction 305-n to a token (tₙ) of dimension T.

Step 502 may further include combining the feature 315-n (e.g., token tₙ) with a noise vector 415. Step 502 may include drawing Z samples from a random noise signal. In some implementations, step 502 may include configuring a noise generator 410 to produce a noise vector \hat{z} 415 of dimension Z. Step 502 may further include combining the noise vector 415 with the feature 315-n associated with the instruction 305-n (token tₙ) to produce a training vector 420 of dimension Z+T, e.g., may include appending the feature 315-n (e.g., token tₙ) to the noise vector 415, concatenating the feature 315-n (e.g., token tₙ) onto the end of the noise vector 415, or the like.

Step 504 may include generating synthetic EM SC data 155 for the instruction 305-n. Step 504 may include configuring the generator 440 (and/or generator ANN 442 thereof) to generate an output S 445 in response to the training vector 420. The output S 445 produced by the generator 440 at 504 may include synthetic EM SC data 155 configured to emulate EM signal(s) produced by a computing device 205 of architecture 201 during execution of the machine-code instruction represented by the instruction 305-n. The output S 445 may be expressed as G(z, tₙ), where G represents the generator ANN 442, Z represents the noise signal generated at 502, and ty represents the feature 315-n (e.g., token) of the instruction 305-n. In some implementations, the generator ANN 442 may include a feedforward neural network (FNN) and step 504 may include feeding the training vector 420 into an input layer of the generator ANN 442 such that the training vector 420 is fed-forward through the generator ANN 442 to produce an output S 445 on the output layer thereof.

Step 506 may include discriminating an authentic signal associated with the instruction 305-n. Step 506 may include configuring the discriminator 450 (and/or discriminator ANN 452 thereof) to generate an output D 455-X in response to a discriminator input vector 451-X including, inter alia, an EM SC data unit 425 associated with the instruction 305-n (an EM SC data unit 425-n). The EM SC data unit 425 may include EM SCM data 255 acquired during execution of the machine-code instruction represented by instruction 305-n, e.g., may include “real” or authentic EM SCM data 255 determined for the instruction 305-n. The discriminator output D 455-X may be expressed as D(x) or D(x, tₙ), where x represents the EM SC data unit 425-n and tₙ represents the token of the corresponding instruction 305-n (e.g., feature 315-n). The output D 455-X may indicate a probability that the EM SCM data unit 425-n represents “real” or authentic EM SCM data 255, as disclosed herein.

Step 508 may include discriminating the synthetic signal generated for the instruction 305-n. Step 508 may include discriminating the synthetic EM signal S 445 produced by the generator 440 (and/or generator ANN 442) at 504 in response to the training vector 420 generated at 502. Step 508 may include configuring the discriminator 450 (and/or discriminator ANN 452 thereof) to generate an output D 455-S in response to a discriminator input vector 451-S including, inter alia, the synthetic EM SC data 155 (S 445) generated at 504. The discriminator output D 455-S may be expressed as D(G(z, tₙ)), where G(z, tₙ) represents the output S 445 of the generator 440 in response to the input vector 420 including the noise vector 415-n (z) and token (tₙ), e.g., feature 315-n. The output D 455-S produced by the discriminator 450 at 508 may indicate a probability that the synthetic EM SC data 155 produced by the generator 440 (e.g., S 445) represents “real” or authentic EM SCM data 255, as disclosed herein.

Step 510 may include determining a discriminator loss. The discriminator loss for the training iteration (i) may be based on outputs D 455-X and D 455-S generated at 506 and 508, respectively. The discriminator loss may be proportional to the degree to which the discriminator 450 (and/or discriminator ANN 452) accurately classified the authentic EM signal associated with the instruction 305-n (e.g., discriminator input vector 451-X including EM SCM data unit 425-n) as “real” or authentic at 506 and/or may be inversely proportional to the degree to which the discriminator (and/or discriminator ANN 452) misclassified the synthetic signal produced by the generator 440 (e.g., discriminator input vector 451-S including synthetic EM SC data 155 of output S 445) as “real” or authentic at 508. In some implementations, step 510 may include evaluating a discriminator loss function (LD) per Eq. 6 below:

$${L}_{D} = log ( {d}_{x} ) + ( log ( 1 - {d}_{s} ) ) \qquad Eq . 9$$

In Eq. 9, dx represents the discriminator output D 455-X of step 506, e.g., D(x) and dₛ represents discriminator output D 455-S of step 508, e.g., D(G(z, tᵢ)).

Step 512 may include updating the discriminator 450 (and/or discriminator ANN 452) based, at least in part, on the discriminator loss determined at 510. Step 512 may include updating the ML CFG 135-D of the discriminator ANN 452. Updates to the discriminator ANN 452 may be based on evaluation of a discriminator gradient (per an optimization or other AI/ML algorithm). By way of non-limiting example, the discriminator may be updated per Eq. 10 below:

$${D}_{i + 1} ← {D}_{i} - {α}_{D} \frac{\partial {L}_{D}}{\partial D} \qquad Eq . 10$$

In Eq 10, Dᵢ₊₁ represents the updated discriminator 450 (and/or discriminator ANN 452), e.g., discriminator 450 to be utilized in a next training iteration i+1, Dᵢ represents the current state of the discriminator 450 (and/or discriminator ANN 452), e.g., discriminator 450 of training iteration i,

$$\frac{\partial {L}_{D}}{\partial D}$$

represents the discriminator gradient, and ap represents an discriminator learning step size and/or learning rate parameter.

Step 514 may include determining a generator loss. The generator loss for the training iteration (i) may be based on output D 455-S generated at 508. The generator loss may be proportional to the degree to which the discriminator 450 (and/or discriminator ANN 452) was “fooled” into misclassifying the synthetic signal produced by the generator 440 (e.g., S 445) as “real” or authentic at 508. In some implementations, step 514 may include evaluating a generator loss function (L_{G}) per Eq. 11 below:

$${L}_{G} = log ( {d}_{s} ) \qquad Eq . 11$$

In Eq. 11, dₛ represents the discriminator output D 455-S, e.g., D(G(z, tₙ)), which may indicate a degree to which the discriminator ANN 452 classified the synthetic EM SC data 155 of output S 445-n as “real” or authentic EM SCM data 255.

Step 516 may include updating the generator 440 (and/or generator ANN 442) based, at least in part, on the generator loss determined at 514. Step 516 may include updating the ML CFG 135-G of the generator ANN 442. Updates to the generator ANN 442 may be based on evaluation of a generator gradient (per an optimization or other AI/ML algorithm). By way of non-limiting example, the discriminator may be updated per Eq. 12 below:

$${G}_{i + 1} ← {G}_{i} - {α}_{G} \frac{\partial {L}_{G}}{\partial G} \qquad Eq . 12$$

In Eq. 12, Gᵢ₊₁ represents the updated generator 440 (and/or generator ANN 442), e.g., generator 440 to be utilized in a next training iteration i+1, Gᵢ represents the current state of the generator 440 (and/or generator ANN 442), e.g., generator 440 of training iteration i,

$$\frac{\partial {L}_{G}}{\partial G}$$

represents a generator gradient, and α_{G} represents a generator learning step size and/or learning rate parameter.

Step 520 may include recording ML CFG 135 learned through, inter alia, implementation of the method 500, as disclosed herein. Features of the ML CFG 135 may be recorded within non-transitory storage, such as an architecture datastore 330, architecture profile 301, and/or the like. Step 520 may include recording and/or updating an NT ML CFG 435 with features of the ML CFG 135. Step 520 may include recording features of the ML CFG 135-G learned for the generator 440 (and/or generator ANN 442) per the updates of step 514, recording features of the ML CFG 135-D learned for the discriminator (and/or discriminator ANN 452) per the updates of step 510, recording extraction and/or translation data (e.g., information pertaining to the extraction and/or translation of MEC of the architecture 201 to features 315), and so on.

Although specific examples of AI/ML procedures are described herein, the disclosure is not limited in this regard, CODE2SC framework 340 disclosed herein may be configured to implement any suitable AI/ML procedure and/or algorithm. Table 3 includes pseudocode illustrating an example of an WGAN-GP approach to learning EM signals for respective instructions 305, e.g., learning EM signals for a specified instruction 305-n over Q iterations i:

TABLE 3

| 1: | function TRAIN_WGAN-GP:( instruction n, | |
|---|---|---|
| | instruction training signal sₙ, | |
| | number of training batch steps Q, | |
| | learning step size α, gradient penalty | |
| | coefficient λ): | |
| 2: | for i = 1 to Q do | |
| 3: | tₙ ← φ(n) | Retrieve feature for instruction |
| 4: | z~N(0,1)^{z} | Draw sample of random noise |
| 5: | ŝ ← G(z, tₙ) | Forward through generator |
| 6: | dₓ ← D(sₙ, tₙ) | Discriminate real signal |
| 7: | dₛ ← D(ŝ, tₙ) | Discriminate synthetic signal |
| 8: | L_{D} ← W_{Loss} + λ · gp | Discriminator loss |
| 9: | D ← D − α ∂L_{D}/∂D | Update discriminator |
| 10: | L_{G} ← −mean(dₛ) | Generator loss |
| 11: | G ← G − α ∂L_{G}/∂G | Update generator |

| | |
|---|---|
| 12: | end for |
| 13: | end function |

As illustrated in Table 3, the discriminator loss (L_{D}) may be a function of a Wasserstein distance (W_{Loss}) and gradient penalty (gp), which may be estimated per Eq. 13 below:

$${W}_{Loss} ← mean ( {d}_{x} ) - mean ( {d}_{s} ) \qquad Eq . 13$$

$$gp ← {( {∇}_{\hat{x}} {{D}_{w} ( \hat{x} )}_{2} - 1 )}^{2}$$

$${L}_{D} ← {W}_{Loss} + λ \cdot gp$$

FIG. 5B is a flow diagram illustrating an example of a method 500B for learning EM signals of an instruction 305. The method 500B may include implementation of an iteration (i) of the WGAN-GP AI/ML procedure of Table 3. Steps 502-508 may include generating a training vector 420 for the instruction 305-n, generating synthetic EM SC data 155 for the instruction 305-n (e.g., configuring the generator 440 to produce an output $445 in response to the training vector 420), discriminating authentic EM SC data 255 associated with the instruction 305-n, and discriminating the output S 445 of the generator 440.

Step 511 may include determining a WGAN-GP discriminator loss (L_{D}) for the iteration i. The WGAN-GP discriminator loss (L_{D}) may be estimated per Eq. 13 above. Step 512 may include updating the discriminator 450 in accordance with the discriminator loss (L_{D}) determined at 511, as disclosed herein.

Step 515 may include determining a WGAN-GP generator loss (LG) for the iteration i. The WGAN-GP generator loss (LG) may include the negative mean of the discriminator output 455-S for the synthetic EM SC data 155 produced by the generator 440 (e.g., L_{G}=−mean (dₛ)). Step 516 may include updating the generator 440 in accordance with the generator loss (L_{G}) determined at 515 and step 520 may include recording updates to the ML CFG 135, as disclosed herein.

FIG. 5C is a flow diagram illustrating another example of a method for learning EM signals for instructions 305 of an architecture 201, as disclosed herein. The method 500C may be configured to train the EM SC synthesis module 130 to emulate EM signals of a specified instruction 305-n, as in the example illustrated by the pseudocode of Tables 2 and/or 3.

At 501, the ML logic 400 of the EM SC synthesis module 130 may receive a request to implement a AI/ML training procedure. The request may specify an instruction 305-n. The request may also include and/or reference EM SCM data 255 associated with the instruction 305-n (e.g., an entry 404 for the instruction 305-n including a corresponding training signal Sy, such as EM SCM data unit 425).

At 503, the ML logic 400 may be configured to tokenize the instruction n, which may include mapping the instruction n to a feature 315-n, as disclosed herein.

At 505, the ML logic 400 may configure the generator 440 and discriminator 450 of the CODE2SC framework 340 to implement an iteration of the AI/ML procedure disclosed herein, e.g., Q iterations. At 505, the ML logic 400 may configure the EM SC synthesis module 130 to implement operations corresponding to the pseudo code of lines 4 through 11 of Table 2 (and/or steps 502 through 520 of the method 500A illustrated in FIG. 5A). Alternatively, at 505, the ML logic 400 may configure the EM SC synthesis module 130 to implement operations corresponding to the pseudo code of lines 4 through 11 of Table 3 (and/or steps 502 through 520 of the method 500B illustrated in FIG. 5B).

Implementing step 505 for an iteration i may include generating a training vector 420 including a noise vector \hat{z} 415 and feature 315-n (tₙ), configuring the generator 440 to produce synthetic EM SC data 155 in response to the training vector 420-n (e.g., produce an output S 451 or ŝ), discriminating the EM SCM data unit 425-n associated with the instruction 305-n (e.g., generating an output D 455-X or dₓ, where dₓ←D(sₙ, tₙ)), discriminating the synthetic data (e.g., generating an output D 455-S or dₛ, where dₛ←D(G(z, tₙ))), determining a discriminator loss for the iteration i, updating the discriminator 450 and/or discriminator ANN 452 per the determined discriminator loss (e.g., Dₙ₊₁←Dₙ−α∂L_{D}/∂_{D}), determining a generator loss for the iteration i, updating the generator 440 (and/or generator ANN 442) per the determined generator loss, recording updated ML CFG 135, and so on. In some implementations, the discriminator loss may be determined per step 510 of FIG. 5A and/or line 8 of Table 2. Alternatively, the discriminator loss may be determined per step 511 of FIG. 5B and/or line 8 of Table 3 (e.g., Eq. 13). The generator loss may be determined per step 514 of FIG. 5A and/or line 10 of Table 2. Alternatively, the generator loss may be determined per step 515 of FIG. 5B and/or line 10 of Table 3.

Step 518 may include determining whether to continue the iterative AI/ML procedure. Step 518 may include evaluating termination criteria of the AI/ML procedure. For example, step 518 may include determining whether the ML logic 400 has completed the number of iterations specified in the request received at 501, e.g., whether Q iterations have been completed. Alternatively, or in addition, step 518 may include evaluating performance-based termination criteria. For example, step 518 may include evaluating an error metric. The error metric may be configured to quantify error between the synthetic EM SC data 155 generated at 505 and corresponding “real” EM SCM data 255, e.g., a corresponding EM SCM DU 425. The error metric may be configured to quantify error by any suitable means, e.g., difference, distance, RMS, Euclidian distance, and/or the like. For example, step 518 may include comparing an error metric to a threshold, e.g., terminate←eᵢ≤eₜₕ, where eᵢ is the error metric determined for the current iteration i and eth is an error threshold. In some implementations, the error metric may correspond to the Euclidean distance between synthetic EM SC data 155 generated over one or more iterations of step 505 to the “real” EM SCM data 255 of entire SWM 101, e.g., SWM 101 used to populate the ATD 402. If one or more termination criteria are satisfied, the flow may continue at 520; otherwise, the flow may continue back at 505 where a next iteration i+1 may be implemented.

Step 518 may include determining whether to continue the iterative AI/ML procedure. Step 518 may include determining whether the ML logic 400 has completed the number of iterations specified in the request received at 501, e.g., whether Q iterations have been completed. If fewer than Q iterations have been completed, the flow may continue at 505; otherwise, if Q or more iterations have been completed, the flow may continue at 520.

Step 520 may include recording ML CFG 135 learned through implementation of steps 501 through 512. The ML CFG 135 may be stored within non-transitory storage, such as NTS resources 103 of the SWM module 110, architecture datastore 330, architecture profile 301, NT ML CFG 435, and/or the like. Step 520 may include recording ML CFG 135-G learned for the generator 440 (and/or generator ANN 442), recording ML CFG 135-D learned for the discriminator 450 (and/or discriminator ANN 452), recording extraction and/or translation data (e.g., information pertaining to the extraction and/or translation of MEC of the architecture 201 to features 315), and so on.

Although FIGS. 5A-5C describe examples of AI/ML procedures for learning EM signals for respective instructions 305, the disclosure is not limited this regard and could be adapted to learn and/or adapt the EM signals learned for respective instructions 305 based on, inter alia, preceding instructions 305, e.g., instructions 305 executed directly prior.

Table 4 includes pseudocode illustrating an example of an AI/ML procedure for learning EM signals associated with an instruction sequence including an instruction (e.g., instruction 305-n) and a prior instruction 305-m.

TABLE 4

| 1: | Function TRAIN:(instruction n, prior | |
|---|---|---|
| | instruction m, instruction training | |
| 2: | signal s_{n,m}, number of training | |
| | batch steps Q, learning step size α): | |
| | for i = 1 to Q do | |
| 3: | \vec{f}_{n,m} ← φ({n, m}) | Retrieve feature for instruction |
| 4: | z~N(0,1)^{z} | Draw sample of random noise |
| 5: | ŝ ← G(z, \vec{f}_{n,m}) | Forward through generator |
| 6: | dₓ ← D(s_{n,m}, \vec{f}_{n,m}) | Discriminate real signal |
| 7: | dₛ ← D(s, \vec{f}_{n,m}) | Discriminate synthetic signal |
| 8: | L_{D} ← log(dₓ) + (log(1 − dₛ)) | Discriminator loss |
| 9: | D ← D − α ∂L_{D}/∂D | Update discriminator |
| 10: | LG ← log(dₛ) | Generator loss |
| 11: | G ← G − α ∂L_{G}/∂G | Update generator |

| | |
|---|---|
| 12: | end for |

In Table 4, \vec{f}_{n,m} represents a feature vector 320 including features 315 corresponding to instructions 305-n and 305-m (e.g., features 315-n and 315-m), s_{n,m} may represent training data associated with a sequence including instruction 305-n followed by instruction 306-m. More specifically, s_{n,m} may include an EM SCM data unit 425 captured during execution of instruction 305-n, the instruction 305-n executed directly after execution of instruction 305-m. The symbol s represents synthetic EM SC data 155 produced by the generator 440 (e.g., S 445) in response to a training vector 420 including a noise vector 415 and feature vector 420, dx represents discriminator output D 455-X in response to s_{n,m}, and dₛ represents the discriminator output D 455-S in response to the synthetic EM data ŝ.

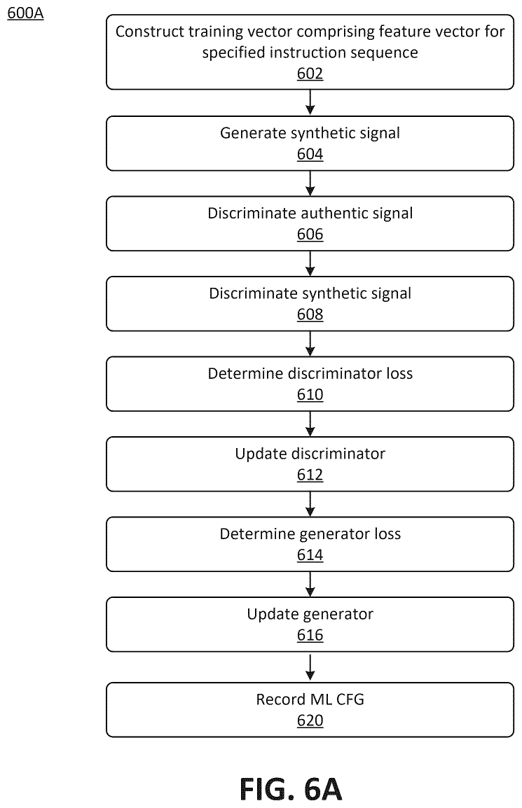

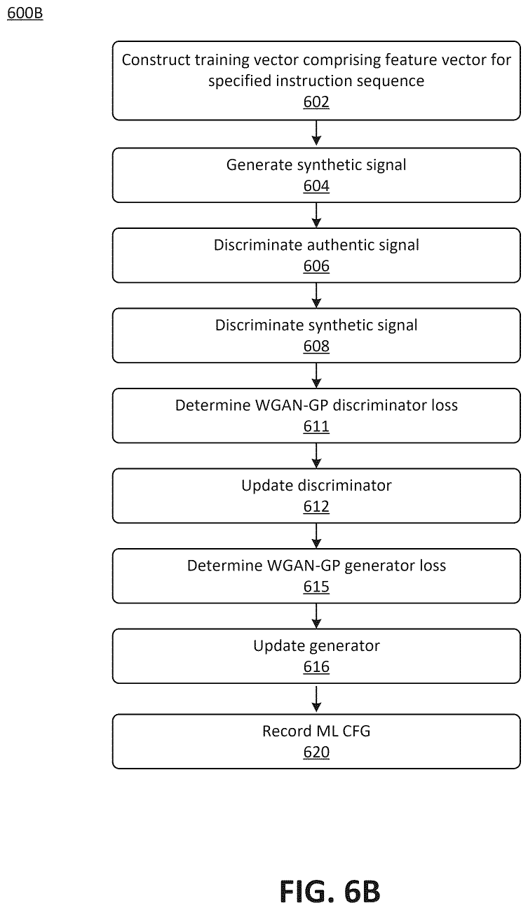

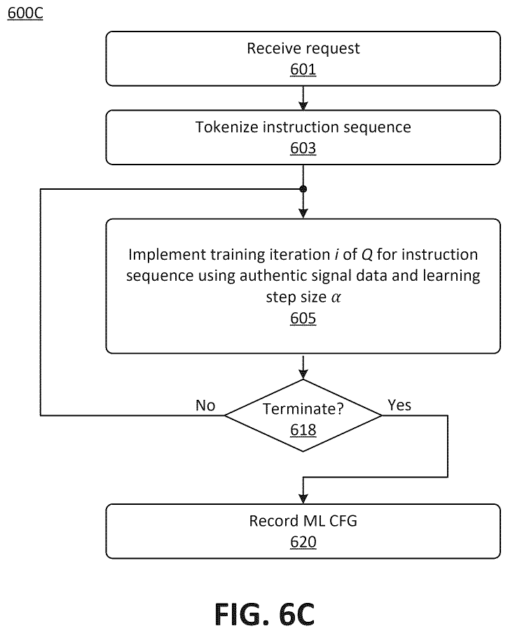

FIG. 6A is a flow diagram illustrating an example of a method 600A for implementing a training iteration of an AI/ML procedure configured to learn EM signals for execution of a specified instruction 305-n following execution of another specified instruction 305-m. The training iteration may include and/or correspond to an iteration i of the TRAIN function illustrated in Table 4.

Step 602 may include constructing a training vector 420 including a feature vector 320 for a specified instruction sequence, e.g., a sequence including instruction 305-n configured for execution following instruction 305-m. Step 602 may include translating instructions 305 of the sequence to respective features 315, as disclosed herein. Step 602 may further include appending the feature vector 320 to a noise signal, resulting in a training vector 420 of dimension Z+2T.

Step 604 may include generating synthetic EM SC data 155 for the instruction sequence. Step 604 may include configuring the generator 440 (and/or generator ANN 442 thereof) to generate an output S 445 in response to the training vector 420. The output S 445 produced by the generator 440 at 604 may include synthetic EM SC data 155 configured to emulate EM signals produced in response to execution of the instruction 305-n directly following execution of instruction 305-m. The output S 445 may be expressed as G(z, \vec{f}_{n,m}), where G represents the generator ANN 442, Z represents the noise signal generated at 602, and \vec{f}_{n,m} represents the instruction sequence being learned.

Step 606 may include discriminating an authentic signal associated with the instruction sequence, e.g., s_{n,m}. Step 606 may include configuring the discriminator 450 (and/or discriminator ANN 452 thereof) to generate an output D 455-X in response to a discriminator input vector 451-X including, inter alia, an EM SC data unit 425 associated with the instruction sequence.

Step 608 may include discriminating the synthetic signal generated for the instruction sequence. Step 608 may include discriminating the synthetic EM signal S 445 produced by the generator 440 (and/or generator ANN 442) at 604 in response to the training vector 420 generated at 602. Step 608 may include configuring the discriminator 450 (and/or discriminator ANN 452 thereof) to generate an output D 455-S in response to a discriminator input vector 451-S including, inter alia, the synthetic EM SC data 155 (S 445) generated at 604.

Step 610 may include determining a discriminator loss. The discriminator loss for the training iteration (i) may be based on outputs D 455-X and D 455-S generated at 606 and 608, respectively. The discriminator loss may be determined per line 8 of Table 4 and/or Eq. 9.

Step 612 may include updating the discriminator 450 (and/or discriminator ANN 452) based, at least in part, on the discriminator loss determined at 610. Step 612 may include updating the ML CFG 135-D of the discriminator ANN 452 per line 9 of Table 4 and/or Eq. 10.

Step 614 may include determining a generator loss. The generator loss for the training iteration (i) may be based on output D 455-S generated at 608. The generator loss may be determined in accordance with line 10 of Table 4 and/or Eq. 11.

Step 616 may include updating the generator 440 (and/or generator ANN 442) based, at least in part, on the generator loss determined at 614. The generator may be updated in accordance with line 11 of Table 4 and/or Eq. 12.

Step 620 may include recording ML CFG 135 learned through, inter alia, implementation of the method 600A, as disclosed herein.

Table 5 includes pseudo code illustrating an example of a WGAN-GP approach to learning EM signals for respective instruction sequences:

TABLE 5

| 1: | function TRAIN_WGAN-GP:( instruction n, | |
|---|---|---|
| | instruction training signal sₙ, | |
| | number of training batch steps Q, | |
| | learning step size α, gradient penalty | |
| | coefficient λ): | |
| 2: | for i = 1 to Q do | |
| 3: | \vec{f}_{n,m} ← φ({n, m}) | Retrieve feature for instruction |
| 4: | z~N(0,1)^{z} | Draw sample of random noise |
| 5: | ŝ ← G(z, \vec{f}_{n,m}) | Forward through generator |
| 6: | dₓ ← D(sₙ, \vec{f}_{n,m}) | Discriminate real signal |
| 7: | dₛ ← D(s, \vec{f}_{n,m}) | Discriminate synthetic signal |
| 8: | L_{D} ← W_{Loss} + λ · gp | Discriminator loss |
| 9: | D ← D − α ∂L_{D}/∂D | Update discriminator |
| 10: | L_{G} ← −mean(dₛ) | Generator loss |
| 11: | G ← G − α ∂L_{G}/∂G | Update generator |

| | |
|---|---|
| 12: | end for |
| 13: | end function |

As disclosed above, the discriminator loss (L_{D}) may be a function of a Wasserstein distance (W_{Loss}) and gradient penalty (gp), which may be estimated per Eq. 13.

FIG. 6B is a flow diagram illustrating an example of a method 600B for learning EM signals of an instruction sequence, e.g., a specified instruction 305-n following another instruction 305-m. The method 600B may include implementation of an iteration (i) of the WGAN-GP AI/ML procedure of Table 5. Steps 601-608 may include constructing a feature vector 320 including instructions 305 of the sequence, generating a training vector 420 for the instruction sequence, generating synthetic EM SC data 155 for the instruction 305-n (e.g., configuring the generator 440 to produce an output S 445 in response to the training vector 420), discriminating authentic EM SC data 255 associated with execution of the instruction 305-n following instruction 305-m, and discriminating the output S 445 of the generator 440.

Step 611 may include determining a WGAN-GP discriminator loss (L_{D}) for the iteration i. The WGAN-GP discriminator loss (L_{D}) may be estimated per Eq. 13 above. Step 612 may include updating the discriminator 450 in accordance with the discriminator loss (L_{D}) determined at 611, as disclosed herein.

Step 615 may include determining a WGAN-GP generator loss (L_{G}) for the iteration i. The WGAN-GP generator loss (L_{G}) may include the negative mean of the discriminator output 455-S for the synthetic EM SC data 155 produced by the generator 440 (e.g., L_{G}=−mean (dₛ)). Step 616 may include updating the generator 440 in accordance with the generator loss (L_{G}) determined at 615 and step 620 may include recording updates to the ML CFG 135, as disclosed herein.

FIG. 6C is a flow diagram illustrating another example of a method for learning EM signals for instructions 305 of an architecture 201, as disclosed herein. The method 600C may be configured to train the EM SC synthesis module 130 to emulate EM signals of a specified instruction 305-n, as in the example illustrated by the pseudocode of Tables 4 and/or 5.

At 601, the ML logic 400 of the EM SC synthesis module 130 may receive a request to implement an AI/ML training procedure. The request may specify an instruction 305-n. The request may also include and/or reference EM SCM data 255 associated with the instruction 305-n (e.g., an entry 404 for the instruction 305-n including a corresponding training signal sₙ, such as EM SCM data unit 425).

At 603, the ML logic 400 may be configured to tokenize the instruction n, which may include mapping the instruction n to a feature 315-n, as disclosed herein.

At 605, the ML logic 400 may configure the generator 440 and discriminator 450 of the CODE2SC framework 340 to implement an iteration of the AI/ML procedure disclosed herein, e.g., Q iterations. At 605, the ML logic 400 may configure the EM SC synthesis module 130 to implement operations corresponding to the pseudo code of lines 4 through 11 of Table 4 (and/or steps 602 through 620 of the method 600A illustrated in FIG. 6A). Alternatively, at 605, the ML logic 400 may configure the EM SC synthesis module 130 to implement operations corresponding to the pseudo code of lines 4 through 11 of Table 5 (and/or steps 602 through 620 of the method 600B illustrated in FIG. 6B).

Step 618 may include determining whether to continue the iterative AI/ML procedure. Step 618 may include evaluating termination criteria of the AI/ML procedure. For example, step 618 may include determining whether the ML logic 400 has completed the number of iterations specified in the request received at 601, e.g., whether Q iterations have been completed. If one or more termination criteria are satisfied, the flow may continue at 620; otherwise, the flow may continue back at 605 where a next iteration i+1 may be implemented.

Step 620 may include recording ML CFG 135 learned through implementation of steps 601 through 612. The ML CFG 135 may be stored within non-transitory storage, such as NTS resources 103 of the SCA module 110, architecture datastore 330, architecture profile 301, NT ML CFG 435, and/or the like. Step 620 may include recording ML CFG 135-G learned for the generator 440 (and/or generator ANN 442), recording ML CFG 135-D learned for the discriminator 450 (and/or discriminator ANN 452), recording extraction and/or translation data (e.g., information pertaining to the extraction and/or translation of MEC of the architecture 201 to features 315), and so on.

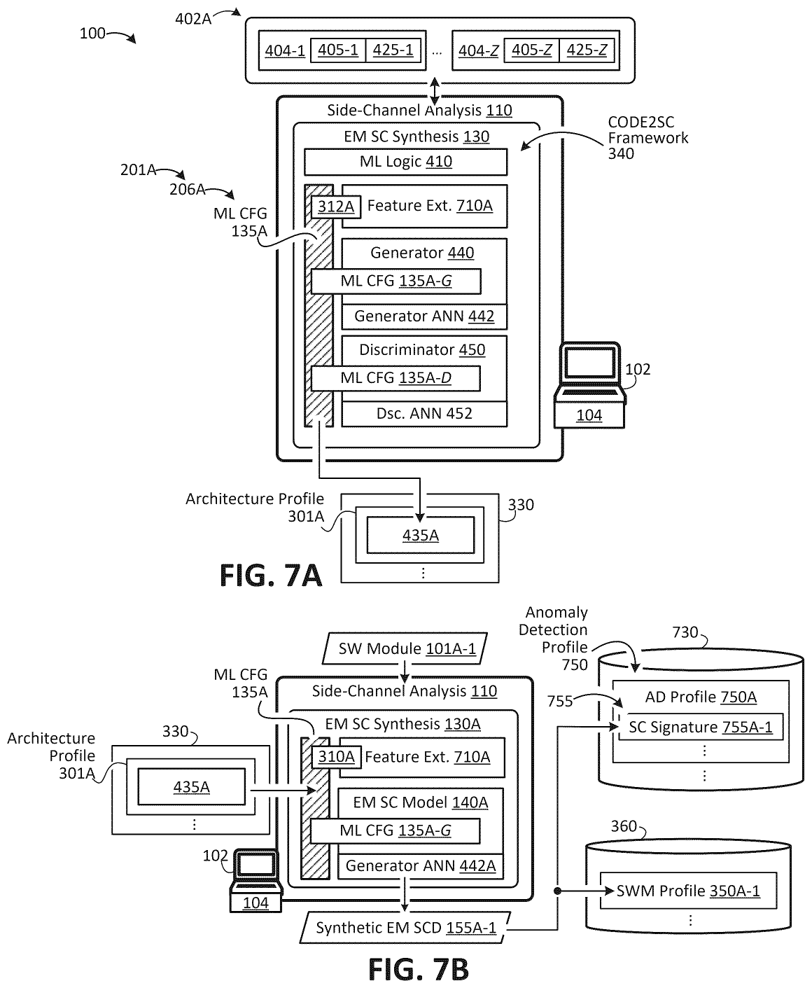

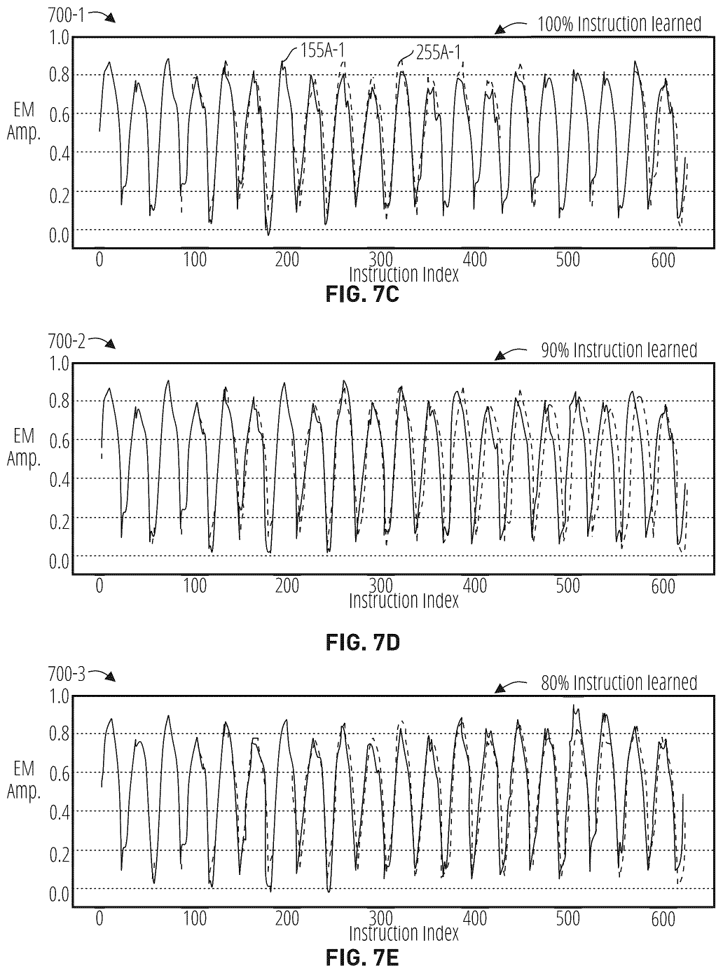

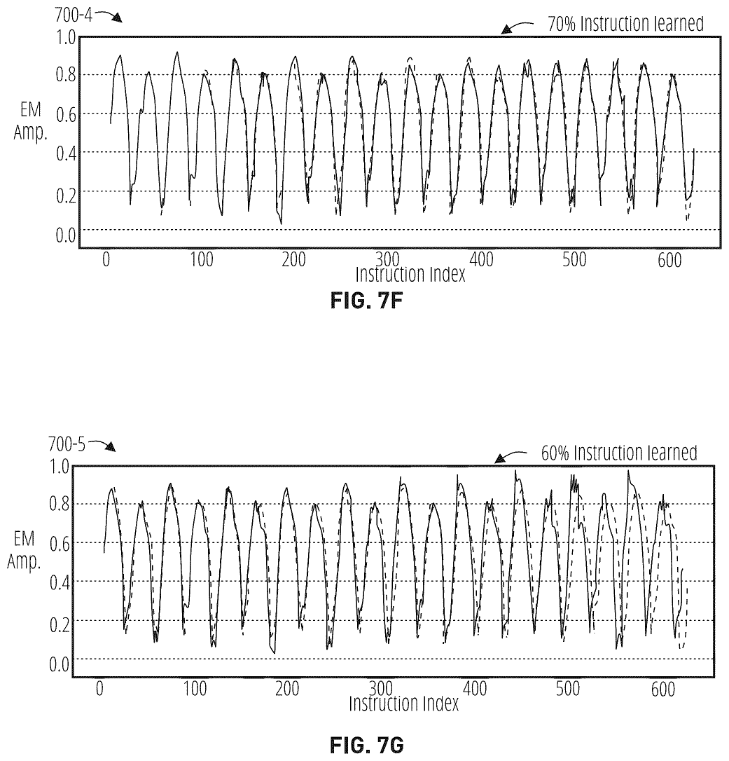

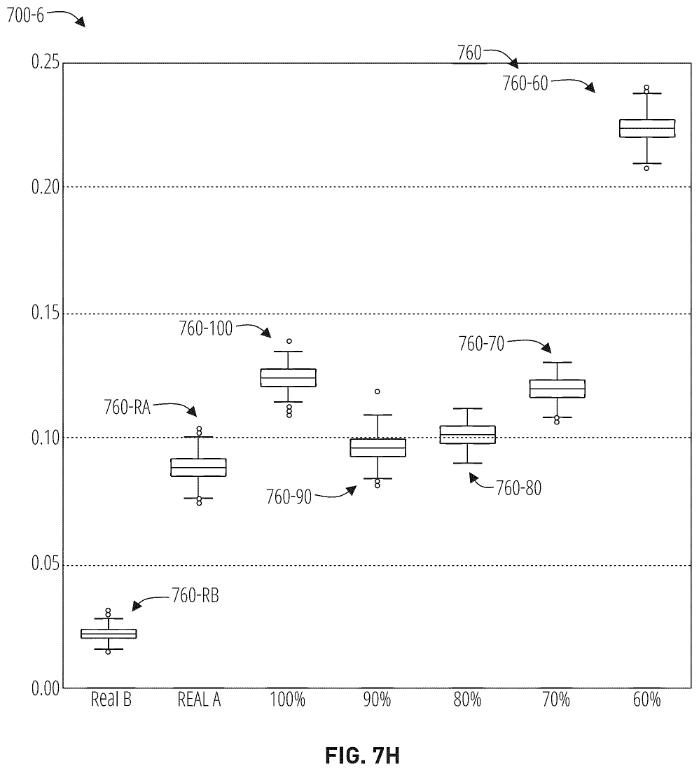

FIG. 7A is a schematic block diagram illustrating another example of an SCA module 110 configured to learn an EM SC synthesis module 130 according to the CODE2SC framework 340. In the FIG. 7A example, the ML logic 400 may be configured to learn EM signals associated with instructions 305 of an architecture 201A. By way of non-limiting example, the architecture 201A may correspond to a particular type of processing unit 206A, e.g., an Atmel AtMega328P® processing unit. In the FIG. 7A example, the EM SC synthesis module 130 may learn an ML CFG 135A configured to cause the EM SC model 140 to emulate EM signals generated by the processing unit 206A in response to execution of respective MEI of the architecture 201A. The architecture 201A of the FIG. 7A example may include U types of MEI, e.g., MEI corresponding to instructions 305-1 through 305-U.

In some implementations, the ML logic 400 may be configured to train the EM SC synthesis module 130 to emulate EM signals emitted in response to execution of respective instructions 305. The ML logic 400 may be configured to train the EM SC synthesis module 130 by use of an ATD 402A, which may include entries 404 corresponding to respective instructions 305 of the architecture 201A. In these implementations, the ATD 402A may include entries 404 configured to characterize EM signals emitted in response to execution of specified instructions 305 of instructions 305-1 through 305-U and the ML logic 400 may be configured to train the EM SC synthesis module 130 in accordance with AI/ML procedures as disclosed in one or more of Table 2, Table 3, and/or FIGS. 5A-5C.

Alternatively, or in addition, the ML logic 440 may be configured to train the EM SC synthesis module 130 to emulate EM signals emitted in response to execution of respective instruction sequences, e.g., EM signals emitted in response to execution of specified instructions 305 executed following other instructions 305. In these implementations, the ATD 402A may include entries 404 configured to characterize EM signals emitted in response to execution of respective instructions 305 in directly following execution of other specified instructions 305. The ATD 402A may include entries 404-1-1 through 404-1-U configured to characterize EM signals emitted in response to execution of instruction 305-1 following instructions 305-1 through 305-U, respectively; may include entries 404-2-1 through 404-2-U configured to characterize EM signals emitted in response to execution of instruction 305-2 following instructions 305-1 through 305-U, respectively, and so on. The ML logic 400 may configure the EM SC synthesis module 130 to learn EM signals for respective instruction sequences in accordance with the AI/ML procedures disclosed in one or more of Table 4, Table 5, and/or FIGS. 6A-6C.

The AI/ML procedures implemented by the ML logic 400 may be configured to a) learn an ML CFG 135A-D configured to cause the discriminator 450 (and/or discriminator ANN 452) to distinguish “real” EM SCM data 255 from “fake” synthetic EM SC data 155, and b) learn an ML CFG 135-G configured to cause the generator 440 (and/or generator ANN 442) to generate synthetic EM SC data 155 that is misclassified as “real” by the discriminator 450.

The SCA module 110 may be further configured to record NT ML CFG 435A learned for the architecture 201A within non-transitory storage, such as an architecture profile 301A of an architecture datastore 330, as disclosed herein. The ML CFG 135A learned by the SCA module 110 may be used to generate synthetic EM SC data 155 for respective SWM 101. For example, another SCA module 110 may utilize the NT ML CFG 435A to, inter alia, instantiate, configure, and/or otherwise implement an EM SC synthesis module 130 configured to emulate the EM SC response of the architecture 201A, as illustrated in FIG. 7B.

FIG. 7B is a schematic block diagram illustrating another example of an SCA module 110. In the FIG. 7B example, the SCA module 110 may be configured to utilize the NT ML CFG 435A learned by the SCA module 110 of FIG. 7A to, inter alia, generate synthetic EM SC data 155 for SWM 101 configured for execution on the architecture 201A. The SCA module 110 may be configured to instantiate, configure, and/or otherwise implement the EM SC synthesis module 130A in accordance with the NT ML CFG 435A.

In a first non-limiting example, the EM SC synthesis module 130 may include and/or be implemented by programmable components, such as software, programmable hardware, and/or the like. For example, the EM SC synthesis module 130 may include and/or be embodied by computer-readable instructions configured for execution on processing resources 104-1 of the SCA module 110 (and/or apparatus 102). The SCA module 110 may be configured to instantiate and/or configure the EM SC model 140 in accordance with the ML CFG 135A of the NT ML CFG 435. More specifically, the SCA module 110 may be configured to instantiate and/or configure a generator ANN 442 of the EM SC model 140 in accordance with an ML CFG 135A-G. The ML CFG 135A-G may including hyperparameters configured to define any suitable feature of the EM SC model 140 (and/or generator ANN 442), as disclosed herein. The ML CFG 135A-G may specify weights and/or other parameters of respective nodes of the generator ANN 442, organize the nodes into layers (e.g., an input layer, output layer, zero or more intermediate layers, and/or the like), define interconnections between respective nodes and/or layers, and so on. In a second non-limiting example, operations of the EM SC synthesis module 130A may be implemented by use of non-programmable components (e.g., hardware, ROM, and/or the like). In these implementations, operations of the ML CFG 135A may be incorporated into the design and/or implementation of the non-programmable components. For example, operations of the ML CFG 135A may be incorporated into the design of a hardware implementation of the EM SC model 140 and/or generator ANN 442.

The SCA module 110 may utilize the EM SC synthesis module 130A configured in accordance with the ML CFG 135A to, inter alia, generate synthetic EM SC data 155 for SWM 101 configured for execution on the architecture 201A. In the FIG. 7B example, the SCA module 110 may utilize the EM SC synthesis module 130A to generate synthetic EM SC data 155A-1 for SWM 101A-1. Generating the synthetic EM SC data 155A-1 may include a) extracting features 315 from the SWM 101A-1 and b) configuring the generator ANN 442A of the EM SC model 140A to generate synthetic EM signals (e.g., segments 355) for respective features 315. The features 315 may be extracted by use of a feature extraction module 710 (e.g., feature extraction module 710A), which may include and/or correspond to the extraction module 300 and/or translation module 310 disclosed herein. The feature extraction module 710A may be configured to extract executable code 302 from the SWM 101A of architecture 201A (e.g., SWM 101A-1) and translate instructions 305 of the executable code 302 to respective features 315. The extraction module 710A may be configured to translate instructions 305 to features 315 suitable for processing by the EM SC model 140A, such as numerical vectors or the like. In some implementations, the extraction module 710A may be configured to convert instructions 305 to features 315 through a text embedding algorithm. Alternatively, the extraction module 710A may be configured to tokenize respective instructions 305, as disclosed herein (e.g., the extraction module 710A may include a tokenizer 312A learned for the instruction namespace of architecture 201A)

The feature extraction module 710A may be further configured to construct feature vectors 320 configured for processing by the EM SC model 140A. The feature vectors 320 may include one or more features 315. For example, the EM SC synthesis module 130A may be configured to emulate EM signals generated by the architecture 201A in response to execution of respective instructions 305 (e.g., individual instructions). In these implementations, the feature vectors 320 produced by the feature extraction module 710A may correspond to individual instructions 305 and the EM SC model 140A (and/or ANN 442A) may be configured to generate synthetic EM SC data 155 in response to individual features 315, e.g., generate segments 355 for respective instructions 305 extracted from an SWM 101. Accordingly, in these implementations, the EM SC model 140A (and/or ANN 442A) may include an input layer configured to receive inputs of dimension T, where T represents a feature 315.

Alternatively, the EM SC synthesis module 130A may be configured to emulate EM signals generated in response to execution of respective instruction sequences, e.g., may be configured to adapt EM signals learned for respective instructions 305 based, at least in part, on previously executed instructions 305. In these implementations, the feature extraction module 140A may be configured to generate instruction vectors 305 including features 315 corresponding to a plurality of instructions 305 (e.g., two instructions 305). For example, the feature vector 320 generated for an instruction 305-n may include the feature 315-n associated with the instruction 305-n and a feature 315-m associated with the instruction 305-m executed directly before the instruction 305-n. Accordingly, in these implementations, the EM SC model 140A (and./or generator ANN 442A) may be configured to generate synthetic EM SC data 155 in response to feature vectors 320 including two features 315, e.g., may include an input layer of dimension 2T, where T represents a feature 315.

In the FIG. 7B example, the feature extraction module 710A may extract features 315 from the SWM 101A-1, form feature vectors 320 including the extracted features 315, and input the feature vectors 320 into the EM SC model 140A. For example, feature vectors 320 may be routed to an input layer for feedforward processing through the generator ANN 442A. The feature vectors 320 may be input in accordance with a logical organization of the corresponding instructions 305 of the SWM 101A-1. For example, the feature vectors 320 may be fed into the generator ANN 442A in a sequential order corresponding to a sequential execution order of the corresponding MEI of the SWM 101A-1. The synthetic EM SC data 155A-1 may, therefore, include a combination of synthetic EM signals (segments 355), each corresponding to a respective instruction 305 of the SWM 101A-1.

FIGS. 7C-7G illustrate examples of synthetic EM SC data 155 generated by use of the EM SC synthesis module 130 illustrated in FIG. 7A (and learned in FIG. 7B). The synthetic EM SC data 155A-1 are illustrated with solid plot lines, indicating EM signal amplitude corresponding to respective instructions of a program (by instruction index). Actual EM SCM data 255A-1 for the program are illustrated with broken plot lines. In FIGS. 7C-7G, plot 700-1 of FIG. 7C illustrates synthetic EM SC data 155A-1 generated by an EM SC synthesis module 130 trained to emulate 100% of the instruction namespace of the architecture 201A (e.g., an ML CFG 135A-100 learned per the CODE2SC framework 340 illustrated in FIG. 7A); plot 700-2 of FIG. 7D illustrates synthetic EM SC data 155A-1 generated by an EM SC synthesis module 130 trained to emulate about 90% of the instruction namespace of the architecture 201A (e.g., an ML CFG 135A-90 learned per the CODE2SC framework 340); plot 700-3 of FIG. 7E illustrates synthetic EM SC data 155A-1 generated by an EM SC synthesis module 130 trained to emulate about 80% of the instruction namespace of the architecture 201A (e.g., an ML CFG 135A-80 learned per the CODE2SC framework 340); plot 700-4 of FIG. 7F illustrates synthetic EM SC data 155A-1 generated by an EM SC synthesis module 130 trained to emulate about 70% of the instruction namespace of the architecture 201A (e.g., an ML CFG 135A-70 learned per the CODE2SC framework 340); and plot 700-5 of FIG. 7G illustrates synthetic EM signal data 155A-1 generated by an EM SC synthesis module 130 trained to emulate about 60% of the instruction namespace of the architecture 201A (e.g., an ML CFG 135A-60 learned per the CODE2SC framework 340).

The synthetic EM SC data 155 illustrated in plots 700-1 through 700-5 of FIGS. 7C-7G emulate “real” EM SCM data 255 in terms of both morphology and amplitude. The SCA module 110 may be configured to determine metrics to quantify the similarity (and/or deviation) between SC data. FIG. 7H illustrates examples of SC difference (SCD) metrics 760. The SCD metrics 760 may be configured to quantify a distance, difference, deviation, and/or other measure of error between the synthetic EM SC data 155 illustrated in FIGS. 7C-7G and “real” EM SCM data 255. The SCD metrics 760 may be based on a Euclidean distance or other suitable measure (maximum distance of 1). As illustrated, the synthetic EM SC data 155A-1 generated using less trained EM SC models 140 may exhibit higher SCD metrics 760 than the synthetic EM SC data 155A-1 generated using more highly trained EM SC models 140. For example, the synthetic EM SC data 155A-1 generated using ML CFG 135-60 may exhibit SCD metrics 760-60 between about 0.21 and 0.24, whereas the EM SC data 155A-1 generated using ML CFG 135-100 through ML CFG 135-70 may exhibit much lower SC metrics 760, e.g., SCD metrics 760-100 through 760-70 between about 0.06 and 0.13.

Referring back to FIG. 7B, the synthetic EM SC data 155A-1 determined for the SWM 101A-1 may be utilized in one or more SC analysis operations. In some examples, the synthetic EM SC data 155A-1 may be used to perform a SC analysis of the SWM 101A-1. Alternatively, the SCA module 110 may record synthetic EM SC data 155A-1 in a SWM profile 350-1 of the SWM 101A-1 for use by another SC analysis facility. By way of further non-limiting example, the synthetic EM SC data 155A-1 may be used for anomaly detection. Portions of the synthetic EM SC data 155A-1 may be stored within an anomaly detection (AD) datastore 730. The AD datastore 730 may include one or more AD profiles 750. An AD profile 750 may be configured to characterize the SC behavior of a specified compute unit. As used herein, a “compute unit” (CU) may include and/or refer to a computing device 205 having a specified application. In other words, a CU may include and/or refer to a computing device 205 that a) implements a specified architecture 201 (e.g., includes a specified type of processing unit 206), and b) is configured to implement a specified SWM 101 (and/or set of SWM 101). A CU may include and/or refer to an appliance, an embedded device utilized in a particular application or system, such as a control unit, an IoT device, and/or the like. The AD profile 750 of a CU may be configured to characterize the SC behavior of the CU or, more specifically, the SC behavior of the CU during execution of the SW module(s) 101 of the CU. The AD profile 750 of a CU may include SC signatures 755 corresponding to respective SWM 101 of the CU. In the FIG. 7B example, the AD datastore 730 may include an AD profile 750A of a CU configured to implement the SWM 101A-1. The AD profile 750A may include an SC signature 755A-1 which may include and/or be derived from the synthetic EM SC data 155A-1 determined for the SWM 101A-1, as disclosed herein.

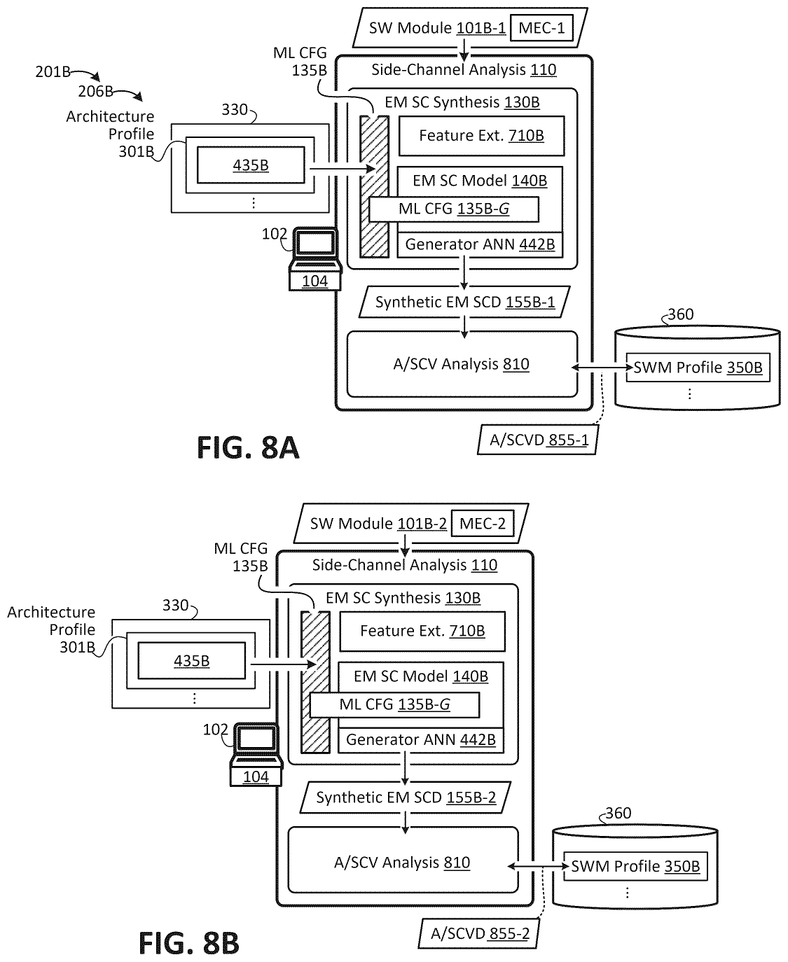

FIG. 8A is a schematic block diagram illustrating an example of an SCA module 110 configured to implement operations of an SC analysis function. The SCA module 110 may include an EM SC synthesis module 130B configured to emulate the EM SC of an architecture 201B (e.g., an architecture 201B). The SCA module 110 may instantiate, configure, and/or implement the EM SC synthesis module 130B in accordance with an NT ML CFG 435B learned for the architecture 201B. The SCA module 110 may retrieve the NT ML CFG 435B from non-transitory storage, such as an architecture profile 301B of an architecture datastore 330. The EM SC synthesis module 130B may include a feature extraction module 710B configured to extract executable code 302 from SWM 101 and translate instructions 305 of the executable code 302 to corresponding features 315, as disclosed herein. The EM SC synthesis module 130B may further include an EM SC model 140B (and/or generator ANN 442B), which may be configured in accordance with an ML CFG 135B-G. The EM SC model 140B may utilize the generator ANN 442B to, inter alia, generate synthetic EM SC data 155 for respective instructions 305 (and/or instruction sequences) of the architecture 201B. The ML CFG 135B-G may include AI/ML data learned by a generator 440 according to the CODE2SC framework 340, as disclosed herein.

The SCA module 110 may further include an anomaly and/or SC vulnerability analysis (A/SCVA) module 810 (e.g., an SC anomaly analysis and/or an SC vulnerability analysis module). In some instances, the A/SCVA module 810 may be configured to implement operations of a SC anomaly function. The A/SCVA module 810 may, for example, be configured to identify anomalies in SC data associated with respective SWM 101, such as injected code anomalies and/or the like. In some instances, the A/SCVA module 810 may be configured to implement operations of a SC vulnerability function. The A/SCVA module 810 may, for example, be configured to identify potential SC vulnerabilities in SC data associated with respective SWM 101, such as leakage of private information and/or the like.

In the FIG. 8A example, the SCA module 110 may be configured analyze SC data pertaining to a SWM 101B-1. The SCA module 110 may a) configure the EM SC synthesis module 130B to generate synthetic EM SC data 155B-1 for the SWM 101B-1, and b) utilize the A/SCVA module 810 to analyze the resulting synthetic EM SC data 155B-1 for potential anomalies and/or vulnerabilities. The synthetic EM SC data 155B-1 may be generated by a) extracting executable code 302 from the SWM 101B-1 (e.g., extracting features of MEC-1), b) translating instructions 305 of the executable code 302 into corresponding features 315, and c) configuring the EM SC model 140B (and/or generator ANN 442B thereof) to generate synthetic EM SC data 155B-1 for the features 351.

The A/SCVA module 810 may be configured to analyze the synthetic EM SCD 155B-1 generated by the EM SC synthesis module 130B. The A/SCVA module 810 may implement any suitable SC analysis function, technique, or algorithm. Information pertaining to potential anomalies and/or vulnerabilities (e.g., SC vulnerabilities) identified by the A/SCVA module 810 may be recorded in non-transitory storage. For example, the SCA module 110 may be configured to record anomaly and/or SC vulnerability analysis data (A/SCVAD) 855-1 determined for the SWM 101B (and/or the corresponding synthetic EM SC data 155B-1) in a SWM profile 350 of the SWM 101B.

The SCA module 110 may be further configured to identify instructions 305 associated with potential anomalies and/or SC vulnerabilities. The A/SCVD 855-1 generated by the A/SCVA module 810 may, for example, identify segments 355 of the synthetic EM SCD 155B-1 associated with potential anomalies and/or SC vulnerabilities and use the feature extraction module 710B to identify MEI, MEC-1, instructions 305, and/or build information associated with the identified regions.

In some implementations, the SCA module 110 may be further configured to mitigate potential SC vulnerabilities. The SCA module 110 may utilize the A/SCVD 855-1 generated for SWM 101B-1 to mitigate anomalies and/or SC vulnerabilities identified within the SWM 101B-1. The SCA module 110 may associate potential anomalies and/or SC vulnerabilities with corresponding instructions 305 (and/or segments of the MEC-1 of the SWM 101B-1). The SCA module 110 may implement and/or recommend modifications to mitigate one or more of the identified anomalies and/or vulnerabilities, such as rewrite operations, obfuscation operations, data whitening operations, instruction reordering, and/or other such techniques. In some implementations, the SCA module 110 may implement one or more mitigation operations by use of one or more tools, such as a compiler, linker, code obfuscation tool, code generator tool, data whitening tool, and/or the like. Alternatively, or in addition, the A/SCVD 855-1 may include information configured to facilitate modification by another, external entity, such as a human programmer, automated tool, or the like. The SCA module 110 may be further configured to analyze modifications to the SWM 101B-1 to determine and/or verify that the potential anomalies and/or SC vulnerabilities have been addressed, as illustrated in FIG. 8B.

FIG. 8B is a schematic block diagram illustrating another example of an SCA module 110 configured to implement operations of a SC analysis function using, inter alia, synthetic SC data 150. In the FIG. 8B example, the SCA module 110 may be configured to analyze SC data pertaining to SWM 101B-2. The SWM 101B-2 may include an updated or modified version of the SWM 101B-1. The SWM 101B-2 may include MEC-2 that incorporates modifications configured to mitigate one or more potential anomalies and/or SC vulnerabilities identified in the SWM 101B-1 (e.g., per the A/SCVD 855-1 generated for the SWM 101B-1 as disclosed herein).

The SCA module 110 may be configured to generate synthetic EM SC data 155B-2 for the SWM 101B-1, as disclosed herein. The A/SCVA module 810 may analyze the synthetic EM SC data 155B-2 and generate corresponding A/SCVD 855-2. The A/SCVA module 810 may evaluate the A/SCVD 855-2 to, inter alia, determine whether the potential anomalies and/or vulnerabilities identified in the synthetic EM SC data 155B-1 have been mitigated and/or whether modifications to the MEC-2 of the SWM 101B-2 resulted in any new potential anomalies and/or SC vulnerabilities (and/or may include information pertaining to such vulnerabilities, if any). The A/SCVD 855-2 may be stored within the SW profile 350B of the SWM 101B-2 (e.g., along with the corresponding synthetic EM SC data 155B-2).

Although operations and components of the systems and methods for SC analysis disclosed herein are described with respect to particular SC and/or particular types of synthetic SC data (e.g., electromagnetic radiation SC), the disclosure is not limited in this regard and could be adapted to learn to emulate any suitable type of SC. For example, the CODE2SC framework 340 illustrated in one or more of FIGS. 3, 4A-4E, and 7A-8C (and/or the AI/ML procedures illustrated in one or more of FIGS. 5A-6C) may be adapted to learn, synthesize, and/or analyze any suitable SC. For example, the CODE2SC framework 340 disclosed herein may be adapted to learn to emulate the response of SC pertaining to one or more of power consumption, acoustics, vibration, temperature, electro-optical radiation (e.g., infrared emission), and/or the like. Alternatively, or in addition, the CODE2SC framework 340 may be configured to emulate the response of a plurality of different types of SC.

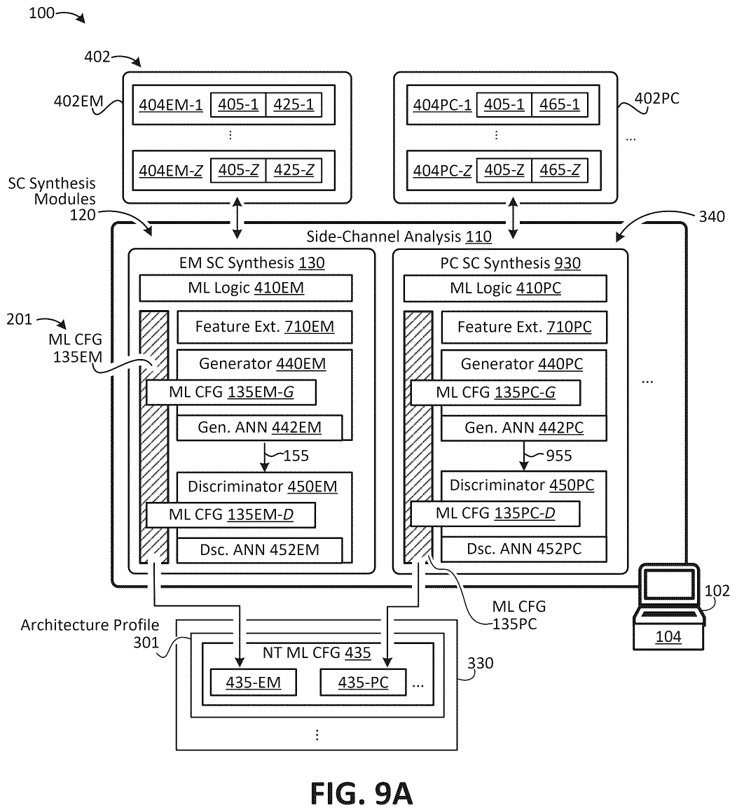

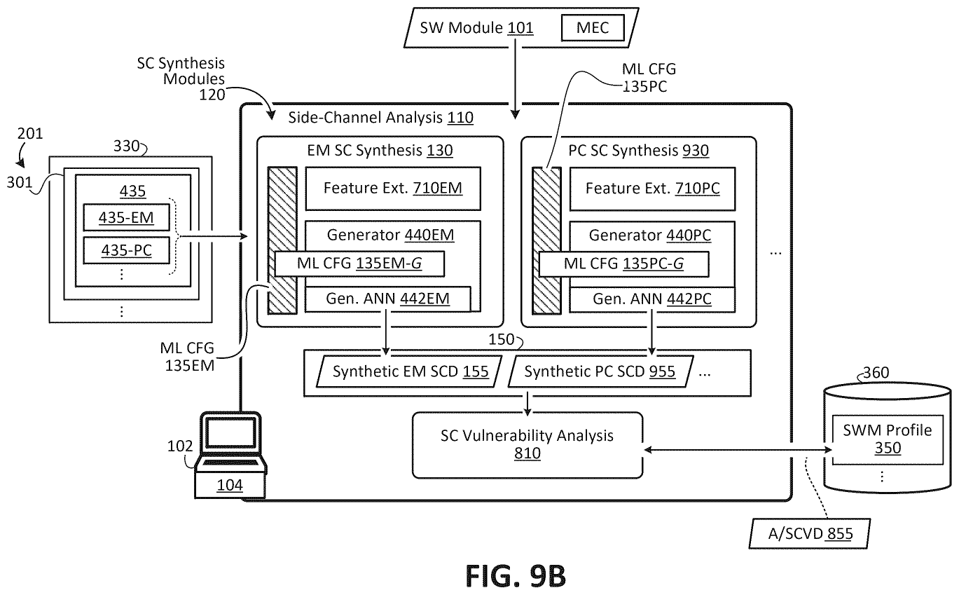

FIG. 9A is a schematic block diagram illustrating an example of an SCA module 110 configured to, inter alia, learn to emulate a plurality of SC of a specified architecture 201. The SCA module 110 may include and/or be coupled to a plurality of SC synthesis modules 120, each configured to learn the SC response of a respective SC. In the FIG. 9A example, the SC synthesis modules 120 may include an EM SC synthesis module 130 and a PC SC synthesis module 930. The EM SC synthesis module 130 may be configured to emulate an EM SC of the architecture 201 and the PC SC synthesis module 930 may be configured to emulate a power-consumption SC.

The SC synthesis modules 120 may learn to emulate the SC response of respective instructions 305 (and/or instruction sequences) by use of an ATD 402. The ATD 402 may be configured to characterize a plurality of different types of SC of the architecture 201, including EM emissions and power consumption. As illustrated in FIG. 9A, the ATD 402 may include training data configured to characterize the EM SC of the architecture 201 (an EM ATD 402 or ATD 402EM). The ATD 402EM may include a plurality of entries 404EM, each including EM SCM data 255 characteristic of the EM response to execution of a specified IV 405, e.g., the EM response to execution of a specified instruction 305 and/or execution of the specified instruction 305 following another specified instruction 305 (e.g., execution of instruction 305-n directly following instruction 305-m). As illustrated in FIG. 9A, the ATD 402EM may include entries 404EM-1 through 404EM-Z configured to characterize the EM SC response of the architecture 201 to execution of IV 405-1 through 405-Z. The EM SC response of the architecture 201 to execution of an IV 405-1 through 405-Z may be characterized by EM SCM data units 425-1 through 425-Z. The EM SCM data units 425 may include EM SCM data 255 captured during execution of respective IV 405, as disclosed herein (e.g., as illustrated in FIG. 2).

The EM SC synthesis module 130 may include and/or be coupled to ML logic 410EM. The ML logic 410EM may utilize the ATD 402EM to, inter alia, train the EM SC synthesis module 130 to emulate the EM SC of the architecture 201. The EM SC synthesis module 130 may be implemented in accordance with the CODE2SC framework 340, as disclosed herein; the EM SC synthesis module 130 may include a generator 440EM and discriminator 450EM having adverse learning objectives, as described above in conjunction with one or more of Eq. 4 through Eq. 8. The generator 440EM may be configured to learn to produce synthetic EM SC data 155 that accurately emulates the EM SC response of the architecture 201 to execution of respective IV 405 (e.g., by use of a generator ANN 442EM) whereas the discriminator 450 may be configured to learn to distinguish “fake” synthetic EM SC data 155 generated for respective IV 405 from corresponding “authentic” EM SCM data 255 (e.g., by use of a discriminator ANN 452EM).

The EM SC synthesis module 130 may be trained through implementation of one or more AI/ML procedures, e.g., AI/ML procedures as described above in conjunction with Tables 2-5 and/or FIGS. 5A-6C. The AI/ML procedures may include processing respective entries 404EM of the ATD 404EM. Processing an entry 404EM may include a) translating the IV 405 of the entry 404EM to a feature vector 320, e.g., by use of feature extraction module 710EM, as disclosed herein, b) constructing a training vector 420, e.g., appending the feature vector 320 to a noise vector 415, c) configuring the generator 440EM to produce synthetic EM SC data 155 in response to the training vector 420, e.g., through feedforward processing through the generator ANN 442EM, d) configuring the discriminator 450EM to produce outputs D 455 indicating a degree to which the EM SCM data unit 425 associated with the IV 405 and/or synthetic EM SC data 155 represents “authentic” EM SCM data 255, and e) updating the generator 440EM (and/or generator ANN 442EM) in accordance with a generator loss (L_{G}), and f) updating the discriminator 450EM (and/or discriminator ANN 452EM) in accordance with a discriminator loss (L_{D}). The processing may further include recording and/or updating an ML CFG 135EM learned through the AI/ML procedure, including an ML CFG 135EM-G learned for the generator 440EM (and/or generator ANN 452EM) and ML CFG 135EM-D learned for the discriminator 450EM (and/or discriminator ANN 452EM). The ML CFG 135EM may be stored and/or otherwise maintained within an NT ML CFG 435 (e.g., may include an NT ML CFG 435EM), which may be stored within a profile 301 of the specified architecture 201 maintained within an architecture datastore 330, as disclosed herein.

In the FIG. 9A example, ATD 402 may further include training data configured to characterize the PC SC of the architecture 201 (a PC ATD 402 or ATD 402PC). The ATD 402PC may include a plurality of entries 404PC, each including PC SCM data 265 characteristic of the PC SC response of the architecture 201 to execution of a specified IV 405. The PC SCM data 265 may include SCM data 250 captured during execution of respective instructions 305 and/or instruction sequences by a computing device 205 (e.g., as illustrated in FIG. 2). The ATD 402PC may include entries 404PC-1 through 404PC-Z configured to characterize the PC SC response of the architecture 201 to execution of IV 405-1 through 405-Z, respectively. The PC SC response of the architecture 201 to execution of IV 405-1 through 405-Z may be characterized by PC SCM data units 465-1 through 465-Z.

The PC synthesis module 930 may include and/or be coupled to ML logic 410PC. Alternatively, the PC synthesis module 930 may utilize the ML logic 410EM of the EM SC synthesis module 130 (and/or the EM SC synthesis module 130 and PC SC synthesis module 930 may utilize same or common ML logic 410).

In the FIG. 9A example, the ML logic 410PC may utilize the ATD 402PC to, inter alia, train the PC SC synthesis module 130 to emulate the PC SC of the architecture 201. The PC SC synthesis module 930 may be implemented in accordance with the CODE2SC framework 340 disclosed herein. For example, the PC SC synthesis module 930 may include a generator 440PC and discriminator 450PC having adverse learning objectives, as described above in conjunction with one or more of Eq. 4 through Eq. 8. The generator 440PC may be configured to learn to produce synthetic PC SC data 165 that accurately emulates the PC SC response of the architecture 201 to execution of respective IV 405 (e.g., by use of a generator ANN 442PC) whereas the discriminator 450 may be configured to learn to distinguish “fake” synthetic PC SC data 165 generated for respective IV 405 from corresponding “authentic” PC SCM data 265 (e.g., by use of a discriminator ANN 452PC).

The PC SC synthesis module 930 may be trained through implementation of one or more AI/ML procedures, e.g., AI/ML procedures as described above in conjunction with Tables 2-5 and/or FIGS. 5A-6C. The AI/ML procedures may include processing respective entries 404PC of the ATD 404PC. Processing an entry 404PC may include a) translating the IV 405 of the entry 404PC to a feature vector 320, e.g., by use of feature extraction module 710PC (and/or a common feature extraction module 710, such as the feature extraction module 710EM), b) constructing a training vector 420, e.g., appending the feature vector 320 to a noise vector 415, c) configuring the generator 440PC to produce synthetic PC SC data 165 in response to the training vector 420, e.g., through feedforward processing through the generator ANN 442PC, d) configuring the discriminator 450PC to produce outputs D 455 indicating whether the PC SCM data unit 465 associated with the IV 405 and/or synthetic PC SC data 165 include “authentic” PC SCM data 265, and e) updating the generator 440PC (and/or generator ANN 442PC) in accordance with a generator loss (L_{G}), and f) updating the discriminator 450PC (and/or discriminator ANN 452PC) in accordance with a discriminator loss (L_{D}). The processing may further include recording and/or updating an ML CFG 135PC learned through the AI/ML procedure, including an ML CFG 135PC-G learned for the generator 440PC (and/or generator ANN 452PC) and ML CFG 135PC-D learned for the discriminator 450PC (and/or discriminator ANN 452PC). The ML CFG 135PC may be stored and/or otherwise maintained within an NT ML CFG 435 (e.g., may include an NT ML CFG 435PC), which may be stored within a profile 301 of the specified architecture 201 maintained within an architecture datastore 330, as disclosed herein.

The CODE2SC framework 340 disclosed herein may be further configured to generate and/or analyze synthetic SC data 250 pertaining to different types of SC. FIG. 9B is a schematic block diagram of another example of a SCA module 110. The SCA module 110 may include an EM SC synthesis module 130 and PC SC synthesis module 930. The EM SC synthesis module 130 may be configured to emulate the EM SC of the architecture 201 learned in the FIG. 9A example, e.g., the generator 440EM may include and/or implement the ML CFG 135EM learned according to the CODE2SC framework 340 disclosed herein. The PC SC synthesis module 930 may be configured to emulate the PC SC of the architecture 201 learned in the FIG. 9A example, e.g., the generator 440PC may include and/or implement the ML CFG 135PC learned according to the CODE2SC framework 340.

In the FIG. 9B example, generating synthetic SC data 150 for a SWM 101 may include, inter alia: a) extracting feature vectors 320 from the SWM 101, each feature vector 320 configured to represent execution of a respective instruction 305 (and/or execution of a respective instruction sequence), b) configuring the generator 440EM of the EM SC synthesis module 130 to generate synthetic EM SC data 155 for the extracted feature vectors 155, and/or c) configuring the generator 440PC of the PC SC synthesis module 130 to generate synthetic PC SC data 955 for the extracted feature vectors 155. In some implementations, the EM SC synthesis module 130 and PC SC synthesis module 930 may include respective feature extraction modules 410, e.g., a feature extraction module 710EM and 710PC, as illustrated in FIG. 9B. Alternatively, the EM SC synthesis module 130 and PC SC synthesis module 930 may utilize a same or common feature extraction module 710.

As illustrated in the FIG. 9A example, the synthetic SC data 150 generated for a SWM 101 may include synthetic EM SC data 155 and synthetic PC SC data 955, e.g., may be configured to emulate the response of the EM SC and/or PC SC of the architecture 201 to execution of the SWM 101. In other words, the synthetic SC data 150 illustrated in FIG. 9B may include an EM SC signature and PC SC signature of the SWM 101.

In some implementations, the SCA module 110 may be configured to generate synthetic SC data 150 for use within one or more SC analysis operations. The synthetic EM SC data 155 and/or synthetic PC SC data 955 may be configured for use within SC analysis operations including, but not limited to: SC vulnerability analysis, anomaly detection, and/or the like.

In a first non-limiting example, the synthetic EM SC data 155 and/or synthetic PC SC data 955 may be utilized for anomaly detection. The synthetic SC data 150 generated for the SWM 101 may be configured to establish a baseline for nominal execution of the SWM 101 on a computing device 205 of the specified architecture 201; the synthetic EM SC data 155 may include an EM SC baseline of the SWM 101 and the synthetic PC SC data 955 may include a PC SC baseline of the SWM 101. The EM SC and/or PC SC may be monitored during operation of the SWM 101 on the computing device 205, which may include capturing EM SCM data 155 and/or PC SCM data 265. For example, anomaly detection may be triggered per Eq. 14 below:

$${trigger}_{em} ← {e}_{em} ( {s}_{em} , {m}_{em} ) \geq {th}_{em} \qquad Eq . 14$$

$${trigger}_{pc} ← {e}_{pc} ( {s}_{pc} , {m}_{pc} ) \geq {th}_{pc}$$

$${trigger}_{SC} ← {e}_{em} ( {s}_{em} , {m}_{em} ) \geq {th}_{em} \vert {e}_{pc} ( {s}_{pc} , {m}_{pc} ) \geq {th}_{pc}$$

In Eq. 14, triggerₑₘ represents trigger criterion for detection of an anomaly pertaining to the EM SC, trigger_{pc} represents trigger criterion for detection of an anomaly pertaining to the PC SC, and trigger_{sc} represents trigger criteria for detection of an anomaly pertaining to a SC, e.g., may be triggered in response to detection of an anomaly pertaining to one or more SC of the architecture 101. In the triggerₑₘ term, sₑₘ represents the predicted EM SC response of the SWM 101 (e.g., synthetic EM SC data 155 determined for the SWM 101), mₑₘ represents the observed EM SC response of the computing device 205 (e.g., EM SCM 255 captured during operation of the SWM 101 on the computing device 205), eₑₘ represents an error metric configured to quantify deviation between sₑₘ and mₑₘ (e.g., a difference, distance, Euclidian distance, or the like), and them represents threshold for detection of an anomaly pertaining to the EM SC. In the trigger_{pc} term, s_{pc} represents the predicted PC SC response of the SWM 101 (e.g., synthetic PC SC data 955 determined for the SWM 101), mem represents the observed EM SC response of the computing device 205 (e.g., PC SCM 265 captured during operation of the SWM 101 on the computing device 205), e_{pc} represents an error metric configured to quantify deviation between s_{pc} and m_{pc}, and th_{pc} represents a threshold for detection of an anomaly pertaining to the PC SC. The trigger_{sc} term represents criteria for detection of an anomaly pertaining to any monitored SC of the architecture 201, e.g., may be triggered in response to detection of an anomaly pertaining to the EM SC, PC SC, and/or the like.

In a second non-limiting example, the synthetic SC data 150 generated for the SWM 101 by the SCA module 110 may be used to, inter alia, detect unauthorized modifications to the SWM 101. As disclosed herein, the synthetic SC data 150 generated for a SWM 101 may be characteristic of the SWM 101, e.g., may be characteristic of the MEC of the SWM 101. In the FIG. 9B example, the synthetic SC data 150 generated for the SWM 101 may include an EM SC signature of the SWM 101 (e.g., synthetic EM SC data 155) and a PC SC signature of the SWM 101 (e.g., synthetic PC SC data 955). Modifications to the SWM 101 (and/or MEC thereof) may result in changes to the SC response of the SWM 101. The SCA module 110 may be used to establish an SC signature of a SWM 101. The SC signature may include and/or be derived from synthetic SC data 150 generated from a validated copy or version of the SWM 101, e.g., may include an EM SC signature including and/or derived from synthetic EM SC data 155 generated for the SWM 101, a PC SC signature including and/or derived from synthetic PC SC data 955 generated for the SWM 101, and so on. The SC signature (and/or corresponding synthetic SC data 150) may be recorded within secure, NT storage, e.g., may be stored within an SWM datastore 360, SWM profile 350, or the like, as disclosed herein. The SC signature may be used to detect subsequent, unauthorized modifications to the SWM 101. For example, the SC signature may be used to detect unauthorized modifications to a copy of the SWM 101 (e.g., a SWM 101-1). An SC analysis operation detect unauthorized modifications to a SWM 101-1 relative to a validated SWM 101 may include: a) retrieving the SC signature of the SWM 101 (e.g., retrieving synthetic SC data 150 generated for the SWM 101), b) generating synthetic SC data 150 for the SWM 101-1, and c) comparing the synthetic SC data 150 generated for the SWM 101-1 to the SC signature of the SWM 101. The comparing may include determining an error between the synthetic SC data 150 and the SC signature of the SWM 101, e.g., may include determining an error between synthetic EM SC data 155 generated for the SWM 101-1 and an EM SC signature of the SWM 101, an error between synthetic PC SC data 955 generated for the SWM 101-1 and a PC SC signature of the SWM 101, and so on. In some implementations, criteria for triggering detection of an unauthorized modification may be implemented as follows:

$${mod}_{em} ← {e}_{em} ( {sig}_{em} , {s}_{em} ) \geq {th}_{em \_ sig} \qquad Eq . 15$$

$${mod}_{pc} ← {e}_{pc} ( {sig}_{pc} , {s}_{pc} ) \geq {th}_{pc \_ sig}$$

$${mod}_{SC} ← {e}_{em} ( {sig}_{em} , {s}_{em} ) \geq {th}_{em \_ sig} \vert {e}_{pc} ( {sig}_{pc} , {s}_{pc} ) \geq {th}_{pc \_ sig}$$

In Eq. 15, modₑₘ represents trigger criterion for detecting unauthorized modification of a SWM 101-1 based on the EM SC signature of the corresponding SWM 101, mod_{pc} represents trigger criterion for detecting unauthorized modification of a SWM 101-1 based on the PC SC signature of the corresponding SWM 101, and mod_{sc} represents trigger criteria for detecting unauthorized modification of a SWM 101-1 based on any SC of the architecture 201 characterized by the SC signature of the SWM 101 (e.g., the EM SC signature or PC SC signature in the FIG. 9B example). In the modₑₘ term, sigₑₘ represents the EM SC signature of the SWM 101, Sem represents synthetic EM SC data 155 generated for the SWM 101-1, eₑₘ represents a function configured to quantify an error therebetween, and th_{em_sig} is an error metric threshold for the EM SC. In the mod_{pc} term, sig_{pc} represents the PC SC signature of the SWM 101, s_{pc} represents synthetic PC SC data 955 generated for the SWM 101-1, e_{pc} represents an therebetween, and th_{pc} sig is an error metric threshold for the PC SC. The mod_{sc} term represents criteria for detection of unauthorized modification pertaining to any SC of the architecture 201 characterized by the SC signature of the SWM 101, e.g., may be triggered based on error pertaining to the EM SC signature and/or PC SC signature in the FIG. 9B example.

Alternatively, or in addition, unauthorized modification to an SWM 101-1 may be detected based on SCM data 150 acquired during operation of the SWM 101-1 on a computing device 205. Detecting unauthorized modifications to the SWM 101-1 relative to the SWM 101 may include a) retrieving the SC signature of the SWM 101, b) capturing SCM data 250 during execution of the SWM 101-1 on the computing device 205, and c) comparing the captured SCM data 250 to the SC signature of the SWM 101 per Eq. 15, e.g., with synthetic SC data 150 replaced by corresponding SCM data 150, as follows:

$${mod}_{em} ← {e}_{em} ( {sig}_{em} , {m}_{em} ) \geq {th}_{em \_ sig} \qquad Eq . 16$$

$${mod}_{pc} ← {e}_{pc} ( {sig}_{pc} , {m}_{pc} ) \geq {th}_{pc \_ sig}$$

$${mod}_{SC} ← {e}_{em} ( {sig}_{em} , {m}_{em} ) \geq {th}_{em \_ sig} \vert {e}_{pc} ( {sig}_{pc} , {m}_{pc} ) \geq {th}_{pc \_ sig}$$

In a third non-limiting example, the synthetic SC data 150 generated by the SCA module 110 may be configured for anomaly and/or SC vulnerability analysis. For example, the SCA module 110 may include and/or be coupled to an A/SCVA module 810, which may be configured to implement operations of an anomaly detection and/or SC vulnerability function, as disclosed herein. The SCA module 110 may a) generate synthetic SC data 150 for the SWM 101 and b) utilize the A/SCVA module 810 to analyze the resulting synthetic SC data 150 for potential anomalies and/or SC vulnerabilities. The synthetic SC data 150 may pertain to any suitable SC of the architecture 201. In the FIG. 9B example, the synthetic SC data 150 may include synthetic EM SC data 155 and/or synthetic PC SC data 955. The A/SCVA module 810 of the FIG. 9B example may be configured to analyze the synthetic EM SC data 155 for potential anomalies and/or SC vulnerabilities pertaining to the EM SC, analyze the synthetic PC SC data 955 for potential anomalies and/or SC vulnerabilities pertaining to the PC SC, and so on. Information pertaining to potential anomalies and/or SC vulnerabilities identified by the A/SCVA module 810 may be recorded in non-transitory storage. For example, the SCA module 110 may be configured to record anomaly and/or SC vulnerability analysis data (A/SCVAD) 855 determined for the SWM 101 (and/or the corresponding synthetic SC data 150) in a SWM profile 350 of the SWM 101.

In some implementations, the SCA module 110 may be further configured to mitigate potential anomalies and/or SC vulnerabilities. The SCA module 110 may utilize the A/SCVD 855 generated for the SWM 101 to mitigate SC vulnerabilities pertaining to one or more SC, e.g., mitigate anomalies and/or SC vulnerabilities pertaining to the EM SC, PC SC, and so on. The SCA module 110 may associate potential anomalies and/or SC vulnerabilities with corresponding instructions 305 (and/or segments of the MEC of the SWM 101). The SCA module 110 may implement and/or recommend modifications to mitigate one or more of the identified anomalies and/or vulnerabilities, as disclosed herein. The SCA module 110 may be further configured to analyze modifications to the SWM 101 to determine and/or verify that the potential anomalies and/or SC vulnerabilities have been addressed.

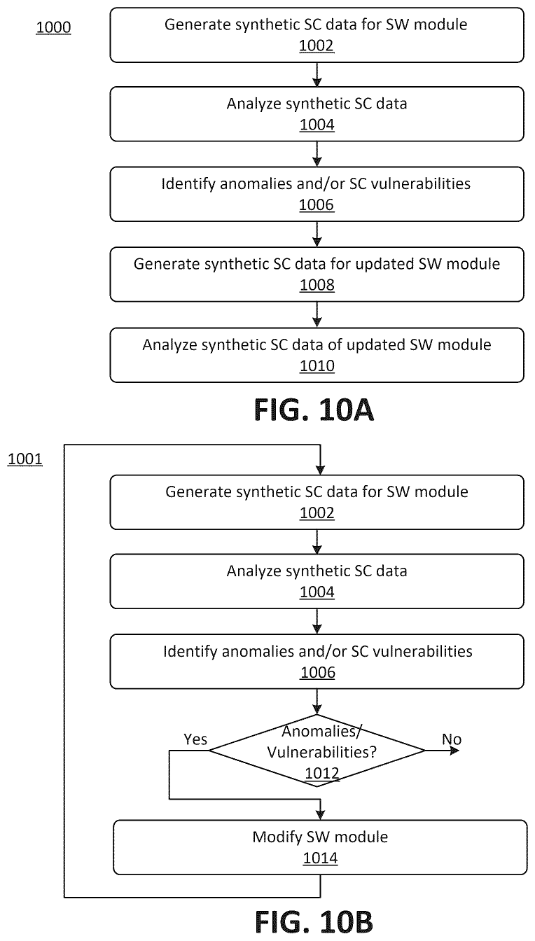

FIG. 10A is a flow diagram illustrating an example of a method 1000 for synthetic anomaly and/or SC vulnerability analysis. Step 1002 may include generating synthetic SC data 150 for a SWM 101, as disclosed herein. Step 1002 may include generating synthetic EM SC data 155 for the SWM 101 by use of an EM SC synthesis module 130 configured to emulate the EM SC of a specified architecture 201, e.g., the architecture 201 configured for execution of the SWM 101. Alternatively, or in addition, step 1002 may include generating synthetic SC data 150 pertaining to one or more other SC, such as synthetic PC SC data 955 or the like.

Step 1004 may include analyzing the synthetic SC data 150 generated at 1002. The SC analysis may include identifying anomalies and/or SC vulnerabilities of the SWM 101 and/or recording corresponding A/SCVD 855 at 1006. Step 1006 may further include associating the identified anomalies and/or SC vulnerabilities with the SW module 105 (and/or MEC thereof). For example, the synthetic SC data 150 may include synthetic EM SC data 155 and step 1006 may include identifying segments 355 of the synthetic EM SC data 155 corresponding to respective anomalies and/or SC vulnerabilities, mapping the segments 355 to features 315, translating the features 315 to instructions 305, and/or associating the instructions 305 with corresponding MEC of the SWM 101. Alternatively, or in addition, step 1006 may include analyzing other types of SC data 150, e.g., may include associating anomalies and/or vulnerabilities identified within synthetic PC SC data 955 with MEC of the SWM 101.

The A/SCVD 855 determined at 1006 may be used to, inter alia, mitigate one or more anomalies and/or SC vulnerabilities of the SWM 101. Mitigating an anomaly and/or a SC vulnerability may include modifying the SWM 101 (and/or MEC thereof) through rewriting, obfuscation, data whitening, instruction reordering, and/or other such techniques.

Step 1008 may include generating synthetic SC data 150 for a modified or updated SWM 101-1. The synthetic SC data 150-1 may pertain to any suitable SC, e.g., may include EM SC data 155-1 and/or synthetic SC data 150-1 pertaining to one or more other SC of the architecture 101. Step 1010 may include analyzing the synthetic SC data 150-1 generated for the updated SWM 101-1, as disclosed herein. Step 1010 may, for example, include analyzing A/SCVD 855-1 determined for the updated SWM 101-1 to determine, inter alia, whether the anomalies and/or SC vulnerabilities identified at 1006 have been mitigated (and/or determine whether the modifications resulting in any new potential anomalies and/or SC vulnerabilities).

FIG. 10B is a flow diagram illustrating another example of a method 1001 for synthetic anomaly and/or SC vulnerability analysis. At 1002, the SCA module 110 may be configured to generate synthetic SC data 150 for a SWM 101 and, at 1004, the SCA module 110 may configure an A/SCVA module 810 to analyze the synthetic SC data 150 to, inter alia, identify anomalies and/or SC vulnerabilities of the SWM 101 at 1006, as disclosed herein. Identifying the anomalies and/or the SC vulnerabilities at 1006 may include generating A/SCVD 855 for the SWM 101. The identifying may further include associating anomalies and/or SC vulnerabilities with MEC of the SWM 101, e.g., with MEC, MEI, functions, libraries, and/or the like.

Step 1012 may include evaluating A/SCVD 855 determined for the SWM 101, as disclosed herein. The evaluating may include determining whether the A/SCVD 855 indicates that the SWM 101 includes one or more anomalies and/or SC vulnerabilities and/or includes anomalies and/or SC vulnerabilities that can be mitigated through modifications to the SWM 101. If anomalies and/or SC vulnerabilities are identified at 1012, the flow may continue at 1014; otherwise, the flow may terminate.

Step 1014 may include generating a modified SWM 101-1. The modified SWM 101-1 may be generated by modifying operations of the SWM 101, e.g., through rewriting, obfuscation, reordering, data whitening, and/or other suitable technique(s). Alternatively, or in addition, step 1014 may include prompting an external entity to modify the SWM 101. Step 1014 may include providing the A/SCVD 855 to a programmer (or software development group), providing the A/SCVD 855 to one or more tools, e.g., build tools, and/or the like.

Step 1014 may further include performing SC analysis of the modified SWM 101-1. Step 1014 may include generating synthetic SC data 150-1 for the modified SWM 101-1 at 1002, analyzing the synthetic SC data 150-1 at 1004 to identify anomalies and/or SC vulnerabilities at 1006, and evaluating the identified anomalies and/or SC vulnerabilities (if any) at 1012. The method 1001 may, therefore, include iteratively modifying and/or refining the SWM 101 until potential anomalies and/or SC vulnerabilities of the SWM 101 have been mitigated (and/or other termination criteria are satisfied).

In some implementations, the SCA module 110 may be configured to perform other SC analysis functions, such as SC anomaly detection. SC anomaly detection may include monitoring a SC of a computing device 205 during execution of one or more SWM 101, comparing SCM data 250 acquired from the computing device 205 to SC signatures of the SWM 101, and detecting an anomaly based, at least in part, on the comparing. It may be difficult to acquire SC signatures that accurate characterize SC behavior. For example, minor misplacements of SC measurement devices, e.g., EM monitoring devices 230, may result in false positives, while the use of excessive comparison metrics may fail to detect anomalies. In some implementations, an anomaly detection system may utilize SC signatures that include and/or are derived from synthetic SC data 150.

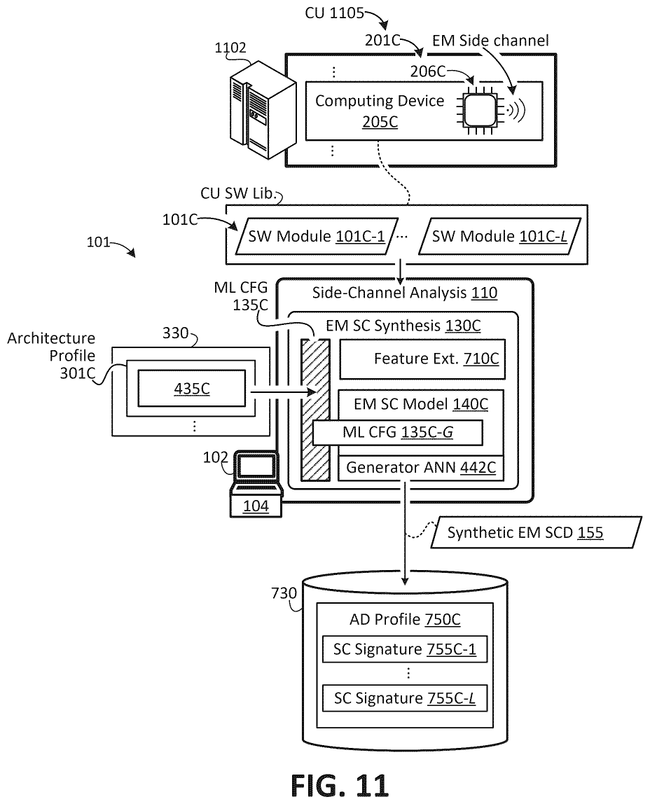

FIG. 11 is a schematic block diagram illustrating an example of a system 101 for synthetic SC anomaly detection. In the FIG. 11 example, the SCA may be configured to generate SC signatures for a CU 1105. The CU 1105 may include and/or correspond to a computing device 205C. The computing device 205C may include an embedded device configured to be deployed within a computing system 1102, such as a control system, cyber-physical system, or the like. The computing device 205C may implement an architecture 201C having an EM SC, e.g., may include a processing unit 206C of architecture 201C. The CU 1105 may be associated with a SW library. The SW library may define SWM 101 implemented by the CU 1105 (and/or corresponding computing device 205). In the FIG. 11 example, the SW library of the CU 1105 may include L SWM 101C, e.g., SWM 101C-1 through 101C-L, which may include, but are not limited to: firmware of the CU 1105, an operating system of the CU 1105, programs implemented by the CU 1105, and/or the like.

The SCA module 110 may include an EM SC synthesis module 130C configured to, inter alia, emulate the EM SC of the CU 1105, e.g., emulate the EM SC of architecture 201C implemented by the computing device 205C of the CU 1105. The EM SC synthesis module 130C may be configured, instantiated, and/or implemented in accordance with an ML CFG 135C learned for the architecture 201C. The ML CFG 135C may be learned by another device or system, such as an SCA module 110 and/or EM SC synthesis module 130 as illustrated in FIG. 4A or FIG. 7A. The ML CFG 135C may include and/or be derived from portions of an NT ML CFG 435C architecture maintained within non-transitory storage, such as an architecture profile 301C of an architecture datastore 330. The feature extraction module 710C may be configured to extract executable code 302 from SWM 101C and convert instructions 305 of the executable code 302 into corresponding features 315. The generator ANN 442C of the EM SC model 140C may be configured to generate synthetic EM SC data 155 for respective SWM 101C, e.g., generate synthetic EM SC data 155 including segments 355 corresponding to respective instructions 305.

In the FIG. 11 example, the SCA module 110 may be configured to populate an AD profile 750C of the CU 1105. The AD profile 750 may include SC signatures 755C configured to characterize SC behavior of the CU 1105 during execution of respective SWM 101C of the SW library. The SCA module 110 may generate SC signatures 755-1 through 755C-L including synthetic EM SC data 155 generated for SWM 101C-1 through 101C-L, respectively. The SC signatures 755 may be used to detect anomalies pertaining to the CU 1105, as disclosed in further detail herein.

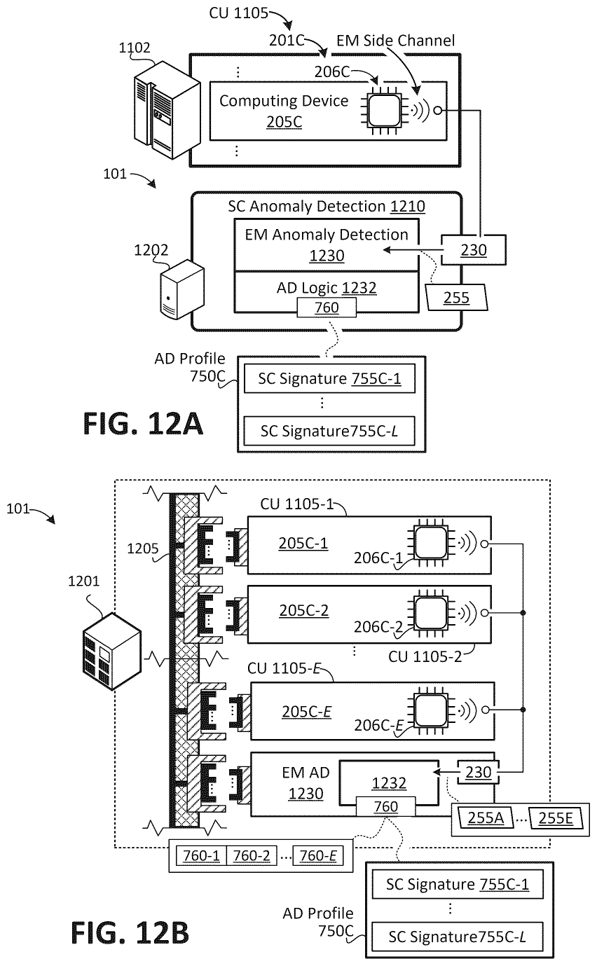

FIG. 12A is a schematic block diagram illustrating an example of a system 101 for synthetic SC anomaly detection. The system 101 may include an anomaly detection (AD) device 1202 which may include and/or be coupled to computing resources 104, as disclosed herein, e.g., may include processing resources 104-1, DSR resources (e.g., memory resources 104-2 and NTS resources 104-3), and/or the like. The AD device 1202 may be configured to monitor one or more SC of a CU 1105. In the FIG. 12A example, the CU 1105 may include a computing device 205C of architecture 201C, e.g., may include an embedded device configured to be deployed within a computing system 1102, as disclosed herein.

The AD device 1202 may include and/or be coupled to a SC anomaly detection (AD) module 1210. The SC AD module 1210 may be configured for operation on computing resources 104 of the AD device 1202. The SC AD module 1210 may be configured to monitor respective SC of the CU 1105. The SC AD module 1210 may include and/or be coupled to an EM SC AD module 1230, which may be configured to monitor an EM SC of the CU 1105. The EM SC AD module 1230 may include and/or be coupled to an EM monitoring device 230. The EM monitoring device 230 may include any suitable means for acquiring EM SCM data 255 pertaining to the EM SC of the CU 1105, as disclosed herein.

The EM SC AD module 1230 may include and/or be coupled to anomaly detection (AD) logic 1232. The AD logic 1232 may be configured to compare EM SCM data 255 acquired from the CU 1105 to an AD profile 750C of the CU 1105. The AD logic 1232 may be configured to compare EM SCM data 255 acquired from the CU 1105 during execution of a specified SWM 101C of the SW library to a corresponding SC signature 755C. the AD logic 1232 may be configured to determine SCD metrics 760, the SCD metrics 760 configured to quantify a difference, deviation, distance, and/or other error between EM SCM data 255 acquired from the CU 1105 and the AD profile 750C of the CU 1105. In some implementations, the SC anomaly detection module 1210 may be configured to determine and/or identify the SWM 101C being executed by the computing device 205C of the CU 1105. The AD logic 1232 may be configured to determine an SCD metric 760 configured to quantify an error between the EM SCM data 255 acquired from the CU 1105 and the SC signature 755C of the identified SWM 101C. The AD logic 1232 may detect an anomaly in response to determining that the SCD metric 760 exceeds a threshold (and/or exceeds a threshold for a threshold period of time and/or threshold index).

Alternatively, or in addition, the SC anomaly detection module 1210 may be configured to passively monitor the CU 1105 and, as such, may not know the SWM 101C being executed by the CU 1105. In these implementations, the AD logic 1232 may be configured to determine SCD metrics 760 comparing the EM SCM data 255 to a plurality of SC signatures, e.g., SC signatures 755C-1 through 755C-L. The AD logic 1232 may detect an anomaly in response to determining that none of the SCD metrics 760 satisfy a proximity threshold (and/or the SCD metrics 760 determined for SC signatures 755C-1 through 755C-L fail to satisfy the proximity threshold for a threshold time period).

The SC anomaly detection module 1200 may implement one or more mitigation actions in response to detection of an anomaly. The SC anomaly detection module 1200 may be configured to implement any suitable mitigation action including, but not limited to: notifying an external entity of the detected anomaly, such as a user, administrator, security system, intrusion detection system, or the like (e.g., sending an electronic message, email, text message, and/or other electronic communication), configuring the CU 1105 (and/or computing device 205C) to operate in a safe mode (e.g., reduced functionality mode), resetting the CU 1105, disabling the CU 1105, and/or the like.

FIG. 12B is a schematic block diagram illustrating another example of a SC anomaly detection system 101. In the FIG. 12B example, the EM AD module 1230 may be configured to monitor the EM SC of a plurality of CU 1105, including CU 1105-1 through CU 1105-E. The CU 1105 may include and/or correspond to respective computing devices 205C-1 through 205-E. The computing devices 205C-1 through 205-E may have a common architecture 201C, e.g., may include respective processing units 206C-1 through 206-E of architecture 201C. The computing devices 205C-1 through 205C-E may, therefore, exhibit substantially the same EM SC behavior. As illustrated in the FIG. 12B example, the computing devices 205C-1 through 205C-E may include respective embedded devices (or modules) configured to interface with a computing system 1201 through, inter alia, integration infrastructure 1205, such as a bus, interface slot, or the like.

In the FIG. 12B example, the EM AD module 1230 may be implemented as an embedded device (or module) of the computing system 1201. Alternatively, operations of the EM AD module 1230 may be implemented on a separate device and/or apparatus 1202 as illustrated in the FIG. 12A example.

The EM AD module 1230 may include and/or be coupled to an EM monitoring device 230. The EM monitoring device 230 may be configured to acquire EM SCM data 255 pertaining to CU 1105-1 through 1105-E, e.g., acquire EM SCM data 255-1 through 255-E. The EM monitoring device 230 may, for example, include antenna and/or other EM sensing means coupled to the EM SC of respective computing devices 205C-1 through 205C-E. Alternatively, or in addition, the EM AD module 1230 may include and/or be coupled to a plurality of EM monitoring devices 230, each configured to acquire EM SCM data 255 pertaining to the EM SC of a respective CU 1105-1 through 1105-E.

The EM AD module 1230 may further include AD logic 1232. The AD logic 1232 may be configured to detect anomalies pertaining to CU 1105-1 through 1105-E, which may include acquiring EM SCM data 255 from respective CU 1105 and comparing the EM SCM data 255 to SC signatures 755 of the CU 1105. The AD logic 1232 may be configured to determine SCD metrics 760 for respective CU 1105. In some implementations, the EM AD module 1230 may be configured to identify SW module(s) 101C being implemented by respective CU 1105 and may determine SCD metrics 760 configured to quantify error between EM SCM data 225 and SC signatures 755 of the identified SWM 101C. The EM AD module 1230 may detect an anomaly pertaining to a CU 1105-1 through 1105-E in response to the corresponding SCD metric 760-1 through 760-E exceeding a threshold (and/or exceed the threshold for a threshold time period). Alternatively, The EM AD module 1230 may be configured to passively monitor the CU 1105. In these implementations, the SCD metrics 760 determined for respective CU 1105 may quantify error between EM SCD data 255 acquired from the CU 1105 and respective SC signatures 755C-1 through 755C-L. The AD module 1230 may detect an anomaly pertaining to a CU 1105 in response to determining that the SCD metrics 760 of the CU 1105 (e.g., SCD metrics 760 for each SC signature 755C-1 through 755C-L) fail to satisfy a proximity threshold and/or fail to satisfy the proximity threshold for a threshold time period.

The EM AD module 1230 may be further configured to implement one or more mitigation actions in response to detecting an anomaly pertaining to a specified CU 1105, as disclosed herein.

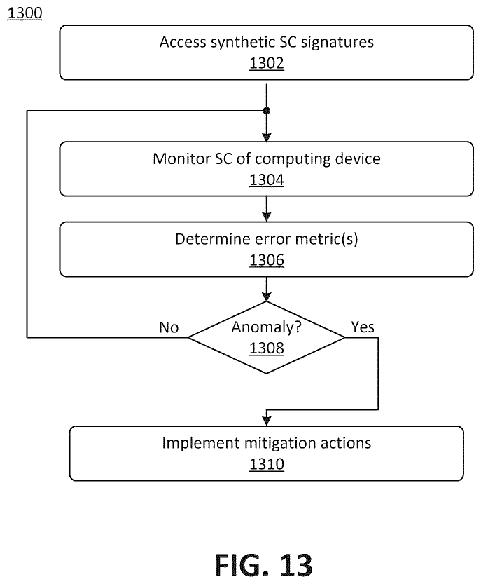

FIG. 13 is a flow diagram illustrating an example of a method 1300 for synthetic SC anomaly detection. Step 1302 may include accessing synthetic SC signatures 755 for a computing device 205. The synthetic SC signatures 755 may include and/or be derived from synthetic EM SC data 155 determined for a SWM 101 to be executed by the computing device 205. The synthetic EM SC data 155 may be generated by an EM SC synthesis module 130 configured to emulate the EM SC of the computing device 205, e.g., an EM SC synthesis module 130 configured to emulate the EM SC of the architecture 201 of the computing device 205 and/or processing unit 206 thereof. The EM SC synthesis module 130 may be instantiated, configured, and/or otherwise implemented in accordance with an ML CFG 135 learned for the architecture 201, as disclosed herein. The ML CFG 135 may be retrieved from an NT ML CFG 435 maintained within an architecture profile 301 or other NTS resources.

In some implementations, step 1302 may include accessing a plurality of SC signatures 755, each SC signature 755 including and/or derived from synthetic EM SC data 155 generated for a respective SWM 101 of a SW library. As disclosed herein, the SW library may include SWM 101 to be implemented on a CU 1105 (and/or computing device 205 of the CU 1105). The SW signatures 755 may include and/or be derived from synthetic EM SC data 155 generated for respective SWM 101 of the SW library, as disclosed herein.

Step 1304 may include monitoring an EM SC of the computing device 205. Step 1304 may include acquiring EM SCM data 255 from the EM SC by use of an EM monitoring device 230, as disclosed herein.

Step 1306 may include determining SCD metrics 760 for the computing device 205. The SCD metrics 760 may be configured to quantify a difference, distance, deviation, and/or other error between the EM SCM data 255 acquired at 1304 and a specified SC signature 755. The SC signature 755 may correspond to a SWM 101 being executed by the computing device 205 during acquisition of the EM SCM data 255. Alternatively, or in addition, step 1306 may include determining a plurality of SCD metrics 760, each SCD metric 760 configured to quantify a difference, distance, deviation, and/or other error between the EM SCM data 225 acquired at 1304 and a respective SC signature 755 of a plurality of SC signatures 755, e.g., SC signatures 755 corresponding to respective SWM 101 of the SW library.

Step 1308 may include determining the EM SCM data 255 is indicative of anomalous operation of the computing device 205. Step 1308 may include determining whether the SCD metric 760 determined for the SWM 101 being executed during acquisition of the EM SCM data 255 exceeds a difference threshold (and/or exceeds the difference threshold for a threshold time period). Alternatively, or in addition, step 1308 may include determining whether each SCD metric 760 determined at step 1308 fails to satisfy a proximity threshold (and/or has failed to satisfy the proximity threshold for a threshold time period). If an anomaly is detected at 1308, the flow may continue at 1310; otherwise, the flow may continue back at 1304, which may include continuing to monitor the computing device 205, as disclosed herein. Step 1310 may include implementing one or more mitigation actions in response to detection of the anomaly, as disclosed herein.

Although FIGS. 11-13 describe anomaly detection with respect to synthetic EM SC data 155, the disclosure is not limited in this regard and could be adapted to detect anomalies (and/or perform other SC analysis functions) by use of synthetic SC data 150 pertaining to other types of SC and/or combinations thereof, e.g., as described above in conjunction with FIG. 9B. This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general-purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “includes,” “including,” and any other variation thereof, are intended to cover a non-exclusive inclusion, such that a process, a method, an article, or an apparatus that includes a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

What is claimed is:

1. A side-channel analysis system, comprising:
one or more data storage devices including, stored thereon:
tokenizer data correlating different token values to different human-readable instructions of a human-readable computing language; and
training data correlating different machine-learned configurations of a side-channel model to the different token values; and
one or more processors operably coupled to the one or more data storage devices, the one or more processors configured to:
generate a synthetic side-channel signal for a code for a software program using the side-channel model, the code comprising human-readable instructions of the human-readable computing language, the synthetic side-channel signal comprising an estimate of an actual side-channel signal that would be generated by a computer executing the code for the software program, the synthetic side-channel signal generated based, at least in part, on token values for the human-readable instructions of the code and the training data; and
analyze the synthetic side-channel signal to detect one or more of anomalies or vulnerabilities of the software program.

2. The side-channel analysis system of claim 1, wherein the one or more of anomalies or vulnerabilities of the software program comprise an injected code anomaly.

3. The side-channel analysis system of claim 1, wherein the one or more of anomalies or vulnerabilities of the software program comprise a side-channel vulnerability.

4. The side-channel analysis system of claim 1, wherein the side-channel model includes a generative adversarial network (GAN) comprising a generator and a discriminator.

5. The side-channel analysis system of claim 4, wherein to train the side-channel model, the processor is configured to:
obtain a token value for a selected human-readable instruction;
combine a sample of noise with the token value to generate a training vector;
generate, by the generator, a training synthetic side-channel signal in responsive to the training vector;
generate, by the discriminator, a synthetic score for the training synthetic side-channel signal;
generate, by the discriminator, an authentic score for a measured synthetic side-channel signal corresponding to the selected human-readable instruction;
determine a generator loss and a discriminator loss based, at least in part, on the synthetic score and the authentic score; and
update the training data to update one or more of the generator or the discriminator of the side-channel model based, at least in part, on one or more of the generator loss or the discriminator loss.

6. The side-channel analysis system of claim 5, wherein the training vector comprises a concatenation of the token value onto the sample of noise.

7. The side-channel analysis system of claim 1, wherein the synthetic side-channel signal is an estimate of one or more of an actual power consumption signal, an actual acoustic signal, an actual vibration signal, an actual temperature signal, an actual electro-optical radiation signal, or an actual electromagnetic radiation signal.

8. A method of operating a side-channel analysis system, the method comprising:
generating a training vector corresponding to a human-readable instruction of a human-readable computing language;
generating, by a generator of a generative adversarial network (GAN), a training synthetic side-channel signal responsive to the training vector;
scoring, by a discriminator of the GAN, an actual side-channel signal that would be generated by execution of a machine-executable instruction corresponding to the human-readable instruction;
scoring the training synthetic side-channel signal;
determining a discriminator loss based, at least in part, on a score assigned to the training synthetic side-channel signal and a score assigned to the training synthetic side-channel signal;
updating the discriminator based, at least in part, on the discriminator loss;
determining a generator loss based, at least in part, on the score assigned to the training synthetic side-channel signal; and
updating the generator based, at least in part, on the generator loss.

9. The method of claim 8, wherein generating a training vector comprises generating a token value for the human-readable instruction and combining the token value with a random sample to generate the training vector.

10. The method of claim 8, further comprising generating a dictionary including different token values and corresponding human-readable instructions of the human-readable computing language.

11. The method of claim 10, wherein each token value of the different token values includes a unique sequence of integers.

12. The method of claim 8, further comprising generating, by the GAN, a synthetic side-channel signal for a code for a software program, the code including at least a portion of the human-readable instruction of the human-readable computing language, the synthetic side-channel signal estimating an authentic side-channel signal that would be emitted by a computer executing a binary code corresponding to the code for the software program.

13. The method of claim 12, wherein generating the synthetic side-channel signal comprises generating a synthetic electromagnetic (EM) radiation signal to estimate an authentic EM radiation signal that would be emitted by the computer executing the binary code.

14. The method of claim 12, further comprising identifying one or more of an anomaly or a vulnerability of the software program based, at least in part, on the synthetic side-channel signal.

15. The method of claim 14, wherein identifying one or more of an anomaly or a vulnerability of the software program comprises identifying an injected code anomaly.

16. The method of claim 14, further comprising modifying the software program responsive to identifying the one or more of an anomaly or a vulnerability to remedy the one or more of an anomaly or a vulnerability.

17. A side-channel analysis system, comprising:
one or more processors; and
one or more data storage devices having computer-readable instructions stored thereon, the computer-readable instructions configured to instruct the one or more processors to:
generate a training vector corresponding to a human-readable instruction of a human-readable computing language;
generate, by a generator of a generative adversarial network (GAN), a training synthetic side-channel signal responsive to the training vector;
score, by a discriminator of the GAN, an actual signal that would be generated by execution of a machine-executable instruction corresponding to the human-readable instruction;
score the training synthetic side-channel signal;
determine a discriminator loss based, at least in part, on a score assigned to the training synthetic side-channel signal and a score assigned to the training synthetic side-channel signal;
update the discriminator based, at least in part, on the discriminator loss;
determine a generator loss based, at least in part, on the score assigned to the training synthetic side-channel signal; and
update the generator based, at least in part, on the generator loss.

18. The side-channel analysis system of claim 17, wherein the computer-readable instructions are further configured to instruct the one or more processors to generate a synthetic side-channel signal for a code for a software program, the code including at least a portion of the human-readable instructions of the human-readable computing language, the synthetic side-channel signal comprising an estimate of an actual side-channel signal that would be generated from execution of a machine-executable code for the software program.

19. The side-channel analysis system of claim 18, wherein the computer-readable instructions are further configured to instruct the one or more processors to identify one or more of an anomaly or a vulnerability of the software program based, at least in part, on the synthetic side-channel signal.

20. The side-channel analysis system of claim 19, wherein the computer-readable instructions are further configured to instruct the one or more processors to modify the software program to remedy the identified one or more of an anomaly or a vulnerability.
